(19) United States
(12) Patent Application Publication
(10) Pub. No.: US 2026/0147089 A1
(43) Pub. Date: May 28, 2026

(54) WIRELESS SENSING AND COMMUNICATION SYSTEM WITH MATCHING FUNCTION FOR IMPROVED INTEROPERABILITY

(71) Applicant: KONINKLIJKE PHILIPS N.V., EINDHOVEN (NL)

(72) Inventors: Walter DEES, Eindhoven (NL); Oscar GARCIA MORCHON, Eindhoven (NL); Robert James DAVIES, Eindhoven (NL); Harry Michael CRONIN, Zurich (CH); David Michael DUFFY, Zurich (CH); Nicholas Simon WALKER, Zurich (CH); Ben MEUNIER, Zurich (CH)

(21) Appl. No.: 19/123,490

(22) PCT Filed: Nov. 1, 2023
(86) PCT No.: PCT/EP2023/080444

§ 371 Date: Apr. 23, 2025

(30) Foreign Application Priority Data
Nov. 3, 2022 (EP) 22205359.7
May 2, 2023 (EP) 23170945.2

(51) Int. Cl. G01S 7/41; G01S 13/72; G01S 13/86; H04W 12/06

(52) U.S. Cl. CPC G01S 7/41; G01S 13/72; G01S 13/86; H04W 12/06

(57) ABSTRACT

The invention relates to a sensing and communication system for sensing targets (objects or people) in an environment, 2024/094745 wherein first real sensing data of a target collected by a first device is used to generate synthetic data which emulates second real sensing data which would be produced by a second device of the same target. The synthetic data is then used to determine whether the second real sensing data collected by the second device matches the first real sensing data collected by the first device, such that it can be confirmed whether both devices are sensing or have sensed the same target, or to identify objects in the field of view of a device (e.g., AR glasses).

### FIELD OF THE INVENTION

The invention relates to the field of integrated sensing and communication (ISAC) in wireless networks, such as—but not limited to—fifth generation (5G) cellular communication systems.

### BACKGROUND OF THE INVENTION

As the wavelength of communication systems decreases, the ability to use the same wavebands for increasingly precise sensing applications improves.

So-called ‘mmWave’ radar is a contactless sensing technology for detecting objects and providing range, velocity and angle of these objects, that operates in a spectrum between 30 GHz and 300 GHz. Due to the technology's use of small wavelengths, it can provide sub-mm range accuracy and is able to penetrate certain materials such as plastic, drywall, clothing, and is relatively impervious to environmental conditions such as rain, fog, dust and snow. The ability to sense surface positions and movements at sub-mm scale enables such systems to perform vital signs monitoring.

As an example, signal wavebands of 5G communication systems or other suitable wireless communication systems can be used as mmWave radar e.g. to measure locations and movements of cars and people and even vital sign signals such as heart rate and breathing rate, but this requires knowledge of the transmission environment, approximate target location, and suitable modifications to the signaling system.

Recently, mmWave frequency doppler radar systems have been investigated for enabling human pose estimation (cf. Sizhe An et al.: “Fast and Scalable Human Pose Estimation using mmWave Point Cloud”, Design Automation Conference (DAC) 2022, arXiv: 2205.00097 [eess. IV]). Such systems generally utilise Frequency Modulated Continuous Wave (FMCW) chirps, which are emitted by a transmitter, deflected by objects in the scene, and then received by one or more antennas. Both range and doppler shift (velocity) of people moving in the scene can be recovered, which may be plotted in two dimensions (2D) and used as a signature of a given pose. Furthermore, human pose estimation has been used for identifying an individual among a cohort of people, primarily for security applications.

Synthetic data is artificial data generated from original data and a model that is trained to reproduce the characteristics and structure of the original data. The generation of mmWave synthetic data representing a 3D human pose from an original video dataset has recently been demonstrated (cf. Karan Ahuja et al.: “Vid2Doppler: Synthesizing Doppler Radar Data from Videos for Training Privacy-Preserving Activity Recognition”, CHI '21, May 8-13, 2021, Yokohama, Japan). The method results in synthetic mmWave doppler radar measurements which closely match real doppler radar measurements of both range and doppler shift over time. It can be broken down into two key steps: (1) generating a 3D mesh model of the posing individual from the video data, (2) generating synthetic doppler radar measurements based on the 3D mesh model, and a given synthetic viewpoint. Equivalent steps to step (1) have been demonstrated with other initial datasets, including generating 3D mesh data from lidar, sonar and worn accelerometers (cf. Amin Ahmadi et al.: “3D Human Gait Reconstruction and Monitoring Using Body-Worn Inertial Sensors and Kinematic Modelling”, DOI 10.1109/JSEN.2016.2593011, Journal of IEEE Sensors). Step (2) should be compatible with 3D meshes generated from these other data types, indicating that synthetic mmWave doppler radar data could be generated from many initial base datasets.

Outside of human pose identification, research has shown that the radar cross sections of objects such as drones or different car models may be distinct enough to perform an identification function. Generation of synthetic radar data of cars and other objects has been commonly applied to virtual sensor training, for example in autonomous vehicles.

ISAC is thought to be a new service for next generation telecoms networks. In such a service, network resources may be intelligently shared between communication and sensing tasks, allowing the network infrastructure to also act as a sensor network. Such “perceptive” networks may be utilised to improve core communications functions on the network but may also enable “sensing as a service”, where 3rd parties can access the outputs of such sensing functions.

The term “metaverse” has been used recently to refer to a shared set of inter-actable spaces, within which users may interact with one another alongside mutually perceived virtual features (i.e., augmented reality (AR)) or where those spaces are entirely com-posed of virtual features (i.e., virtual reality (VR)). This definition has recently been adopted in some 3GPP work items. Throughout the present disclosure, VR and AR is generally referred to as “mixed reality” (MR).

Interoperability in metaverse and mixed reality (MR) services has been predicted to be a key issue to address. More particular, parts of the service such as digital store fronts and digital goods and items that they sell, are expected to be not interoperable by default. This means that, for a given user interacting in one metaverse environment, any digital assets that they have procured will not be “visible” to a different user interacting in a second metaverse environment.

Such interoperability issues lead to problems for user experience (because users may be more likely to purchase digital assets if they can be viewed by any other user, even outside of their specific metaverse), and there is therefore a need to identify solutions which enable limited interoperability issues (and particular digital asset sharing) between metaverses, without undermining the effective monopoly each metaverse service provider holds in the digital storefronts within their own service.

### SUMMARY OF THE INVENTION

It is an object of the present invention to improve to improve the identification of objects for sensing related services.

This object is achieved by an apparatus as claimed in claim 1, by a terminal device as claimed in claim 12, by an access device as claimed in claim 13, by a system as claimed in claim 14, by a method as claimed in claim 15, and by a computer program product as claimed in claim 16.

According to a first aspect related to a wireless communication device or other network device (e.g., access device or terminal device), an apparatus comprises at least one sensor featured by at least one sensing parameter, in particular at least one of a sensor type and a point or direction of view, wherein the apparatus is configured to:
obtain first measured data of a target object;
receive from a second sensor second measured data related to the target object;
obtain synthetic data of the second measured data and/or the first measured data based on the at least one sensing parameter of the first sensor and/or at least one sensing parameter, in particular at least one of a sensor type and a point or direction or field of view, related to the second measured data; and
determine based on the obtained synthetic data whether there is a match between the first measured data and the second measured data.

According to a second aspect related to a procedure executed at a wireless communication device or other network device (e.g., access device or terminal device), a method of matching a target object in a wireless network comprises:
obtaining first measured data of a target object;
receiving from a second sensor second measured data related to the target object;
obtaining synthetic data from the second measured data and/or the first measured data based on at least one sensing parameter of the first sensor and/or at least one sensing parameter, in particular at least one of a sensor type and a point or direction of field of view, related to the second measured data, and
determining based on the obtained synthetic data whether there is a match between the first measured data and the second measured data.

According to a third aspect, a terminal device (e.g., UE) comprising an apparatus of the first aspect is provided.

According to a fourth aspect, an access device (e.g., base station, access point or the like) comprising an apparatus of the first aspect is provided.

According to a fifth aspect, a wireless communication system is provided, which comprises at least one of the terminal device according to the third aspect and the access device according to the fourth aspect.

Finally, according to a sixth aspect, a computer program product is provided, which comprises code means for producing the steps of the method of the second aspect when run on a processor of a network device.

Accordingly, the proposed solution enables a matching service where two different devices may confirm or disconfirm having viewed or otherwise sensed the same object, via the generation of synthetic data based on data from the first device, which closely resembles the data that would have been generated by the second device if it had viewed the same object.

A “perceptive” network with matching service is thus provided, that may consist of many terminal devices (e.g., UEs) and access devices (e.g., gNBs) with varying capability and modality deployed for sensing target objects (e.g., people and objects) in an environment. First (real) sensing data of a target object collected by a first device is used to generate synthetic data adapted to emulate as accurately as possible second (real) sensing data which would have been produced by a second device of that same target object. The synthetic data can then be used to determine whether the second sensing data collected by the second device matches with the first sensing data collected by the first device, such that it can be confirmed whether both devices are sensing or have sensed the same object.

Thus, the specific generation of synthetic data to match sensing data of a second sensor based on the sensing data of a first sensor facilitates determination of same target objects sensed by different sensors. The synthetic data generation process may take into account factors such as the location, viewing angle or viewing point of the different sensors.

The proposed matching concept can be applied in various use-case-specific embodiments (as described later) to provide a method and system for generating synthetic data by or for one device to enable matching to the real-world data of a second device, where the synthetic data is generated based on a knowledge of at least one sensing parameter used by the second device (for example, sensor type, point of view, viewing direction etc.).

Depending on the specific use case, the following advantages are enabled:
A network may be allowed to arbitrate information transfer between a first device and a second device when the identity of the second device is unknown to the first device. More specifically, in a MR/metaverse use case, the network may allow the first device to determine the identity of a user being specifically viewed by the first device, such that necessary further information may be retrieved (e.g., the correct digital assets to be loaded for a particular viewed user).

Furthermore, tracking of individual devices between cells via transfer of data representing their radar cross-sections can be achieved, providing service continuity for sensing tasks on the network. More specifically, tracking of non-communicating objects may be allowed, as they travel from cell to cell, which may have important functions in areas such as law enforcement (e.g., tracking a vehicle).

Additionally, a user can be allowed to provide data using easy-to-access sensors (such as smartphone cameras) which can then be used as part of an authentication service provided by the network.

According to a first option which may be combined with any of the above first to sixth aspects, the at least one sensing parameter related to the second measured data may be at least one sensing parameter of the second sensor, wherein the ate least one sensing parameter of the second sensor is obtained from another device.

According to a second option which may be combined with the first option or any of the above first to sixth aspects, the apparatus may be configured to determine whether there is a match between the obtained synthetic data of the first measured data and the obtained synthetic data of the second measured data; or to determine whether there is a match between the first measured data and the obtained synthetic data of the second measured data; or to determine whether there is a match between the second measured data and the obtained synthetic data of the first measured data.

According to a third option which may be combined with the first or second option or any of the above first to sixth aspects, the determination (e.g., by the apparatus) whether there is a match may be achieved by using at least one of a first algorithm for segmenting the first and the second measured data into first and second object-related data, a second algorithm for generating the synthetic data from the first or second object-related data or one of previous inputs, a third algorithm for converting the first or second object-related data or one of the previous inputs into a first or second intermediate form, in particular a multi-dimensional representation, representative of an object described by the first or second object-related data, a fourth algorithm for converting the first or second intermediate form or one of the previous inputs into the synthetic data, and a fifth algorithm for aligning the first and second intermediate form.

According to a fourth option which may be combined with any of the first to third options or any of the above first to sixth aspects, an identity of the target object may be determined (e.g., by the apparatus) based on the obtained synthetic data and the first measured data.

According to a fifth option which may be combined with any of the first to fourth options or any of the above first to sixth aspects, the first measured data may be retrieved (e.g., by the apparatus) from a database.

According to a sixth option which may be combined with any of the first to fifth options or any of the above first to sixth aspects, additional data related to the target object may be retrieved (e.g., by the apparatus) from a metaverse or mixed reality service provider and to provide the additional data to the second sensor.

According to a seventh option which may be combined with any of the first to fifth options or any of the above first to sixth aspects, the apparatus may be configured to perform asset tracking of the target object. This enables intermittent checking of tagged assets to ensure that the tracking tag is still attached to the proper asset.

According to an eighth option which may be combined with any of the first to fifth options or any of the above first to sixth aspects, the apparatus may be configured to request the target object to accept a network-aided identification.

According to a ninth option which can be combined with any of the first to fifth options or any of the above first to sixth aspects, the apparatus may be configured to authorize the target object if a match has been determined.

According to a tenth option which can be combined with any of the first to fifth options or any of the above first to sixth aspects, the apparatus may be configured to provide support for service continuity, in particular when the target object moves out of the coverage area of the remote device.

According to a seventh aspect, the above object is solved by an apparatus comprising a receiver and a sensing sensor featured by certain sensing parameters (e.g., sensor type, point of view) and configured to:
sense or retrieve a first sensed data of a target object,
receive a second sensed data from a first device related to the target object,
(optionally) receive sensing parameters (e.g., sensor type, point of view) from the first device,
generate synthetic data from the second sensed data (or the first sensed data) based on the parameters of the apparatus and the parameters of the first device, and
determine whether the real-world first sensed data (resp. the second sensed data) and the generated synthetic data match.

According to a first option, the apparatus of the seventh aspect may be configured to:
generate synthetic data from the first sensed data and the first sensed data based on the parameters of the apparatus and the parameters of the first device, and
determine whether the generate synthetic data from the first sensed data and the generated synthetic data from the second sensed data match.

According to a second option which may be combined with the first option, the apparatus of the seventh aspect may further comprise at least one of a Segmentation Algorithm, a Synthetic Data Algorithm, a X-to-Mesh Algorithm, a Mesh-to-Y Algorithm, a Synthetic Transform Algorithm, and a Mesh Alignment Algorithm.

According to a third option which may be combined with the first or second option, the apparatus of the seventh aspect may further be configured to determine an identity of the target object based on the generated synthetic data and the first sensed data.

According to a fourth option which may be combined with any of the first to third options, the first sensed data may be stored in a database.

According to a fifth option which may be combined with any of the first to fourth options, the apparatus of the seventh aspect may be configured to retrieve additional data related to the target object from the Metaverse/MR service provider and provide said additional data to the first device.

According to a sixth option which may be combined with any of the first to fifth options, the apparatus of the seventh aspect may be configured to perform asset tracking of the target object.

According to a seventh option which may be combined with any of the first to sixth options, the apparatus of the seventh aspect may be configured to request the target object to opt-in for network-aided identification.

According to an eighth option which may be combined with the seventh option, the apparatus of the seventh aspect may be configured to authorize the target object if there is a match.

According to a ninth option which may be combined with any of the first to eighth options, the apparatus of the seventh aspect may be configured to support service continuity when the target object moves out of the coverage area of the first device.

According to an eighth aspect, the above object is solved by an UE comprising the apparatus of the seventh aspect and the first to fourth, sixth and seventh options.

According to a ninth aspect, the above object is solved by a base station comprising the apparatus of the seventh aspect and the first to ninth options.

According to a tenth aspect, the above object is solved by method for matching featured by
sensing a first sensed data of a target object,
receiving a second sensed data from a first device related to the target object,
(optionally) receiving sensing parameters (e.g., sensor type, point of view) from the first device,
generating synthetic data from the second sensed data (or the first sensed data) based on the parameters of the apparatus and the parameters of the first device, and
determining whether the first sensed data (resp. the second sensed data) and the generated synthetic data match.

According to an eleventh aspect, the above object is solved by computer program product comprising code means for producing the steps of the method of the tenth aspect when run on a computer device.

According to a twelfth aspect, the above object is solved by system for the generation of synthetic data by one device to enable matching to the real-world data of a second device, where the synthetic data is generated with knowledge of the parameters used by the second device in its sensing (for example, sensor type, or point of view).

It is noted that the above apparatus may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the apparatus of claim 1, the terminal device of claim 12, the access device of claim 13, the system of claim 14, the method of claim 15, and the computer program product of claim 16 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 schematically shows a distributed sensing function created via a 5G communication system link;

FIG. 2 schematically shows an embodiment of a transmitter and receiver architecture, which may be used in embodiments of the present invention;

FIG. 3 schematically shows a sensing and communication system with data processing and matching algorithms according to a first embodiment;

FIG. 4 schematically shows a process flow diagram according to the first embodiment;

FIG. 5 schematically shows a flow diagram of a matching procedure according to a second embodiment;

FIG. 6 schematically shows a modified system structure according to a third embodiment;

FIG. 7 schematically shows a flow diagram of a matching procedure according to a fourth embodiment;

FIG. 8 schematically shows a target authorization procedure according to various embodiments of the present invention;

FIG. 9 schematically shows an embodiment of a flow diagram of a sensing operation, according to an embodiment of the present invention;

FIG. 10 schematically shows an embodiment of a flow diagram of a location and movement detection process, which may be used in embodiments of the present invention;

FIG. 11 schematically shows an embodiment of a flow diagram of a heart rate and breathing rate detection process, which may be used in embodiments of the present invention;

FIG. 12 schematically shows a sensing system according to an embodiment of the present invention;

FIG. 13 schematically shows an architecture of a wireless network with overlapping sensing structure in which the invention can be implemented;

FIG. 14 schematically shows a block diagram indicating how a handover is performed in accordance with the first embodiment of the invention;

FIG. 15 schematically shows a block diagram indicating how a handover is performed in accordance with a second embodiment of the invention;

FIG. 16 schematically represents a cooperative sensing procedure according to another embodiment of the invention; and

FIG. 17 schematically shows a block diagram and an exchange of signals for a cooperative sensing procedure according to another embodiment of the invention.

### DETAILED DESCRIPTION OF EMBODIMENTS

Embodiments of the present invention are now described based on a cellular sensing and communication network environment, such as 5G. However, the present invention may also be used in connection with other wireless technologies (e.g., IEEE 802.11/Wi-Fi or IEEE 802.15.4/ultra-wideband communication (UWB)) in which target sensing is provided or can be introduced.

Throughout the present disclosure, the abbreviation “gNB” (5G terminology) or “BS” (base station) is intended to mean a wireless access device such as a cellular base station or a WiFi access point or a universal serial bus (USB) personal area network (PAN) coordinator. The gNB may consist of a centralized control plane unit (gNB-CU-CP), multiple centralized user plane units (gNB-CU-UPs) and/or multiple distributed units (gNB-DUs). The gNB is part of a radio access network (RAN), which provides an interface to functions in the core network (CN). The RAN is part of a wireless communication network. It implements a radio access technology (RAT). Conceptually, it resides between a communication device such as a mobile phone, a computer, or any remotely controlled machine and provides connection with its CN. The CN is the communication network's core part, which offers numerous services to customers who are interconnected via the RAN. More specifically, it directs communication streams over the communication network and possibly other networks.

Furthermore, the terms “base station” and “network” may be used as synonyms in this disclosure. This means for example that when it is written that the “network” performs a certain operation it may be performed by a CN function of a wireless communication network, or by at least one base station that is part of such wireless communication network, and vice versa. It can also mean that part of the functionality is performed by a CN function of the wireless communication network and part of the functionality by the base station.

Moreover, the terms “radar sensing” and “wireless sensing” are intended to cover not only techniques whereby a single device both sends and receives a radar signal, but also distributed RF based sensing techniques, such as techniques whereby the sensing signal is received by multiple devices in a distributed manner or techniques that are based on sensing of a channel state information (CSI) in a CSI-based distributed sensing solution and/or based on other types measurement information related to RF signals (e.g. multiple-in multiple-out (MIMO) sounding signal feedback, doppler phase shift measurements). It is to be noted that the above terms “radar sensing” and “wireless sensing” can be interchangeably used throughout the present disclosure, and that embodiments describing radar sensing as an example can also extend to other types of wireless sensing, such as e.g. those using a reference signal so that UEs report relevant measurements of said reference signal, e.g., sensing based on channel state information (CSI).

The term “sensing” is used to denote not only “radar sensing” or “wireless sensing”, but sensing using any sensor modality, including cameras, pressure sensors, movement sensors, heat sensors, etc.

Furthermore, the term “data type” is intended to cover different types of data output by sensors of different types. For example, a video camera may output video data, and a lidar sensor may output point cloud data. Moreover, intermediate data types are covered, which aren't output directly by a sensor, but which may have been generated by processing data sets of other types-for example, three-dimensional (3D) mesh data (as explained later). Furthermore, the terms “target” and “target object” indicate any entity that may be subject to wireless sensing. This may include people, animals, inanimate objects, structures consisting of several smaller entities (e.g., a cloud consisting of small waterdrops). Also, the terms “target” and “target object” may be used as synonyms in this disclosure.

Unless otherwise specified, the term “object” is intended to cover any three-dimensional form of interest within an environment on which information may be gathered by sensors. Generally, this includes people (and their motions), animals, vehicles, drones, im-mobile objects, structures consisting of several smaller entities (e.g., a cloud consisting of small waterdrops), etc.

It is noted that throughout the present disclosure only those blocks, components and/or devices that are relevant for the proposed sensing and/or matching function are shown in the accompanying drawings. Other blocks have been omitted for reasons of brevity. Furthermore, blocks designated by same reference numbers are intended to have the same or at least a similar function, so that their function is not described again later.

### Sensing Signals

The sensing function of the following embodiments may be implemented e.g. by a radar functionality in wireless communication involving one or more access devices (e.g., base stations (BS)) and/or one or more terminal devices (e.g., UEs).

As an example, Frequency Modulated Continuous Wave (FMCW) mmWave radar systems can measure range, velocity, and angle of arrival (if two receivers are available) of objects in the scene which reflect radio waves. Such radar systems emit a chirp signal, e.g., a sine wave that increases in frequency over time. The chirp signal (e.g., a continuous wave pulse) has a bandwidth and a frequency increase rate. Generally, a continuous series of such chirps are emitted. The transmitted and received analogue chirp signals are mixed to generate an intermediate frequency (IF) signal which corresponds to the difference in frequencies of the two signals (outbound and inbound) and whose output phase corresponds to the difference in the phases of the two signals.

Each surface of a scene or environment will therefore produce a constant frequency IF signal whose frequency relates to the distance to the surface (i.e., a first distance from the transmitter of the chirp signal to the surface plus a second distance from the surface to the receiver of the chirp signal). To resolve two surfaces at different distances, the two IF signals can be frequency resolved. A longer time window of the IF signal results in greater resolution. As the chirp time is related to its bandwidth (with constant chirp frequency change) the resolution of the radar is related to the chirp bandwidth. The IF signal may then be band pass filtered (to remove signals below some minimal range and frequencies above the maximum frequency for a subsequent analogue-to-digital converter (ADC)) and digitized prior to further processing. The upper frequency sensing range of the bandpass filter and ADC sets the maximum range that can be detected (i.e., IF frequencies increase with range).

To detect vibrations, the phase of the IF signal is important, since the phase (i.e., the difference in phases of the transmitted and received chirp signals) is a sensitive measure of small changes in the distance of a surface. Small distance changes can be detected in the phase signal but may be indiscernible in the frequency signal. Moreover, phase difference measures between two consecutive chirp signals can be used to determine the velocity of the surface.

As an example, a fast Fourier transform (FFT) processing can be performed across multiple chirp signals to enable separation of objects with the same range but moving at different velocities. A Fourier transform converts a signal from a space or time domain into the frequency domain. In the frequency domain the signal is represented by a weighted sum of sine and cosine waves. A discrete digital signal with N samples can be represented exactly by a sum of N waves. FFT provides a faster way of computing a discrete Fourier transform by using the symmetry and repetition of waves to combine samples and reuse partial results. This method can save a huge amount of processing time, especially with real-world signals that can have many thousands or even millions of samples.

As a further example, angle estimation can be performed by using the phase difference between the received chirp signal at two separated receivers.

As another option, a channel state information (CSI) can be used, which is a measure of the phases and amplitudes of many frequencies detected at a receiver, thereby forming a complex ‘map’ of the radio environment, including effects of objects within that environment. CSI characterizes how wireless signals propagate from the transmitter to the receiver at certain carrier frequencies. CSI amplitude and phase are impacted by multi-path effects including amplitude attenuation and phase shift, e.g., by the displacements and movements of the transmitter, receiver, and surrounding objects and humans. In other words, CSI captures the wireless characteristics of the nearby environment. These characteristics, assisted by mathematical modeling or machine learning algorithms, can be used for different sensing applications.

A radio channel may be divided into multiple subcarriers, as is done e.g. in 5G communication systems (using e.g. orthogonal frequency division multiplexing (OFDM)). To measure CSI, the transmitter may send long training symbols (LTFs), which contain pre-defined symbols for each subcarrier, e.g., in a packet preamble. When those LTFs are received, the receiver can estimate a CSI matrix using the received signals and the original LTFs. For each subcarrier, the channel can be modeled by y=Hx+n, where y is the received signal, x is the transmitted signal, H is the CSI matrix, and n is the noise vector. The receiver estimates the CSI matrix H using a pre-defined signal x and the received signal y after signal processing such as removing cyclic prefix, de-mapping and demodulation. The estimated CSI is then a three-dimensional matrix of complex values and this matrix represents an ‘image’ of the radio environment at that time. By processing a time series of such ‘images’ information on movements, locations and vibrations of objects can be extracted.

Such a processing of a CSI matrix can be used for vital signs monitoring, presence detection, and human movement recognition. As an example, neural network like recognition techniques can be used to process the CSI matrix to perform such kinds of recognition.

It is noted that systems using channel state information (CSI) are somehow related to systems with FMCW mmWave radar. In a CSI-based system, the input signal X may be defined and the receiver may use the received signal Y to obtain H, i.e., as H =(Y−N)/X. In a FMCW mmWave radar, the transmitted signal Chirp X may also be predefined, and the receiver may uses the received signal Y to obtain a transfer function as H=Y/X. This last step is in fact somehow related to multiplying the locally computed chirp signal and the received chirp signal and applying a bandpass filter. According to various embodiments described below, the above described wireless sensing techniques are implemented in a mobile communication system (e.g. 5G or other cellular or WiFi communication systems), while the functional coexistence of radar and communication operating in the same frequency bands is configured to avoid interference bandwidths. Thereby, radio sensing can be integrated into large-scale mobile networks to create perceptive mobile networks.

As another example, the sensing signal may consist of a number of pulses sent, e.g., at specific frequencies and timing (sensing signal parameter information) by a sensing transmitter. The sensing receiver may include a number of bandpass filters that allow identifying the sensing signal parameter information, e. g, timing and frequency of the received pulses. In particular, if the transmitter determines a given pseudo-random sequence of frequency/timing pulses and beams it, e.g., by means of beamforming, in a specific direction, and if the transmitter communicates to the receiver the timing/frequency, in general, the sensing signal parameter information, of the transmitted sensing signal, the receiver can use its bandpass filters to identify the reception of the same transmitted pulses, i.e., sensing signal, based on the received sensing signal parameter information.

### (DISTRIBUTED) SENSING CONFIGURATION AND OPERATION

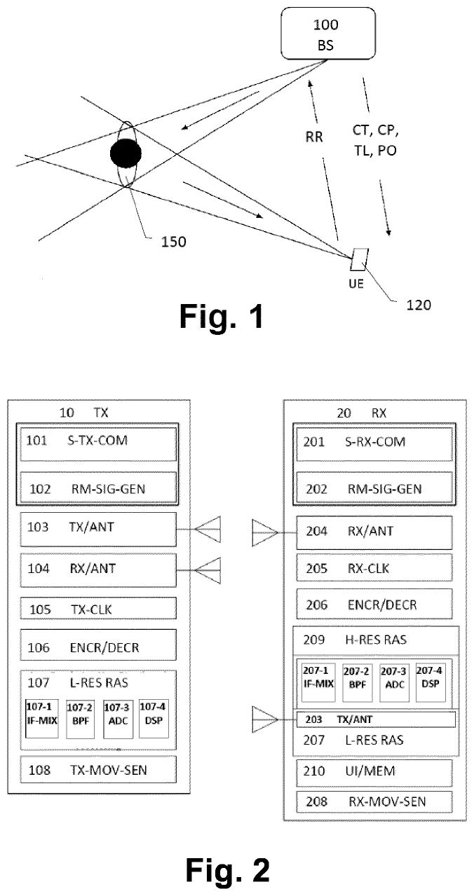

FIG. 1 schematically shows a distributed radar function created via a wireless communication system link, which may be used in embodiments of the present invention.

However, it is to be noted that the present invention can be equally applied for non-distributed sensing services/function where a first sensing device performs sensing centrally and then (after handover) a second sensing device performs sensing centrally. Thus, the described embodiments can be implemented in a single device including both a transmitter and a receiver.

In a distributed radar function, in distinction to a purely centralized radar solution (i.e., whereby the transmitter and receiver of the radar signals are part of or operated by the same device), a part of the 5G (or other cellular or WiFi) network spectrum is configured (e.g., set into a radar mode) or is detected to be quiet/free of communication for a period of time to enable performing, e.g., remote vital signs and other measurements by construction of a distributed radar system between a base station (BS) 100 or UE (as transmitter) and at least one UE 120 or base station (as receiver), while the lack of analogue signal exchange and the additional path length caused by the transmitter-receiver distance and the distance between the receiver (e.g., UE 120) and a target (e.g., human being) may be corrected for. To this end, a base station 100 (or UE) that will act as transmitter may set up a communication link with a UE 120 (or base station) that will act as a receiver (or vice versa) to exchange some control information and/or sensing measurements and/or (partial) sensing results. The control information may include a set of configuration parameters related to the distributed sensing operation. The parameters may include e.g., distance and angle from transmitter to receiver, pulse origination time, pulse phase, frequencies, possibly including chirp timing (CT), chirp profile (CP), target location (TL), phase offset (PO), time between subsequent sensing signals, number of repetitions, sensing signal waveform information, amplitudes, MIMO/beamforming parameters, number of transmitter antennas used, transmit power, potential interference patterns, an identifier/address (e.g., internet protocol (IP) address/uniform resource locator (URL) address) of a destination server and/or network function/device for sending the sensing results to (e.g., for storage or further processing), session or application related information (e.g., session identifier or application identifier), a desired accuracy for the sensing measurements, etc., and may be communicated in response (e.g., as a radio resource control (RRC) Connection Reconfiguration message including, e.g., a measurement configuration as specified in 3GPP TS 38.331 extended with sensing configuration parameters) to a request for radar (RR) (e.g., an initial Attach Request message from a UE to a base station or an RRC message or System Information as specified in 3GPP TS 38.331 from a base station to a UE, extended with a sensing request field) from the receiver side (e.g., UE 120), or may be sent to the receiver side by the transmitter side before the transmitter will start sending sensing signals (e.g., as part of a configuration/auxiliary information message/signal), or may be (partially) pre-configured on the receiver (e.g., stored in an universal subscriber identity module (USIM) or stored in a nonvolatile memory at manufacturing time), or may be configured on the receiver by means of a local application, or may be provided by the network (possibly via the transmitter or via another transmitter, or, e.g., provided by an access and mobility management function (AMF), policy control function (PCF), network exposure function (NEF), location management function (LMF), gateway mobile location center (GMLC), or other core network function (e.g., as specified in 3GPP TS 23.501)) as part of policy/system information/RRC configuration/session configuration (e.g., upon initial registration or connection setup of the receiver to the network or a previous initial registration/connection setup). These parameters may be configured differently per application (e.g., based on the sensing target or based on the sensing algorithm). A set of parameters may be combined in the form of a sensing profile that may be identifiable, e.g., by means of a profile identifier or application identifier or device identifier. After a sensing profile is sent/configured/pre-configured on a receiver, the activation of a sensing profile may be triggered by sending a signal/message to the receiver with an indicated sensing profile identifier. The sensing profile and/or the configuration parameters may also include an algorithm identifier, filter identifier or machine-learning model identifier to trigger the application of respectively a specific sensing algorithm, a filter or a machine learning model to use for analyzing/processing the received sensing signals. These algorithms, filters or models may be pre-configured/stored at the receiver beforehand, or transmitted by the transmitter to the receiver (e.g. as virtual machine code, filter parameters/code or model data), for example in a separate message, or may be downloaded (e.g., as virtual machine code, filter parameters/code or model data) by the receiver based on, e.g., a download URL or IP address of a server, may be configured for the application required. For example, if a precise distance measurement is required, the full set of parameters may be communicated, while if a phase-based velocity is required, only chirp parameters may be required. In some applications, the chirp parameters may be predefined and only an identifier indicating the set of chirp parameters may be exchanged. The parameters may also include a set of time/frequency resources (e.g., a semi-persistent schedule as defined in 3GPP TS 38.321) and/or time/frequency offsets in which the sensing signals are planned to be transmitted and/or when these are expected to arrive at the receiver. This information may also be provided as a time interval in which the receiver is expected to listen to incoming reflected sensing signals (e.g., as an offset to a start time or system frame number/subframe/symbol at which the signal will be transmitted by the transmitter). The start time, offset or time interval to perform the sensing by the receiver may be specified such that it starts at the start time or end time at which the first instance of the sensing signal is received by the receiver (i.e., the one received via a direct non-reflected path), i.e., reception of the first instance of the sensing signal can be used by the receiver to trig-ger/activate active sensing of the reflected sensing signals. The parameters may also include information about quiet periods or guard intervals that may be taken into account by the receiver device. In addition, the parameters may include information about encoded identity information or special symbol/preamble or a unique signal characteristic that can enable the receiver to uniquely identify the respective sensing signal from possible other sensing or communication signals. In order for the receiver to be capable of determining which parts of the sensing signal has encoded information in it (e.g., signal identity information, timestamp of when the transmitter sent the signal), additional timing or frequency information may be provided to identify start/end times or a subdivision of time intervals within the time interval for receiving a complete single sensing signal, that indicates where in the sensing signal the receiver can find the encoded information. In a similar way as for the sensing receiver, the sensing transmitter may be configured by the network (e.g., by an access and mobility management function (AMF), policy control function (PCF), network exposure function (NEF), location management function (LMF), gateway mobile location centre (GMLC), or other core network function (e.g., as specified in 3GPP TS 23.501)) as part of policy/system information/RRC configuration/session configuration (e.g., upon initial registration or connection setup of the sensing transmitter to the network or a previous initial registration/connection setup) with parameters on how to perform the sensing (e.g., pulse origination time, pulse phase, frequencies, possibly including chirp timing (CT), chirp profile (CP), target location (TL), phase offset (PO), time between subsequent sensing signals, sensing signal waveform information, amplitudes, MIMO/beamforming parameters, number of transmitter antennas to be used, transmit power, quiet periods or guard intervals that may be taken into account, etc.) and/or which algorithm, filter, sensing profile to use and/or which destination server and/or network function/device to send the sensing results to (e.g., for storage or further processing) and/or session or application related information (e.g., session identifier/application identifier), etc. The above-mentioned parameters for sensing may also be pre-configured on the transmitter (e.g., stored in USIM or stored in a nonvolatile memory at manufacturing time), or may be configured on the transmitter by means of a local application, or may be provided by the receiver.

Note that the LMF may comprise or connect to a set of services/functions (e.g., Gateway Mobile Location Centre (GMLC)) that may together be responsible/capable of determining, verifying, providing and/or storing a set of locations, distances, angles, coordinates, and other relevant information for location and/or ranging services, and/or managing/configuring/operating a set of location and/or ranging services, and/or combining distances, angles, location information with distance, angles, location information from other sources or resulting from various location/ranging mechanisms. The term “LMF” denotes any such service/function or combination thereof.

In order to facilitate the configuration of the above mentioned sensing parameters, a sensing receiver or sensing transmitter device may provide its sensing related capabilities to the network (e.g., a core network function, or a service (operated/offered by the network) responsible for managing and/or performing the sensing (i.e., a sensing service), or an application function for managing and/or using the results of the sensing operations (i.e., a sensing application)), to one or more base stations, or to the other device(s) involved in the distributed sensing (e.g., to the sensing transmitter device in case of a sensing receiverdevice) by means of a capability exchange message (e.g., as part of the request for radar message, or an RRC UECapabilityInformation message as specified in 3GPP TS 38.331, extended with some fields to denote the sensing related capabilities). The sensing related capability information may include for example device information (such as number of antennas or supported frequency ranges), wireless sensing signal processing capabilities (such as which algorithms supported, and/or whether it is capable of determining certain sensing results/goals (e.g., capable of determining a position or movement of a target object or a shape of a target object), one or more supported sensing profiles, etc.), wireless sensing signal transmission capabilities (whether this is supported and if so at which frequencies, etc.). The sensing receiver may be configured differently based on the received capabilities of the sensing receiver and/or sensing transmitter. The sensing transmitter may be configured differently and/or adapt the sensing signal based on the received capabilities of the sensing receiver and/or sensing transmitter.

The parameters to use for the configuration of the sensing transmitter and sensing receiver may depend on and be adapted based on sensing requirements that may be provided, e.g., through an application function or a network exposure function or other core network function/service or application, for example a sensing service or a sensing application. Such sensing requirements may, e.g., identify the type of sensing results that are expected to be calculated (e.g., movement, position, shape, material, biometrics), information about one or more target objects (e.g., information about rough location, last known location, identifiable features or already known features such as size or material or shape) and/or quality of service (e.g., desired accuracy, sampling rate) and/or information about algorithms/filters to be used and/or session/application related information (e.g., application identifier or session identifier).

In FIG. 1, the base station (BS) 100 and/or the UE 120 determine(s) the (rough) location or area or volume of the target 150 by emitting a series of signals, e.g., chirp signals, that may be beamformed in the direction of the target 150. The (rough) location may also be in the form of a relative position, e.g., a set of distances and/or angles relative to a reference point (e.g., the transmitter or the receiver).

Optionally, e.g., before the actual radar sensing procedure is started between a transmitter and a receiver, the target angle and distance and/or target shape and/or target material/reflectivity characteristic may be determined using a location estimation radar operation and/or target shape determination operation and/or target material/reflectivity characteristic determination operation at the transmitter (e.g., base station (BS) 100), unless it is already known. This information may be stored at the transmitter and/or may be provided to the receiver and/or may be provided to a network function responsible for collecting the sensing measurements and/or (partial) sensing results and which may perform further processing on these sensing measurements/results to determine further sensing characteristics of a particular target.

Depending on the target sensing application, ahead of emitting a (chirp) signal, the precise timing of the phase and frequency (and optionally amplitude) of each individual (chirp) signal may be communicated (e.g., by using a protected standard communication signal) to the receiver (i.e., UE 120) optionally along with the location or relative position of the emitter (i.e., BS 100) and optionally rough location of the target 150. The idea of protected communication (encryption and/or integrity protection) is to make sure that only the target receiver can use this information. Based thereon, the receiver may optionally determine a path length and angle from the transmitter to the receiver and internally synthesize an analogue (chirp) signal matching the emitted (chirp) signal. Received and synthesized signals can be used for sensing purposes.

If the relative positions and exact times are known, the path length of reflected sensing signals via a target 150 can be determined and/or the target surface can be reconstructed accurately, e.g., by detecting a correct intermediate frequency (IF) signal at a mixer output when the signal is a chirp signal. Knowing the rough position of the target object and/or by detecting the angle of arrival of the incoming reflected sensing signal(s), a distance or angle between the receiver and the target object and/or the emitter and the target object may be calculated. Knowing the phase and therefore phase difference, the velocity of the target 150 can be determined based on the frequency.

If only the velocity of the target 150 is required (as opposed to its position and velocity), the transmitter can optionally avoid providing its relative position and only communicate the phases, timing and frequency of emitted sensing signal. In certain cases, only the sensing signal itself may be transmitted to the receiver so that the receiver can use that sensing signal assuming a fixed time delay to compute the IF signal from which the velocity of the target can be derived. This may be of particular interest to measure vital signs such as breath or heart rate. For instance, it may allow to measure the speed of the breast when breathing and derive from it the breathing rhythm.

Given good enough reflecting surface location estimation, the receiver may enable further data to be collected, such as skin conductivity.

In an example, the radar sensing capability can be achieved by the following procedures. The parameters of the sensing signals to be used in the transmitter sensing generation process, the rough location or relative position of the target and the position offset/angle from the transmitter to the receiver (e.g., UE 120), or the absolute/geographic location of the transmitter along with a future time or a set of time/frequency resources for first (and subsequent) sensing signals, are determined and communicated from the transmitter to the receiver by using, e.g., a protected communication signal.

Alternatively, some of the parameters may also be pre-configured at the receiver or may be configured at the receiver by means of a local application or may have been sent by the transmitter or the network at an earlier time (e.g., during a previous session). Then, the communicated parameter information is (optionally) decrypted and/or verified by the receiver. Thereafter, the transmitter emits sensing signals at the stated time by using, e.g., its discrete Fourier transform spread orthogonal frequency division multiplexing (DFT-s-OFDM) signal generation process to generate the sensing signal. The receiver may listen to the sensing signals at the time/resources as indicated in the parameter information. The receiver may use its DFT-s-OFDM signal generation process to generate an internal synthetic sensing signal (e.g., chirp) matching the parameters supplied, optionally with a delay corresponding to the direct distance from the transmitter to the receiver, thereby minimizing the IF frequency generated in the receiver. The receiver may use the supplied sensing parameter information and/or the internal representation of the sensing signals to configure its radio frequency (RF) reception frontend or signal detection unit to identify/detect the sensing signal amongst the signals received by the RF reception frontend. Upon detection and/or further processing of the received sensing signals, the receiver may determine and record/store start/end times, phase shifts, frequencies, amplitudes, signal deformations, signal strength, interference patterns, detected special symbols/preambles, encoded identity information of the sensing signals and/or timing of quiet periods between sensing signals. The receiver may use this information to further determine whether the received sensing signals are actually reflected by a target object or have been received via a direct non-reflected path between the transmitter and the receiver, in order to filter out only the relevant sensing signals to extract sensing information about a target object. To this end, the receiver may calculate the expected path loss and/or timing between transmitter and receiver for direct path, and expected path loss and/or timing via indirect reflected path via the target, and use this in the determination of whether the received sensing signals are actually reflected by a target object or have been received via a direct non-reflected path between the transmitter and the receiver.

Alternatively, the transmitter may calculate the expected path loss and/or timing between transmitter and receiver for direct path and expected path loss and/or timing via indirect reflected path via the target, and send this information to the receiver, which can then use this in the determination. The receiver may form an IF signal using (e.g., mixing) the internal synthetic “emitted” sensing signal and the received sensing signal reflected at the target 150 and may perform band pass (or optionally only high pass filtering at the maximum frequency of the ADC) filtering and ADC to digitize the IF data and/or to digitize raw/filtered received reflected sensing signal data. To this end the receiver may create a compressed or uncompressed digitally sampled representation of the IF signal or the received raw/filtered reflected sensing signal(s), with a sampling frequency pre-configured at the receiver device, or a sampling frequency provided by the transmitter (e.g., as part of the sensing signal parameters). Also, information about which compression method/format to apply may be provided by the transmitter (e.g., as part of the sensing signal parameters) or pre-configured at the receiver. The digital IF signal may then be processed to yield application specific data (e.g., the output of one or more (pre-configured) algorithms or machine learning models), in this case sensing results related to the target (e.g. certain characteristics of the target such as its position, speed, shape, size, material composition etc. that may be determined after performing the respective signal processing/analysis on the received (reflected) sensing signals), or the digitized data from the receiver can be transmitted to the transmitter or a network function/device or a cloud to perform further application specific processing.

In addition to the processed or digitized data, the receiver may include identification information of the signal, sensing profile, algorithm/model, and/or the device, and may include timing and/or measurement information (e.g., arrival/end times, phase shifts, frequency, amplitude or signal deformations of the sensing signals) and/or antenna information/antenna sensitivity/MIMO configuration/beamforming configuration used by the receiver for sensing, and/or location/distance/angle related information of the receiver relative to the transmitter and/or the target, or as absolute coordinates, and/or information about the sensing application or sensing session (e.g., application identifier or session identifier).

A complete separation of transmitter and receiver in a digital radio system such as 5G implies that the receiver has no access to the analogue version of the directly emitted signal (phase, frequency), only the reflected sensing signal, and therefore cannot form the IF signal in the analogue domain. This would mean that all processing is performed on the received analogue signals (which requires a very fast ADC is to digitize the received “raw” sensing signal).

Furthermore, in the proposed distributed radar sensing system, the distance to the reflecting surface of the target 150 depends on both the distances from the transmitter to the target 150 and from the receiver to the target 150 (rather than simply being twice the distance from the transmitter to the target, as in non-distributed radar systems).

The “minimum range” of the measurement corresponds to the direct distance from the transmitter to the receiver. Of course, objects may be measured which lie at smaller distances from the receiver, but their indicated range will always be greater than the direct distance from the transmitter to the receiver. Equal time returns lie on spatial position ellipses (return ellipses) having the transmitter and receiver positions as their two focal points. The minimum (degenerate) ellipse with a short axis length of zero (a straight line between transmitter and receiver) has a minimum delay time, which is the time taken for radio waves to go directly from transmitter to receiver.

The receiver may receive a signal corresponding to the directly transmitted signal straight from the transmitter to the receiver (a pseudo-surface at “zero” range, i.e., points on the direct line between transmitter and receiver).

Therefore, the proposed integrated distributed radar system may require a kind of clock-level synchronization between transmitter and receiver to remove ambiguity in sensing parameter estimation.

Furthermore, the auxiliary information signals (e.g., radar request and responded parameters) can be communicated between the transmitter to the receiver via an alternative communication route (using, e.g., a separate band, a beam formed sub-beam directed at the receiver, or time interspersed signals between sensing signals) so that the receiver can obtain a representation of required details of the transmitted signal (e.g., precise timing, phase of the continuous (chirp) signal) in order to simulate the mixing of the transmitted and received signals to obtain an IF signal without requiring direct analysis of the analogue emitted signal. This could be done by, for example, internally generating an analogue version of the identical emitted sensing signal using the parameters supplied via the auxiliary information signal. Thus, to ensure that a correct timing is provided for this mixing of a simulated transmitter sensing signal and the actual received sensing signal, the transmitter should signal the precise timing, phase, frequencies etc. of the emitted signal to the receiver ahead of time.

Furthermore, the receiver may use the auxiliary/(pre-)configured information/parameters about the sensing signal to distinguish between a sensing signal received via a direct non-reflected path, versus reflected sensing signals. The receiver may ignore the sensing signals received via a direct non-reflected path (e.g., by ignoring the first instance of receiving the sensing signal (for example, by checking the arrival time of the sensing signal, or by checking for phase shifts, frequency changes, signal deformations, amplitude changes, interference patterns that correspond to identify which of the sensing signals has been reflected or not), or may use these signals to more accurately determine its relative position/distance/angle towards the transmitter. The receiver may also use the signal received via a direct non-reflected path as further input to the signal analysis algorithm/model, e.g., as additional reference signal for IF calculation, (relative) position calculation or additional phase shift/signal deformation/frequency/amplitude calculations.

Additionally, the distance and angle from the transmitter to the receiver or the absolute/geographical position of the transmitter may be signaled as well, in order to calculate the correct positions for detected surfaces.

Finally, if the receiver (or transmitter, or both) is a hand-held device, the movements and vibrations of that device(s) may be measured by corresponding sensors, in order to subtract them from the movements and vibrations of the detected surfaces for some sensing applications.

The proposed distributed radar system between, e.g., the base station (BS) 100 (as the transmitter) and the UE 120 (as the receiver and analyzer) provide the advantage that the receiver may be located more preferentially for obtaining the reflected sensing signals at higher signal strength than the transmitter (i.e., using the receiver part of the transmitter device to monitor the reflected sensing signals, e.g., as in the case of non-distributed sensing), for example it may be closer or more in the path of the reflected sensing signal, and may avoid some of the clutter from the transmitted signal.

Moreover, a single antenna may not operate in full continuous duplex mode, while the proposed distributed radar system separates the transmitter antenna from the receiver antenna.

As a further advantage, multiple receivers can be used with a single transmitter, each possibly associated with collecting vital signs from a different target (e.g., individual human being).

However, as explained above, the sensing may be performed centrally by a single first device and, after sensing handover, the sensing may again be performed centrally by a single second device.

### Sensing Transmitter and Receiver Architecture

FIG. 2 schematically shows an embodiment of a summarizing transmitter and receiver architecture (including optional elements and functions) of a communication system with distributed sensing capability.

Although the architecture shows the transmitter device and receiver device as distinct devices in a distributed sensing system, the functions of the sensing transmitter and sensing receiver may be co-located in the same device (e.g., in case of a centralized sensing architecture), whereby (a subset of) similar functions and elements are expected to be present.

The proposed distributed radio wave sensing radar/communication system comprises a transmitter device (TX) 10 and a receiver device (RX) 20 and is configured to operate over a suitable radio frequency range (such as the initially mentioned mmWave range) and comprises RF hardware and signal processing algorithms to enable both standard communication, e.g., 5G, and radar sensing for vital signs, object detection and/or movement recognition. In 5G systems, two options for an uplink (UL) waveform are provided. One is cyclic prefix OFDM (CP-OFDM, same as downlink (DL) waveform) and the other one is discrete Fourier transform spread OFDM (DFT-s-OFDM) which corresponds to the UL waveform in long term evolution (LTE) systems (i.e., fourth generation (4G)). Transform precoding is the first step to create the DFT-s-OFDM waveform, followed by sub-carrier mapping, inverse FFT and cyclic prefix (CP) insertion. Whether a UE needs to use CP-OFDM or DFT-s-OFDM can be determined by a radio resource control (RRC) parameter.

A 5G transmitter or receiver with integrated radar sensing capability may have slightly modified DFT-s-OFDM and frequency domain spectral shaping (FDSS) filters enabling them to generate suitable chirps. Linear and other chirp signals can be generated with DFT-s-OFDM signals via a well-designed FDSS filter enabling standard communication hardware with only minor modification to generate suitable signals for radar. Their framework offers a way to efficiently synthesize chirps that can be used in dual-function radar and communication (DFRC) or wireless sensing applications with existing DFT-s-OFDM transceivers.

Other options for generating a signal suitable for simultaneously performing data transmission and radar sensing are described in Cong Li et al.: “Radar Communication Integrated Waveform Design Based on OFDM and Circular Shift Sequence”, Mathematical Problems in Engineering, July 2017, and are based on a peak-to-mean envelope power ratio (PMERP) and a peak-to-side-lobe ratio (PSLR) of OFDM waveforms. To be specific, a Gray code technology can be adopted to reduce the PMERP and simultaneously choose an optimal cyclic sequence to improve the PSLR of an OFDM waveform. The optimal cyclic sequence is dynamically generated to continuously provide the best waveform according to the change of communication data. In addition, to meet the requirements of different radar detection tasks, two simple methods can be utilized to adjust the bandwidth of the OFDM waveform. One method is to design different subcarrier complex weights and the other method is to utilize a phase code technique.

The transmitter device (TX) 10 may be an access device (e.g., base station) or a terminal device (e.g., UE or internet of things (IoT) device) and comprises a standard transmitter communication unit or system (S-TX-COM) 101 enabling standard communication, e.g., 5G, capabilities using, e.g., DFT-s-OFDM generated data communication signals. By operating in a “radar mode”, the transmitter communication system 101 is capable of forming a radar mode signal generator (RM-SIG-GEN) 102 capable of, e.g., generating linear chirp signals (chirps) using minimally modified communication components. This can be achieved, e.g., by a using (slightly) modified DFT-s-OFDM with a suitable FDSS filter for converting the single-carrier nature of the DFT-s-OFDM signal to a linear combination of chirp signals circularly translated in the time domain, as described, e.g., in Alphan Sahin et al.: “DFT-spread-OFDM Based Chirp Transmission”, IEEE Communications Letters, Volume: 25, Issue: 3 Mar. 2021. By exploiting properties of Fourier series and Bessel function of the first kind, an FDSS filter for an arbitrary chirp can be obtained.

Furthermore, the transmitter device 10 comprises a transmission frontend (TX/ANT) 103 (e.g., capable of operating in mmWave frequencies) including a transmitter coupled to antenna with beam forming capabilities.

Optionally, a reception frontend (RX/ANT) 104 (e.g., capable of operating in mmWave frequencies) may be provided (e.g., as a separate component or integrated with the transmission frontend 103 in a joint transceiver frontend), which includes a receiver coupled to an antenna with beam forming reception capabilities (e.g., if an additional non-distributed transmitter-only radar operation is to be performed to determine a target location, shape/size or material/reflectivity characteristic).

Additionally, the transmitter device 10 comprises a transmitter clock generator (TX-CLK) 105 for generating an accurate system clock for the transmitter device 10.

Optionally, a transmitter time delay measurement functionality (not shown) may be provided (e.g., implemented by a processor/controller of the transmitter device 10), which uses the standard transmitter communication unit 101 to perform a two-way time delay measurement with a cooperative receiver device (e.g., the receiver device 20).

Optionally, an encryption and decryption functionality (ENCR/DECR) 106 may be provided for implementing a suitable data encryption/decryption scheme (based on, e.g., the Advanced Encryption Standard (AES) algorithm or the Rivest, Shamir and Adleman (RSA) algorithm) and data integrity verification (e.g., a data verification scheme using a message authentication code or digital signatures). For instance, data may be distributed in a protected radio resource control (RRC) message.

As a further option, the transmitter device 10 may comprise a non-distributed (low-resolution) transmitter radar analysis system (L-RES RAS) 107, i.e., a radar analysis system that may comprises a receiver device and/or may comprise a (low-resolution) transmitter radar analysis system, which provides a non-distributed location radar scanning capability, which may include an intermediate frequency (IF) generation mixer (IF-MIX) 107-1 to which a copy of an emitted sensing signal and an externally received reflected sensing signal are supplied and mixed to generate a mixed signal including an IF signal. Furthermore, the transmitter radar analysis system 107 may comprise electronic signal processing components—including a transmitter band pass filter (BPF) 107-2 and an analog-to-digital converter (ADC) 107-3—capable of IF filtering and analogue to digital conversion of the generated IF signal. Moreover, the transmitter radar analysis system 107 may comprise a digital signal processing component and algorithm system (DSP, implemented by, e.g., a digital signal processor) 107-4 which provide DSP capabilities for, e.g., location detection, preprocessing by clutter removal, etc.

As a still further option, the transmitter device 10 may comprise sensor components including transmitter movements sensors (TX-MOV-SEN) 108, such as accelerometers or the like, which measure movements and vibrations of the transmitter device 10.

Furthermore, the receiver device 20 may be an access device (e.g., base station) or a terminal device (e.g., UE or Internet of Things (IoT) device) and may comprise a standard receiver communication unit or system (S-RX-COM) 201 that provides standard communication capabilities, e.g., in 5G, using, e.g., DFT-s-OFDM-generated data communication signals. By operating in a “radar mode”, the receiver communication system 201 may be capable of forming a radar mode signal generator (RM-SIG-GEN) 202 that, e.g., generates linear sensing signals, e.g., by using a (slightly) modified DFT-s-OFDM signal, wherein the generated sensing signals may be used internally and not coupled to a transmitter and antenna. The waveform of the sensing signal may be generated from specific input parameters that may include at least one of a specific start time, a phase, an amplitude, a base frequency, a band width, a frequency slope, a sensing signal repetition frequency, a gap between sensing signals, and a total number of sensing signals.

Furthermore, the receiver device 20 comprises a reception frontend (RX/ANT) 204 which includes a receiver coupled to a antenna with beam forming reception capabilities, and which may be capable of operating in mmWave frequencies.

Additionally, the receiver device 20 comprises a receiver clock generator (RX-CLK) 205 for generating an accurate system clock for the receiver device 20.

Optionally, a receiver time delay measurement functionality (not shown) may be provided (e.g., implemented by a processor/controller of the receiver device 20), which uses the standard receiver communication unit 201 to perform a two-way time delay measurement with a cooperative transmitter device (e.g., the transmitter device 10).

Optionally, an encryption and decryption functionality (ENCR/DECR) 206 may be provided for implementing a suitable data encryption/decryption scheme (based on, e.g., the Advanced Encryption Standard (AES) algorithm or the Rivest, Shamir and Adleman (RSA) algorithm) and data integrity verification (e.g., a data verification scheme using a message authentication code or digital signatures) matched to the scheme(s) used on the transmitter side. For instance, data may be distributed in a protected radio resource control (RRC) message.

As a further option, the receiver device 20 may comprise a (low-resolution) non-distributed radar analysis system (L-RES RAS) 207 which provides a non-distributed location radar scanning capability, i.e., a radar analysis system that may comprise a receiver device and/or may comprise a (low-resolution) transmitter radar analysis system, which may include a transmitter frontend (TX/ANT) 203 including a transmitter coupled to an antenna with beam forming capabilities of the receiver device 20.

Additionally, the (low-resolution) radar analysis system 207 may include components which are shared with an additional high-resolution distributed radar analysis system (H-RES RAS) 209 and which may comprise an IF generation mixer (IF-MIX) 207-1, to which a (internally generated) copy of an emitted sensing signal and an externally received reflected sensing signal are input to generate a mixed signal including an IF signal, electronic signal processing components including a receiver band pass filter (BPF) 207-2 and an ADC 207-3 and capable of IF filtering and analogue to digital conversion of the generated IF signal, and an electronic and digital components and algorithm system (DSP, e.g., a digital signal processor) 207-4 which provide DSP capabilities for, e.g., location detection, preprocessing by clutter removal, etc.

The high-resolution distributed radar analysis system 209 may be configured to share electronics components of the IF generation mixer 207-1, which is configured to mix the inputs of an internally generated sensing signal based on supplied timing/phase parameters produced by the radar mode signal generator 202 and an externally received sensing signal supplied by the receiver frontend 204, electronic components of the receiver band pass filter 207-2 and ADC 207-3, which take an analogue IF signal, filter it with a suitable bandpass filter and perform analogue to digital conversion, and the electronic and digital components and algorithm system 207-4, which provides DSP capabilities for desired applications, including pre-processing by clutter removal etc. In order to prevent leakage/tampering of potentially privacy sensitive sensing information about a target, the radar analysis should run in a secure tamper-resistant subsystem, and the resulting sensing information should be stored on a secure storage and/or encrypted with non-tamper resistant credentials (such as subscriber identity module (e.g., USIM) credentials)

Alternatively, a final digital processing could be off-loaded from the receiver device 20 to the transmitter device 10 or to a network function/device or a cloud computing resource, which may return obtained results.

Optionally, the receiver device 20 may comprise a user Interface (UI/MEM) 210 with data storage and display capabilities, which can input information from a user, store data in the receiver device 20 and output displays to the user. Specific elements of the user interface 210 may be dependent on the type of receiver device (e.g., UE) and its function. For example, a hand-held smartphone device may have a sophisticated user interface 210 and display, while an IoT monitoring device may simply have a visual or auditory alarm.

As a further option, the receiver device 20 may comprise receiver movements sensors (RX-MOV-SEN) 208 such as accelerometers, cameras, structured light sensors, etc., which measure movements and vibrations of the receiver device 20, and locations of nearby objects. The receiver device 20 may also communicate via its transmitter standard communication unit 201 to the transmitter device 10 its movements and vibrations by using a receiver movement data series during a sensing time interval, which have been obtained by the receiver movements sensors 208. The receiver movement data series may be sent to the transmitter by using a separate communication channel between the receiver and transmitter (e.g., as a series of RRC or media access control (MAC) control element (CE) messages).

### Matching Sensed Objects from Multiple Viewpoints

The following embodiments allow for various use cases to identify objects in the field of view of a device (e.g., AR glasses) and use cases to identify when two different devices/sensors have sensed or are sensing the same person or object. The underlying “perceptive” wireless network may consist of many terminal devices (e.g., UEs) and base stations (e.g., gNBs) with varying capability and modality deployed for sensing objects in the environment. An identification/matching feature can be accomplished when one or more devices/sensors generate data from one or more viewpoints, whereby data is matched to a set of criteria and/or whereby the data is matched with a simulated/calculated/received set of (possibly synthetic) data from the same or another viewpoint, and/or whereby data from two or more devices/sensors generate data of different data types, whereby the semantics of the data of one data type matches the semantics of the data of another data type.

A viewpoint (or point of view) is a position in a reference coordinate system from which an object or target area/volume is sensed. Together with the field of view of a sensor being used to sense a target object or target area/volume, and the heading of the sensor (e.g. direction/orientation/angle of the field of view the sensor, or viewing angle), it determines how an object or area is sensed (e.g. which parts of the surface of an object can be captures/sensed by the respective sensor and under which angle).

A field of view (FoV) is typically the span over which a given scene can be imaged by a sensor (e.g., a camera), i.e., extent of the observable world that can be sensed. It may be represented by a set of angles in 3D space and/or by an angle together with a direction/orientation and/or by an angular area and/or by a focal length (e.g., of a lens) and a sensor size.

A sensor may be omnidirectional, i.e. is capable of sensing all around, which may be indicated by a FoV of 360 degrees or by an omnidirectional flag/attribute The proposed solutions can be implemented in multiple use cases, e.g.:
1. In a metaverse or MR scenario where multiple users are using UEs or other terminal devices to interact with their respective metaverses in a single shared physical location, an interoperability issue may arise where digital assets related to one user need to be rendered by the UE or other terminal device of a user who is currently viewing them. The UE of the viewing user may not locally have the information required to identify key details of the viewed user (such as the identity of the user currently being viewed) and/or the metaverse that viewed user is participating in, and thus, which digital assets to render in relation to them (e.g., their digital outfit). There is therefore a need for the UE of the viewing user to attain the above information. In an example, the information (e.g., identity) of the viewed user may be derived from data which is locally available to the UE of the viewing user (such as the pose data of the viewed user) and/or from capabilities of the wireless network to which all participating UEs are connected, including sensing and communications.
2. In asset tracking, assets are typically tracked by affixing a network-connected asset tag to them. However, such asset tags can be removed from assets, or attached to other assets, without the knowledge of the network or asset owner. Thus, the proposed matching feature can be applied to such asset tags.
3. A perceptive network capable of collecting pose, gait or morphological information from an individual via doppler radar may be able to contribute to authentication of that individual.
4. When a UE or other terminal device passes between cells, service continuity will be required for sensing functions (as in calls and data functions). This could be achieved by using the proposed matching function to “expect” (anticipate) that a UE or other terminal device of a given physical form and motion arrives in a cell. In a sensing scenario, sensing the same target object from different viewpoints and/or different sensing modalities can increase the accuracy of the sensing measurements/results and/or improve the identification/matching of a target object (e.g. in a crowded area) and/or increase the robustness of the sensing of a target (in case one of the sensing modalities gets compromised (e.g. something blocks camera view). To this end it is important to be able to identify if two devices/sensors are sensing the same target object and/or are able to convert one type of sensing data to other types of sensing data and/or are able to calculate, match or interpret sensing data from different viewpoints or matching criteria

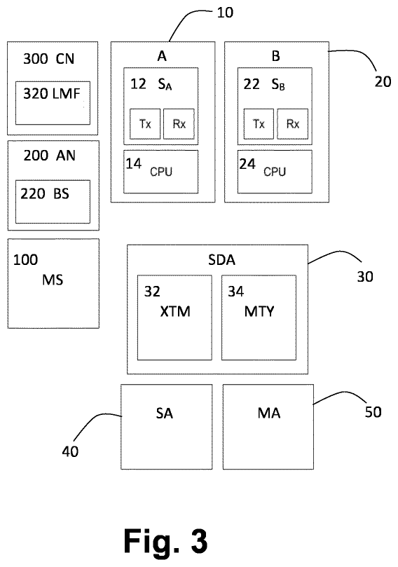

FIG. 3 schematically shows a sensing and communication system with data processing and matching algorithms according to a first embodiment.

A first device (A) 10 contains necessary antennas, communication interfaces, and other components (e.g., a central processing unit (CPU) 14 for processing data) to communicate via communication networks such as a 5G system comprising mobile station(s) (MS) 100, such as a UE, a radio access network (RAN) 200 comprising at least one access device (e.g., gNB) 220 and a core network (CN) 300.

Furthermore, the first device 10 contains at least one sensor (SA) 12 (with optional transmitting (Tx) and receiving (Rx) units for radio-based sensing) for generating at least one data type (measured data of the first device 10) based on the sensed information. The at least one sensor 12 may include video camera, lidar, sonar, accelerometers, radar, etc.

A second device (B) 20, which may have a similar structure (e.g., CPU 24 and optional transmitter and receiver for radio-based sensing) as the first device 10, comprises at least one sensor (SB) 22 which generates a different data type (measured data of the second device 20) based on the sensed information and which has different sensing parameters (e.g., a different position, a different field of view, a different angle of view, etc.).

Sensors 12 and 22 may have a set of properties, which may include a field of view (FoV) of the sensor and/or a heading of the sensor and/or a 3D position of the sensor. Furthermore, the sensors 12 and 22 may be operated by and/or contained in and/or attached to the same device, i.e., the first device 10 and the second device 20 could be the same device. In such a case, the communication of measurement data and/or segmented data and/or capability information etc. may by implemented using device internal communication mechanisms.

Depending on the specific use case of the embodiment (as described above and in more detail later), the first and second device 10, 20 may be a terminal device (e.g., UE), a base station (e.g., gNB) or other type of access device, or any other (network) device with sensing capability and network access.

Furthermore, the system comprises a set of algorithms, wherein any given algorithm may run locally on the hardware of the first and/or second devices 10, 20, and/or as a part of a network function (e.g., location management function (LMF) 320) on a core network (CN) 300 of the wireless network, using hardware that the core network 300 has access to, and/or on 3rd party hardware, as part of an application function (AF), and/or on any other hardware that is accessible by the first or second device 10, 20.

The algorithms may include a (set of) segmentation algorithm(s) (SA) 40 which may segment the measured data of the first device 10 and the measured data of the second device 20 into object-related data (segmented measured data of the first device 10 and segmented measured data of the second device 20) about discrete objects of interest and optionally additional (meta)data related to the discrete objects, such as location. The nature of the segmentation algorithm(s) is dependent on the data type and the use-case-specific embodiment. E.g., for a doppler radar data type, the segmentation algorithm may be configured to cluster reflections and assign temporary labels, while for a video data type, the segmentation algorithm may be equivalent to a pre-trained object recognition algorithm which classifies objects within the video.

Furthermore, the algorithms may include a (set of) synthetic data algorithm(s) (SDA) 30 which may be configured to generate a set of synthetic data based on the segmented measured data of the first device 10. The synthetic data algorithms 30 may be divided into a first algorithm and a second algorithm. The first algorithm is an X-to-Mesh algorithm (XTM) 32 which is configured to generate for a given set of segmented measured data of a given data type of the first device 10 a set of 3D mesh data representative of the object described by the segmented measured data of the first device 10. The second algorithm is a Mesh-to-Y algorithm (MTY) 34 which uses the 3D mesh data to generate the synthetic data. The Mesh-to-Y algorithm may have information about the second device 20, such that the synthetic data may be generated to fit certain criteria, including at least one of the same data type as the segmented measured data of the second device and the same perspective as the sensor 22 of the second device 20 (i.e., to adapt to the appearance of the same object in the segmented measured data of the second device 20) or vice versa (i.e., based on objects detected based on measurement data of the second device 20 to adapt the appearance of the same object in the segmented measured data of the first device 10).

Additionally, the algorithms may include a matching algorithm (MA) 50 which compares the synthetic data derived from the measured data of the first device 10 to the segmented measured data of the second device 20 to identify if any of the segments of the segmented measured data of the second device 20 match the synthetic data of the first device 10 and may output a binary result (matching outcome) for each segment. Optionally, the matching algorithm may be configured to generate a confidence metric (matching confidence) for each matching outcome.

It is noted that the above algorithms 30, 32, 34, 40 and 50 may not always be required or may be combined into more complex algorithms (e.g., all algorithms may be combined in a single algorithm) or may be divided into more simple algorithms (e.g., the matching algorithm may comprise a match algorithm and confidence estimator algorithm.

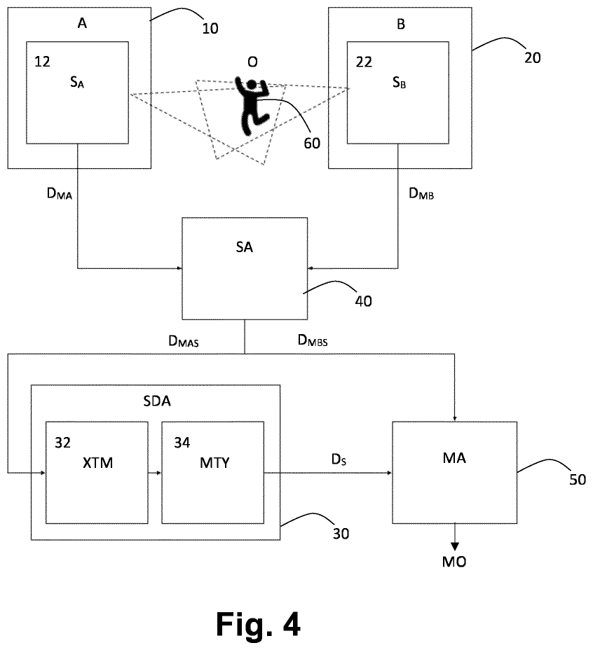

FIG. 4 schematically shows a process flow diagram according to the first embodiment.

A process is described for matching objects described by data of one given data type and collected by one given device with objects described by data of a different given data type collected by a different device. The process is designed to enable two different devices with potentially different data collection capabilities to identify when the same object has been sensed.

The sensor (S_{A}) 12 of first device (A) 10 collects measured data D_{MA}, which may contain data on one or more objects (O) 60. Device (A) 10 may transmit this data to the second device (B) 20 or to the wireless network (e.g., to an object matching service). In addition to the data, device (A) 10 may transmit information about a field of view (FoV) of the sensor 12, capabilities of the sensor 12 (e.g. sensing modality, resolution), a heading of the sensor 12 and/or a 3D position of the sensor 12 or the first device 10 to the second device (B) 20 or to the wireless network.

The sensor (SB) 22 of the second device (B) 20 collects measured data D_{MB} , which may contain data on one or more objects (e.g., including e.g. the one of more objects 60). Device (B) 20 may transmit this data to the first device (A) 10 or to the wireless network (e.g., to an object matching service). In addition to the data, device (B) 20 may transmit information about a field of view (FoV) of the sensor 22, capabilities of the sensor 22 (e.g. sensing modality, resolution), a heading of the sensor 22 and/or a 3D position of the sensor 22 or the second device 20 to the first device (A) 10 or to the wireless network.

The segmentation algorithm(s) (SA) 40 may run on the measured data D_{MA} of the first device 10 and/or the measured data D_{MB} of the second device 20 to produce segmented measured data D_{MAS} of the first device 10 and/or segmented measured data D_{MBS} of the second device 20 related to the one or more objects 60 in the data, respectively.

The synthetic data algorithm(s) (SDA) 30 may run on the segmented measured data D_{MAS} to generate synthetic data D_{S}. For instance, firstly, the X-to-Mesh algorithm (XTM) 32 generates mesh data for each segment-related or object-related data, and secondly, the Mesh-to-Y algorithm (MTY) 34 uses the mesh data to generate the synthetic data D_{S} for each segment-related or object-related data.

Finally, the matching algorithm (MA) 50 compares each segment of the synthetic data D_{S} to each segment of the segmented measured data D_{MBS} and may output a binary matching outcome for each segment (i.e., whether they match or not), as well as an optional matching confidence.

The steps of segmentation and synthetic data generation are an exemplary instantiation of a method in which a synthetic data algorithm runs on the measured data D_{MA} of the first device 10 to generate the synthetic data containing data on at least one object.

In an alternative embodiment, steps of segmentation and synthetic data generation may be performed for the measured data D_{MB} of the second device 20 and the obtained synthetic data may be compared to the segmented measured data D_{MAS} of the first device 10.

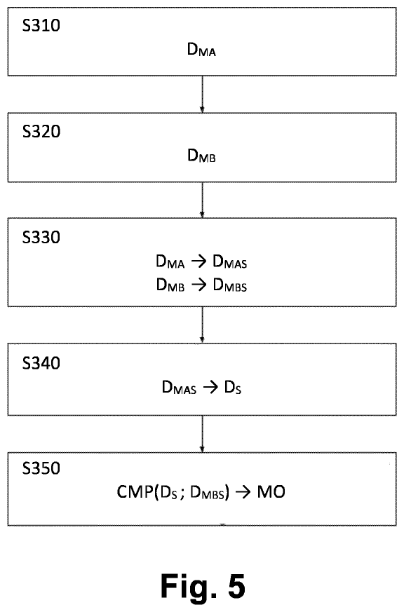

FIG. 5 schematically shows a flow diagram of a matching procedure according to a second embodiment.

In step S310, measured data D_{MA} of a first data type collected by a first device for one or more objects are received or retrieved (e.g., by a network device, which may be a terminal device, an access device or a network function).

In step S320, measured data D_{MB} of a second data type collected by a second device remote from the first device are received or retrieved (e.g., by the network device), which may contain data on one or more objects (e.g., including e.g. the one of more objects of step S310).

In subsequent step S330, the measured data D_{MA} of the first device and/or the measured data D_{MB} of the second device are segmented (e.g., at the network device) to produce segmented measured data D_{MAS} of the first device and/or segmented measured data D_{MBS} of the second device related to the one or more objects in the data, respectively.

Then, in step S340, the segmented measured data D_{MAS} of the first device are processed (e.g., at the network device) to generate synthetic data D_{S}. This may be achieved by first generating mesh data for each segment-related or object-related data and then using the mesh data to generate the synthetic data D_{S} for each segment-related or object-related data.

Finally, in step S350, each segment of the synthetic data D_{S} is compared (CMP) to each segment of the segmented measured data D_{MBS} whereby the output may be a binary matching outcome (MO) for each segment (i.e., whether they match or not), as well as an optional matching confidence.

In an additional embodiment that can be combined with other embodiments, the (segmented) measured data of the second device may be converted to the same intermediate form, e.g., mesh Data, as the measured data of the first device, and matching may be carried out in the intermediate mesh domain, as described in the following third embodiment.

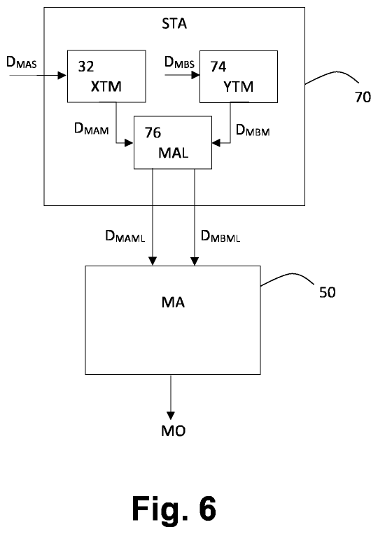

FIG. 6 schematically shows a modified system structure according to the third embodiment, in which an alternative set of algorithms is used for determining a match.

The alternative set of algorithms comprises a (set of) synthetic transform algorithm(s) (STA) 70 which may map both sets of segmented measured data D_{MAS}, D_{MBS} of the first and second devices 10, 20 into a common domain intended to facilitate matching (e.g., the 3D mesh data described above). Other examples for the common domain could a Fourier transform or other kinds of machine vision transforms or an intermediate form to be compared at a later stage. Such an intermediate form could be the 3D mesh data or a Hough transform used in computer vision, for example.

The synthetic transform algorithm(s) 70 may be divided to cover two classes of transforms which may be achieved by first and second algorithms.

The first algorithm is the X-to-Mesh algorithm (XTM) 32 (described above) which is configured to generate, for a given set of segmented measured data D_{MAS} of a given data type of the first device 10, a set of 3D mesh data D_{MAM} representative of the object described by the segmented measured data D_{MAS} of the first device 10.

The second algorithm is a Y-to-Mesh algorithm (YTM) 74 which is configured to generate, for a given set of segmented measured data D_{MBS} of a given data type of the second device 20 a set of 3D mesh data D_{MBM} representative of the object described by the segmented measured data D_{MBS} of the second device 20.

Furthermore, the alternative set of algorithms comprises an additional mesh alignment algorithm (MAL) 76 which is configured to ensure, if necessary, that the 3D mesh data sets D_{MAM} and D_{MBM} of the first and second devices 10, 20 are aligned using e.g. respective position and/or viewpoint data and/or FoV and/or sensing capabilities of the first and second devices 10, 20. Thereby, aligned mesh data sets D_{MAML} and D_{MBML} are obtained.

Alternatively, either device may have information about the other device (e.g., location information) such that the transformed data (e.g., mesh data) can be generated from the perspective of the respective other device.

As another alternative, each device may be supplied (e.g., by the network) with new perspective coordinates for which the transformed data needs to be obtained and/or generated. This may allow matching between far remote devices.

Additionally, the alternative set of algorithms may include a matching algorithm (MA) 50 which compares the two aligned mesh data sets D_{MAML} and D_{MBML} to identify if any of the segments of the aligned mesh D_{MBML} data of the second device 20 match the aligned mesh data D_{MAML} of the first device 10 and which may output a binary result (matching outcome (MO)) for each segment. Optionally, the matching algorithm may be configured to generate a confidence metric (matching confidence) for each matching outcome.

It is noted that the above algorithms 70, 32, 74, 76 and 50 may not always be required or may be combined into more complex algorithms (e.g., all algorithms may be combined in a single algorithm) or may be divided into more simple algorithms (e.g., the matching algorithm may comprise a match algorithm and confidence estimator algorithm.

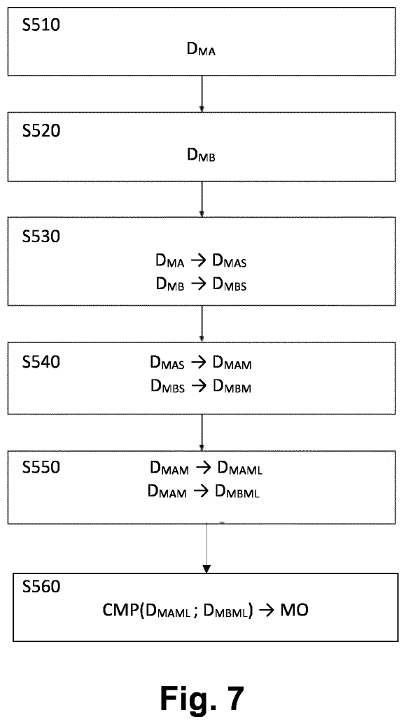

FIG. 7 schematically shows a flow diagram of a matching procedure according to a fourth embodiment.

Steps S510 to S530 of FIG. 7 correspond to steps S310 to S330 of FIG. 5 and are not described again here.

In step S540, the segmented measured data D_{MAS} and D_{MBS} of the first and second device are processed (e.g., at the network device) to generate mesh data D_{MAM} and D_{MBM}, respectively, for each segment-related or object-related data.

Thereafter, in step S550, the mesh data D_{MAM} and D_{MBM} of the first and second devices are aligned (e.g., at the network device) using e.g. respective position and/or point of view data and/or sensing capabilities of the first and second devices. Thereby, aligned mesh data sets D_{MAML} and D_{MBML} are obtained.

Finally, in step S560, the two aligned mesh data sets D_{MAML} and D_{MBML} are compared to identify if any of the segments of the aligned mesh data D_{MBML} of the second device match the aligned mesh data D_{MAML} of the first device whereby the output may be a binary result (matching outcome (MO)) for each segment. Optionally, the matching algorithm may be configured to generate a confidence metric (matching confidence) for each matching outcome.

In an additional embodiment that can be combined with other embodiments, the measured data D_{MA} and/or D_{MB} of the first and/or second device may be stored, e.g., in a database.

In an additional embodiment that can be combined with other embodiments, the segmented measured data D_{MAS} and/or D_{MBS} of the first and/or second device may be stored, e.g., in a database.

In an additional embodiment that can be combined with other embodiments, the mesh data or synthetic data D_{S} may be stored, e.g., in a database.

In an additional embodiment that can be combined with other embodiments, the data that is stored, e.g., in a database, may be stored together with metadata determining the type of device or algorithm that was used to sense or compute the data.

In an additional embodiment that can be combined with other embodiments, when matching is required, the device that performs the matching may retrieve from the storage service (e.g., database) the data that is most suitable, e.g., mesh data, since it reduces the computational complexity of the device (since a single additional transformation is re-quired).

In an additional embodiment that can be combined with other embodiments, the measured data D_{MA} and D_{MB} of the first and/or second device may correspond to measurements of an object over a period of time. This may correspond, e.g., to a video measurement of a user when walking, from which not only mesh data can be extracted representing the form or pose of the user, but also frequency data related to the walking fashion of the user or the heart rate of the user. The synthetic data algorithm(s) might not only transform a specific aspect of the measured data (in this example, video) of the sensed object (e.g., form or pose) when creating the synthetic data (that might correspond to mmWave data), but it may also transform multiple aspects of the measured data, e.g., in this example, form/pose as well as walking gait and/or heart rate.

Additionally or alternatively, an AI model targeted/taught to identify certain object or movement patterns (e.g., walking or breathing or heart beating) may be used to determine based on a set of measured data and/or mesh data or other segmented or synthetic data if a set of measurements of an object over a period of time matches a certain object or movement pattern.

In an additional embodiment that can be combined with other embodiments, the matching algorithm might not only match a single aspect of the measured data, but also multiple aspects to become a multidimensional matching algorithm. The matching can be performed in multiple ways, e.g., by checking that all n aspects viewed as an n-dimensional vector match, or by checking that all n aspects viewed as an n-dimensional weighted vector match, or by deriving a combined confidence value as the norm (e.g., norm 0, norm 1, norm 2, norm infinity) of the n-dimensional (weighted/normalized) vector of the confidence values.

In an additional embodiment that may be combined with other embodiments or may be implemented independently, if based on the data received from the first device 10 and/or second device 20, a match is found (e.g., same object can be detected by both sensors or target object matching a model of an object or a set of data stored for a set of viewpoints, sensor headings and/or FoVs is found) by the first device 10, the second device 20 or a service in the network (e.g., object matching service), the first device 10 or the second device 20 or a service in the network may send a message to the first device 10 or second device 20 to adapt its FoV, sensor heading, viewpoint or sensing resolution, e.g. to improve the sensing of a particular target or to initiate sensing of another target. Such message may include FoV information, angular information, location information, resolution information. Upon receiving such message, the first device 10 or second device 20 may adjust its sensors according to the information in the message. Additionally or alternatively, such message may include information about a focal point or target object information (e.g., mesh data, semantic model of a target, set of target identification information, set of reference coordinates) or target area/volume information, which the first device 10 or second device 20 may use to determine a FoV, sensor heading or viewpoint that enables the first device 10 or second device 20 to sense the given focal point or target object or target area, upon which the first device 10 or second device 20 may adjust its sensors according to the determined FoV, sensor heading or viewpoint. To this end, the first device 10 or second device 20 may have some hardware components to realize this (e.g., an adaptable lens to change the focus, shutters to obscure part of sensor, a rotation mechanism to change the sensor heading, a different radio to perform wireless sensing at higher frequencies). Similarly, if based on the data received from the first device 10 and/or second device 20, no match is found by the first device 10, the second device 20 or a service in the network, the first device 10 or the second device 20 or a service in the network may send a message to the first device 10 or second device 20 to adapt its FoV, sensor heading, viewpoint or sensing resolution, e.g. to improve the sensing of a particular target or to initiate sensing of another target.

Additionally or alternatively, the first device 10 may transmit information to the second device 20 or to a service in the network about a field of view (FoV) of the sensor 22, a heading of the sensor 22 and/or a 3D position of the sensor 22. This information may indicate for which viewpoint, angle and/or FoV the data transmitted by the first device was adapted (e.g., to D_{MAML} and D_{MBML}), and/or may indicate the desired viewpoint, sensor heading and/or FoV that should be used by sensor 22 of device 20 to perform sensing and/or to perform matching. Based on this information, device 20 may be configured or instructed to adapt its viewpoint, sensor heading or FoV accordingly. Similarly, the second device 20 may transmit information to the second device 10 or to a service in the network about a field of view (FoV) of the sensor 12, a heading of the sensor 12 and/or a 3D position of the sensor 12. This information may indicate for which viewpoint, angle and/or FoV the data transmitted by the sensor device was adapted (e.g., to D_{MAML} and D_{MBML}), and/or may indicate the desired viewpoint, sensor heading and/or FoV that should be used by sensor 12 of device 10 to perform sensing and/or to perform matching. Based on this information, device 10 may be configured or instructed to adapt its viewpoint, sensor heading or FoV accordingly.

In the following, the above embodiments described in connection with FIG. 1 to 7 will be described in more detail based on specific use cases.

### Asset Tracking

In an asset tracking use case, assets are commonly tracked via physically attached tags, but tags may be removed and attached to a different object or fall off and become lost.

To address this problem, a user may use a UE (e.g., smartphone with camera, lidar) or other terminal device to image the object at the moment a tag is attached, which may then be used to generate synthetic radar data. This synthetic data may be compared to real radar measurements taken a later time by the wireless network, to confirm that the tag is still attached to the same physical asset.

Note that the user might also use the UE to generate or obtain radar data directly if the UE has radar capabilities. In this case, the radar data can be combined with the synthetic data and the combined data can be used in the later comparison.

Note that the radar data obtained by the UE and the radar data obtained by the wireless network might not directly match since the pose/orientation of the sensors might be different. Thus, it may still be required to transform the data in one of the datasets (e.g., the radar data obtained by the UE) into a synthetic data set of radar data taking into account the sensors and/or viewpoints and/or viewing direction etc. of the UE and the wireless network.

In such an asset tracking use case, the first device (A) 10 of FIG. 3 may be a UE such as a smartphone and the second device (B) 20 may be a line-of-sight sensor, e.g., a camera or lidar sensor. The measurement data D_{MA} of the first device 10 may be a sequence of photographs or a video from multiple angles of the asset (if the sensor 12 is a camera), and/or a set of lidar measurements taken from multiple angles of the asset (if the sensor 12 is a lidar) and/or other measurements of other sensors.

The second device (B) 20 of FIG. 3 may be a UE or base station which comes into proximity with the tracked asset. The sensor 22 may be a radar sensor which may include at least one of dedicated radar sensors placed on the based station (e.g., gNB), communications components used in dedicated sensing mode (e.g., ISAC), and a passive sensing option derived from normal communications signals.

In this use case, the X-to-Mesh algorithm 32 may be an image-to-mesh algorithm (such algorithms may be configured to take multiple photos of an object (e.g., from different angles) as an input to generate a representative mesh) or a lidar-to-mesh algorithm (such algorithms may be configured to receive one or more lidar measurements of an object from different angles to produce a representative mesh, with better accuracy the more angles are covered).

Furthermore, the Mesh-to-Y Algorithm 34 may generate synthetic data D_{S} which emulates one or more cross sections of the asset to be tracked, wherein cross sections based on different viewpoints may be synthesized, which correspond to the predicted view(s) of the imaged asset, as obtained by the sensor 22 of the second device 20.

An additional device (asset tag) may be designed to be attached to a certain object (asset) and/or to be easily geographically tracked. The asset tag may contain all necessary antennas and other components to communicate via communications networks such as the 5G system. As part of its normal operation, the asset tag may periodically report its location to the 5G system. The asset tag may have an associated identifier (asset tag ID) known to the 5G system.

Furthermore, an additional database (asset database) may be provided, which stores the asset tag ID as well as the mesh data and/or a set of (other) matching criteria describing an associated asset.

Moreover, an additional algorithm (tag check algorithm) may be provided, which initiates the process of checking that the asset tag is still attached to the correct asset, by requesting the second device 20 to take a measurement and requesting verification. This may be triggered periodically, may be opportunistic based on the asset tag coming into vicinity of an appropriate second device 20, or may be called by another process on the network when a check is required. If triggered periodically or by an external process, the tag check algorithm may also be responsible for identifying a suitable second device 20, i.e., one with an e.g. radar or lidar sensing capability and which is within range of the asset tag location.

In the following, an example of a procedure related to this use case is described.

A user attaches an asset tag to an asset to be tracked. At the time of attachment, the user uses the sensor 12 of the first device 10 to take one or more images of the asset as the measured data D_{MA} which is sent to the X-to-Mesh algorithm 32 that generates mesh data of the asset (with the asset tag). The mesh data and associated asset tag ID are stored in the asset database. Additionally or alternatively, also the originally measured data D_{MA} could be stored.

Later, the tag check algorithm may be triggered periodically or on demand. This may be requested, for example, by the asset owner. In an example, it may be triggered when it is determined that the asset tag location is within range of an appropriate second device 20 (i.e., a UE or gNB with radar capabilities). The appropriate second device 20 in the vicinity of the asset tag may be requested by the tag check algorithm to begin collecting radar measurements as the measured data D_{MB} of the second device 20. The known asset tag location may be used to guide the measurement parameters.

The Mesh-to-Y algorithm 34 is then triggered e.g. by the tag check algorithm to generate synthetic data D_{S} of the asset from the perspective of the sensor 22 of the second device 20. This algorithm may use the known asset tag location and a known location of the appropriate second device 20 to synthesise a correct virtual viewpoint as a first step, and then generate the synthetic data D_{S} for the asset by retrieving the appropriate mesh data from the asset database.

Finally, the matching algorithm 50 compares the measured data D_{MB} to the generated synthetic data D_{S} to output a positive or negative matching outcome. A positive matching outcome may be outputted when the virtual and real doppler radar datasets have a similarity that exceeds a predetermined numerical threshold. Furthermore, a matching confidence may be calculated based on the average size of the differences between the datasets. If a negative matching outcome is returned, the tag check algorithm may trigger an alarm and/or request further action.

### User Authentication and Authorization

In a user authentication (identification) use case, an object (e.g., user) may get access to a network-aided (network-supported) authentication (identification) system, where users initially use UE sensors to image themselves and/or object (e.g., vehicle) encompassing/carrying a UE, and this data is then used to generate synthetic radar data representative of the user/object. Later, the UE may request an authentication function where local base station (e.g., gNBs) or other UEs image the user/object via radar and compare the image data to the synthetic data to authenticate the user of the UE or the object encompassing/carrying a UE.

In this use case, the first device (A) 10 of FIG. 3 may be a UE such as a smartphone or wearable device and the sensor 12 of the first device 10 may be a line-of-sight sensor, e.g., a camera or lidar sensor. Here, the measured data D_{MA} may be a sequence of photographs or a video of the user's body, face or other biometrics and/or object carrying/encompassing a UE from multiple angles (if the sensor 12 is a camera), or a set of lidar measurements of the user's body, face or other biometrics and/or object carrying/encompassing a UE taken from multiple angles (If the sensor 12 is a lidar).

The second device (B) 20 may be a base station and the sensor 22 of the second device 20 may be a radar sensor which may include at least one of dedicated radar sensors placed on the base station (e.g., gNB), communications components used in dedicated sensing mode (e.g., ISAC), and a passive sensing option derived from normal communications signals.

For this use case, the synthetic data algorithms 30 may include:

The X-to-Mesh algorithm 32 which may consist of a pre-trained adversarial network which generates 3D mesh data of the user's body, face or other biometrics and/or object carrying/encompassing a UE based on the measured data D_{MB} of the second device 20.

The Mesh-to-Y algorithm 34 which generates synthetic data D_{S} that emulates the radar cross section of the imaged user/object. In this case, cross sections from different viewpoints may be synthesized, which correspond to the predicted view(s) of the imaged user/object by the sensor 22 of the second device 20, guided by locations and/or viewpoint data and/or viewing angle and/or sensing capabilities of the second device 20 and the first device 10.

An additional database (user mesh database) may be provided, which stores the generated mesh data.

Furthermore, an additional algorithm (authentication request algorithm) may be provided, which initiates the synthetic data-aided authentication when triggered by the first device 10.

In the following, an example of a procedure of this use case is described.

A user opts in (participates, registers) to a network-aided authentication (identification) system, where the user may use the sensor 12 of the first device 10 to image or otherwise sense his/her body at several different angles and to output this data as the measured data D which is sent to the X-to-Mesh algorithm 32 that generates mesh data of the user's body. The mesh data is stored in the user mesh database.

When the user uses the first device 10 later, the authentication request algorithm triggers an authentication session. The local second device(s) 20 (e.g., a base station (e.g., gNB) by which the first device 10 is being served) collects the measured data D_{MB} of the user's body. The device location of first device 10 may be used to aid in setting up the sensors 22 of the second devices 20 to gather this data.

The Mesh-to-Y algorithm 32 runs on the user's mesh data to generate synthetic data D_{S} of the user's body from the perspective of the sensor 22 of the second device 20.

Finally, the matching algorithm 50 compares the measured data D_{MB} to the generated synthetic data D_{S} to output a positive or negative matching outcome. A positive matching outcome may be outputted when the virtual and real doppler radar datasets have a similarity that exceeds a predetermined numerical threshold. Furthermore, a matching confidence may be calculated based on the average size of the differences between the datasets. If the matching outcome is negative, or the matching confidence is too low, then the authentication fails. In this case, a re-authentication may be requested, or an alert may be sent to the operator of the first device 10. Otherwise, the authentication is positive and the user gains access to the first device 10.

In an embodiment that can be used with other embodiments, the second device 20 might also rely on the first device 10 to perform certain measurements. For instance, the second device 20 might use a given sensing technology, e.g., mmWave radar, as a transmitter and the first device 10 might act as receiver wherein the first device 10 is instructed to provide the second device 20 with the measurements.

In an embodiment that can be used with other embodiments, this use case may also be applicable to UEs or other terminal devices, including standalone devices, e.g., for verifying or enhancing verification of a user. A reason may be that if UEs with sensing capabilities, e.g., mmWave sensing capabilities, are increasingly used, such UEs can also be used to sense certain parameters of a user or the user environment.

In an embodiment, user/object authentication may be performed when a user is trying to access a UE. The user/object authentication may also be performed when a UE of the user/object is initiating access to a wireless network or service in the core network, such as a sensing service, as detailed in other embodiments in this disclosure.

In an embodiment, user/object authentication may be based on data sensed over a period of time, e.g., when a user is walking towards the UE to access the UE, since this can allow determining certain user specific features, e.g., the way a user walks.

One of the issues with radar systems and wireless sensing systems in general, for both distributed and non-distributed/centralized radar systems, but also for other systems using other sensing modalities, is that within the sensing area/volume multiple objects may be present that may be sensed/detected. Not all these objects may be subject to a wireless sensing service, may not have subscribed to such wireless sensing service, may not be intended targets of a wireless sensing service, and/or may not even wish to be sensed or take part of a sensing service or sensing procedure. Similarly, for systems using other sensing modalities. This issue does not only hold for wireless sensing services, but also for other services, such as surveillance services, metaverse or augmented reality services and/or matching service or viewed object identification service, making use of wireless sensing or other sensing modalities. In the subsequent text the term sensing service also covers these kinds of services.

This is an issue since wireless sensing or sensing using other sensing modalities may reveal personal identification information (e.g., biometrics) and/or other information that may be privacy sensitive (e.g., where a person is located or what he is doing). In many countries, user must give consent to take part in services that may obtain privacy sensitive information, in particular in private domains, such as somebody's home. Similarly, user consent can be required for 3GPP features depending on local regulations as described in TS 33.501, Annex V, where, e.g., the collection, processing, and usage of privacy sensitive data, e.g., by means of sensing, might also be restricted to a particular usage. Also, the devices involved in sensing, in particular the ones that may obtain/receive privacy sensitive information in the process, should be properly authorized.

In general, if the sensing service or sensing transmitter or sensing receiver determines that the sensing information (e.g., sensing measurements or sensing results related to a detected object) or the input/output data of the sensing signal processing do not correspond to the given information on how to identify the target (e.g., determined location is too far from the UE that the target is carrying, or the shape/size of the target is different (e.g., smaller or larger), or the biometrics do not fit with the target, or one or more sensing measurement/results are above or below certain threshold values, or the mesh data does not match (as described in other embodiments)), the sensing service or sensing transmitter or sensing receiver may discard the received sensing signal and/or discard the sensing information (e.g., sensing measurements or sensing results), and/or discard the input/output data of the sensing signal processing, and/or may not perform any further processing on these measurements, results and/or input/output data and/or may not transmit to a further processing unit. The sensing service or sensing transmitter or sensing receiver may also generate a notification message and, e.g., send it to an application, application server, core network function or via/through the NEF for further processing or storage, and/or may store information about such occurrence onto non-volatile storage (such as a database), if the target is not detected (anymore).

The following embodiments describe in which authorization can be obtained/provided to initiate sensing of a particular target, and to mitigate/prevent sensing (in particular detailed sensing) of unauthorized/unintended targets.

In order to achieve this, the sensing service, sensing transmitter or sensing receiver may receive or may be configured with information (e.g. from/by an application, network exposure function, policy control function, subscription database (e.g., home subscriber service, unified data management service), identity database, authentication/authorization control function, public safety answering point, for example as part of the sensing configuration/parameters) about a target location/area/volume (e.g., a delimited geographical area denoted by a set of coordinates, lengths, sizes, diameters) in which the target is to be sensed or is expected to be and/or how to identify the target (e.g., physical characteristics of the target (e.g., size, shape, mass, material composition, biometrics associated with a target (e.g., heart rate signal characteristic, body shape, body absorption/reflectivity characteristic, body posture/movements, body size/mass, diseases/handicaps leading to certain identifiable characteristics, such as sleep apnea leading to breathing pauses during sleeping, asthma leading to potentially fast irregular breathing rate or gasping for breath, a limp leading to unusual body movements, tremors (e.g., Parkinson), expected body temperature pattern, heart rate variability/pattern)), identities and/or locations of wireless communication devices or other devices that the target may own, encompass, include, or carry, etc.). This target identification information may include thresholds or other criteria related to sensing measurement/results, such as a minimum/maximum deviation from a certain location, a set of different shapes or scatterplot of allowed shapes, or multiple shape definitions indicating a minimal shape and maximum shape contours, deviations in size (e.g., maximum/minimum allowed difference in height, width, length, or kilograms), minimum/maximum speed, a set of possible moving pattern and/or possible deviations thereof, minimum/maximum value for sensed biometrics (e.g., minimum/maximum heart rate or breathing rate), etc. Note that the target identification information may be defined with different levels of accuracy, granularity, matching criteria (e.g., threshold values), depending on the resolution/accuracy of the radar-based sensing (e.g., depending on number of transmitter and receivers, frequency used, whether non-distribute or distributed sensing is used).

Alternatively or additionally, a target may also be indicated by exclusion, i.e., as a person or animal or structure or another type of object that does not match a set of criteria (e.g., is not a person, animal, object or structure that, e.g., matches certain known biometrics or size) and/or that should not be detected at a certain location/area or volume (e.g., does not match the biometrics of the people registered to live in a certain house, for which the biometrics may have been stored in advance), for example to detect intruders/burglars to a house. The information provided to the sensing service, sensing transmitter or sensing receiver (possibly indirectly via a sensing service) may further comprise a set of telephone numbers (e.g., emergency call numbers) that should be contacted in case of certain alert situations, a set of time periods (e.g., only evenings) or a set of triggers (e.g., only when person is known to be at home, e.g., by receiving a signal from a device that the person may carry) when the service should be active.

The sensing service, sensing transmitter or sensing receiver may also obtain information about devices (e.g., their identities and estimated location) that are in the vicinity of the target or target's address/location/home (e.g., a set of nearby base stations or UEs in the vicinity (e.g., a UE placed in the person's home or UEs carried around by the person or its family, friends or neighbors) that are capable and that may be authorized (or are authorized) by the network and/or by the user of the device and/or by the target object to participate in (distributed) sensing of the intended target. The authorization information (which may also include user consent information) may be stored as part of a user's subscription (e.g., in the unified data management (UDM) function of the core network) and/or as part of the sensing service and/or received from a service or application function or external application or authentication, authorization and accounting (AAA) server (e.g., through the NEF).

Based on the above mentioned target location/area/volume information and/or target identification information, the sensing service may select and/or configure one or more sensing transmitter device(s) and/or the sensing receiver device(s) with a sensing configuration which enables the sensing to be performed with the required accuracy to be capable of performing the matching with the target identification information, for example by configuring a set of frequencies for the sensing signals, which measurements need to be performed, how many times a sensing signal should be transmitted or how many times a measurement should be performed, etc. The sensing service may also provide information about the target area/location/volume to be sensed and/or a (sub)set of target identification information to the sensing transmitter device(s) and/or sensing receiver device(s).

Based on the above-mentioned target identification information, the sensing service and/or the sensing transmitter and/or the sensing receiver may be configured to perform a target matching procedure based on the configured target identification information, whereby the target matching procedure includes determining (e.g., through algorithmic processing of the sensing data (i.e., sensing measurements and/or (partial) sensing results) produced by and/or obtained from the sensing receiver) whether a set of sensing measurements performed on received sensing signals, or results from a processing performed on a set of sensing measurements and/or (partial) sensing results, meet one or more of the configured criteria (e.g., threshold values) for identifying the target object. This may include determining whether or not the sensing measurements and/or sensing results fall within certain thresholds and/or boundary conditions, e.g., is the object sufficiently close to a target location, does the identified shape of the object fall within certain boundaries, is the size of the object close to an expected size, is the speed of the object below a minimum or above a maximum expected speed for a target or below a minimum or above a maximum to enable proper sensing of the target object, is the moving pattern a moving pattern that could be expected by the target, are the measured biometrics (e.g., heartrate or breathing rate) below/above a certain expected value for a target, etc.

In an embodiment that may be combined with other embodiments or implemented independently, the sensing service and/or sensing transmitter and/or sensing receiver and/or the first device 10 (which may be a sensing transmitter and/or receiver) and/or the second device 20 (which may be a sensing transmitter and/or receiver)may receive (e.g., from/by an application) or get pre-configured or determine information about a model (e.g., semantic model, digital twin) of an object (e.g., a set of metadata describing the object, or a virtual graphical representation of the object) and/or sensor related data (e.g. measurement data, (pre-)processed sensor output or segmented data or mesh data that may be captured by a sensor, stored and/or (pre-)processed, and/or that is synthesized by a sensing device or sensing service or application) for a set of viewpoints, sensor headings and/or FoVs (e.g., radar cross section) of an object and/or a set of video footage of an object and/or a set of mesh data of an object stored in an object database, whereby the data for the set of viewpoints, sensor headings and/or FoVs may be generated or stored according to a predefined set of positions (e.g., known location of a base station) or angles (e.g., one or more angles in relation to a reference line towards the magnetic north) and/or FoVs (e.g., omnidirectional). This information may be used as target identification information, and may be used to match sensing data from a sensing transmitter and/or sensing receiver and/or the first device 10 and/or the second device 20 with the received information, using the procedures as described in other embodiments, such as by generating data for a viewpoint (e.g. radar cross section) for a certain angle and/or FoV from the received sensing measurements/data and/or sensing capabilities and/or information about viewpoint, heading, FoV from the sensing transmitter/receiver or the first device 10 or the second device 20 and matching this with data for a viewpoint, sensor heading and/or FoV (e.g., radar cross section) of the received, pre-configured or determined set of viewpoints, sensor headings and/or FoVs. Depending on whether a match is found (e.g. with a certain confidence level), the sensing session may be continued or aborted, or the sensing data may be approved for further processing/storage or discarded, initiate an additional sensing operation, select a (different) target or sensing receiver or sensing transmitter or first device 10 or second device 20 for further sensing, generate an event or transmit a signal indicating that a matching target was detected or was not detected, or initiate/continue an authorization of a target for sensing (e.g., verifying whether a detected object is an authorized target for a sensing service). In case of metaverse or augmented reality services, target objects may be other participants in a metaverse or augmented reality service. Target object identification may be performed to exclude “innocent” bystanders from being recognized or being sensed without their permission.

The target matching procedure may be given an (ideal) representation of a signal as input, to which the outcome of the signal processing (which may include passing the signals through one or more filters) needs to be matched by finding similarities between the processed signal and such (ideal) representation of a signal. This may include identifying overlap of the processed signal with the (ideal) representation of the signal, possibly changing the amplitude or timing of the signal. This may also include identifying signal shapes, signal peaks and verifying if these may or may not occur in the (ideal) representation of the signal. Similarly, for sensing modalities such as video or an image feed, the video or image output may first need to pass various image processing algorithms, such as noise removal, sharpening, resizing, before additional actions, such as creating segmented data, mesh data or a radar representation of the video or images.

Additionally or alternatively, the input for such target matching procedure may include a description of at least one or more signal characteristics (e.g., certain signal peaks or signal shapes) that need to be present in order for the signal to match. The input for such target matching procedure may also include a set of signal characteristics (e.g., certain signal shapes, signal peaks) that should not be present in order for the signal to match. Since some sensing measurements and/or sensing results may not be stable (e.g., measurements fluctuating between certain values, movements causing Doppler shift, small movements, or RF signal interference causing noise in certain signals), the signals may need to pass certain filters (e.g., low-pass or high-pass filter) in order to remove noise, unwanted spikes, outliers or trends, or Doppler shifts from a signal. Note that the sensing measurements and sensing results may be measured or calculated during a period of time whereby some outliers during that period of time may be removed and/or some average values during the period of time may be used for the signal processing and matching algorithms. The resulting output after these processing steps may be a signal that matches the given (ideal) representation and/or the given set of signal characteristics, whereby matching is likely never going to be 100% accurate. This is further exacerbated if the original or processed sensing signal or sensing measurements or (partial)sensing results lack sufficient accuracy (e.g., because a low frequency signal or low sampling rate, or a low accuracy signal representation is used). Hence, the matching results may be provided together with a level of confidence, or a matching percentage, or a standard deviation value. The target matching procedure may be given a minimum level of confidence, or a confidence interval, or a minimum matching percentage, or a maximum standard deviation value for one or more of the configured criteria or other target identification information. If a minimum confidence level, or a minimum matching percentage, or a maximum deviation is not met, the target matching procedure may not include this in the set of matched criteria or other target identification information.

Additionally or alternatively, the target matching procedure may perform matching of the sensing measurements and/or (partial) sensing results with an artificial intelligence (AI) model, whereby the AI model may have been trained in identifying a particular target or set of targets, e.g., by using sensing measurement results and/or (partial) sensing results based on sensing of the target in a controlled environment, possibly in various settings. Such AI model may be provided as input to the target matching procedure or may be made available (e.g., running on an edge server) to the target matching procedure through a communication interface. By passing a set of sensing measurements and/or (partial) sensing results of an actual target with such AI model, the AI model may determine that the given sensing measurement result and/or (partial) sensing result, such as a certain processed signal matches with what the model has learned on how to identify the particular target. Additionally or alternatively, the AI model may determine a machine learning confidence score that the given sensing measurement result and/or (partial) sensing result indeed identifies the target and/or that it matches one or more of target identification information for the target. The AI model may provide the matching learning confidence score and/or other matching results for further processing in the target matching procedure.

The target matching procedure may result in a set of objects (i.e. matching targets) that match either a subset of the set of target identification information in the case of a partial match or the entirety of the set of target identification information in the case of a full match, whereby, as mentioned above, the matching may be augmented with or conditioned with a confidence level or a matching percentage. In short, a matching target is an object that matches (with a certain confidence or matching percentage) at least a subset of the target identification information, e.g., by meeting one or more of the configured criteria (e.g., threshold values) for identifying the target object. The sensing service, sensing transmitter or sensing receiver or the first device 10 or the second device 20 performing the sensing of a target or performing the target matching procedure may allocate a new identifier when a new and/or distinct object has been detected, or may allocate an identifier that is associated with a set of target identification information (e.g., matching criteria for a target), or may allocate an identifier based on a target identifier provided by an application, or may allocate an identifier based on a subscription identifier associated with the sensing service and/or the sensing of the target, or may allocate an identifier based on an identification of the sensing session. The entity responsible for the target matching procedure may replace an allocated identifier with an identifier associated with a set of target identification information in case of a full match and/or when the confidence level or matching percentage is above a pre-configured threshold.

In order to identify a target in a target location/area/volume, the sensing service, sensing transmitter or sensing receiver or the first device 10 or the second device 20 may initiate an initial scan of the target area and/or obtain the sensing measurements/results resulting from an initial scan of the target area as input for a target matching procedure. Such initial scan may be a low-resolution scan, but may also be a high-accuracy scan, e.g., if allowed/enabled/authorized for example in certain countries or facilities (e.g., in case of a non-public network) or certain use cases (e.g., for lawful intercept or emergency situations), for example using distributed radar sensing or in a higher frequency such as mmWave. The sensing signals/measurements/results may be processed as described in other embodiments to obtain a set of sensing results, which may reveal zero, one or more objects (e.g., persons, animals, houses, cars) detected in the target area. Similarly, in a FoV of a sensor 12 of the first device 10 or sensor 22 of the second device 20 of FIG. 3, the initial sensing (i.e. an initial scan) performed by sensor 12 or sensor 22 may be in low resolution (e.g. low resolution video, or only contour detection whereby faces or other distinguishing features of a person could be obfuscated), but if allowed/enabled/authorized for example in certain countries or facilities (e.g., in case of a non-public network) or certain use cases (e.g., for lawful intercept or emergency situations), the sensing may be performed in high resolution (e.g. high resolution video). These sensing signals/measurements/results may be processed as described in other embodiments to obtain a set of sensing results, which may reveal zero, one or more objects detected in the FoV of sensor 12 or sensor 22.

If only one object is detected that may (or may not) match a set of target identification information (according to the target matching procedure), then the sensing service, sensing transmitter or sensing receiver or the first device 10 or the second device 20 may generate an event and/or transmit a signal (that may carry a message, e.g., to an application server, core network function or via the NEF) indicating that a matching target or the intended target is present in the scanned area/volume/FoV (possibly augmented with position information and/or other sensing results related to a detected target), and/or may store information about detecting a target (possibly augmented with position information and/or other sensing results related to a detected target) onto non-volatile storage (such as a database) if the target is detected in accordance with the target identification information, and/or may initiate an additional scan and/or may perform further sensing measurements for verification or to determine additional matches to the target identification information and/or may initiate/trigger the start of a (detailed) sensing session (only) when the presence of the intended target is detected. To this end, the sensing service, sensing transmitter or sensing receiver or the first device 10 or the second device 20 may inform the one or more other sensing services, sensing transmitters or sensing receivers or other devices that can perform sensing using one or more sensing modalities (such as the first device 10 or second device 20) that may be involved in the (detailed) sensing of a target, e.g., by sending a signal to initiate additional sensing operations.

If more than one object is detected that may (or may not) match a set of target identification information (according to the target matching procedure), then the sensing service, sensing transmitter or sensing receiver or the first device 10 or the second device 20 may generate an event and/or transmit a signal (that may carry a message, e.g., to an application server, core network function or via the NEF) indicating that the multiple intended targets are detected and/or that multiple objects (e.g., matching targets) are detected that match (or do not match) a set of identification information (but for which, e.g., it cannot be determined with sufficient certainty that the intended target is present in the scanned area/volume/FoV and/or which detected object is the intended target), and/or may delay/cancel the start of a (detailed) sensing session and/or may initiate another scan and/or may perform further sensing measurements for verification or to determine additional matches to the target identification information (e.g., to reduce the number of potential targets and/or to find a better match with the set of target identification information for the intended target).

In another embodiment, the sensing service or the first device 10 or the second device 20 may initiate an initial scan of a target location/area/volume/FoV and obtain the sensing measurements/results resulting from an initial scan of the target area or for a FoV. This may include raw measurement results (such as timing or signal strength of signals) or may be (partial) sensing results (e.g., number of detected objects, location of an object, speed of an object, size of an object, movement pattern of an object) derived from the sensing measurements. The sensing service, sensing transmitter or sensing receiver or the first device 10 or the second device 20 (as a requesting entity) may provide these sensing measurements/results or a subset thereof to a/another sensing service or to a sensing application or to a core network function (e.g., an authentication server function (AUSF) or UDM) or external server responsible for performing the target matching procedure. Because of security and privacy reasons, the target matching procedure may need to be performed within a security/privacy domain for a specific target (e.g., in the home network (e.g., a home public land mobile network (H-PLMN)) who owns the target's subscription to the sensing service or by a server operated by a trusted identification authority (e.g., provided by government) or by a server operated by an authorized/trusted application provider)), and hence the target identification may not be shared with the sensing service, sensing transmitter or sensing receiver, in particular if these would operate in a visiting network (e.g., a visited public land mobile network (V-PLMN)). After the sensing service, sensing application or core network performed the target matching procedure on the provided sensing measurements/results, it may respond to the requesting entity that a match has been found or has not been found and/or a (temporary) identity related to an identified target that may be used for further authentication and authorization, as described in later embodiments. The response may also contain information about whether the target is authorized to be a target for sensing and/or may contain credentials that may be used for encrypting/decrypting subsequent messages (e.g., if the (temporary) identity is provided in a subsequent message secured by a key based on those credentials). Based on the response(s) received, the sensing service, sensing transmitter or sensing receiver or the first device 10 or the second device 20 may stop or continue the sensing operation, initiate an additional sensing operation, generate an event or transmit a signal indicating that a matching target was detected or was not detected or initiate/continue an authorization of a target for sensing (e.g., verifying whether a detected object is an authorized target for a sensing service).

In yet another embodiment, the sensing service, sensing transmitter or sensing receiver or the first device 10 or the second device 20 may initiate an initial scan of a target location/area/volume/FoV and obtain the sensing measurements/results resulting from an initial scan of the target area. This may include raw measurement results (such as timing or signal strength of signals) or may be (partial) sensing results (e.g., number of detected objects, location of an object, speed of an object, size of an object, movement pattern of an object) derived from the sensing measurements. The sensing service, sensing transmitter or sensing receiver or the first device 10 or the second device 20 (as a requesting entity) may request one or more (other) sensing services or sensing applications or core network functions (e.g., AUSF or UDM) or identity databases (e.g., provided by government) that maintains/stores target identification information to provide one or more sets of target identification information (e.g., target identification information that matches one or more sensing measurements/results). Such request may contain information about the target location/area/volume/FoV that was scanned, one or more sensing parameters/measurements/results (e.g., a size of an object, a location of an object, a speed of an object, a movement pattern of an object, a shape of an object, a material of an object), and/or information about one or more targets subscribed to the sensing service (which may also configure/be in control of the sensing transmitter or sensing receiver) and/or that are expected to be in/near the target location/area/volume/FoV. Based on this request, the one or more (other) sensing services or sensing applications or core network functions or identity databases may provide a (sub)set of target identification information for targets for which the target location/area/volume and/or target identification information (partially) match with the provided information (e.g., about the target location/area/volume that was scanned and/or one or more sensing parameters/measurements/results). Similarly, matching may be done by calculating data for different viewpoints, sensor headings and/or FoVs (e.g. radar cross sections) based on sensing data (e.g., measurement data or segmented data) from a sensor 12 of the first device 10 with sensing data from sensor 22 of the second device or model (e.g., semantic model) of an object or set of data for different viewpoints, sensor headings and/or FoVs for an object (e.g., stored in a matching database), as described in other embodiments of this disclosure. Additionally or alternatively, a set of target identification information is provided by the network (e.g., the sensing service) or an application (e.g., via the NEF) or an external entity (e.g., a public safety answering point (PSAP)) to the sensing service, sensing transmitter(s) and/or sensing receiver(s) or the first device 10 or the second device 20 as part of the configuration information for sensing of a target based on the set of target identification information, or as part of a request to start sensing a target or target location/area/volume/FoV. The (sub)set of target identification information received by the sensing service, sensing transmitter or sensing receiver or the first device 10 or the second device 20, may then be used by the sensing service, sensing transmitter or sensing receiver or the first device 10 or the second device 20 to perform further and/or more detailed sensing of a target that may be fine-tuned to the (sub)set of target identification that was provided, in order to achieve a better matching result or, for example, to further determine/exclude one or more detected objects in the initial (low resolution) scan that may or may not match (e.g., fall within or outside of a set of thresholds for location, speed, size or other parameters) a set of target identification information to be an intended target.

Depending on the situation the detailed/prolonged/continued sensing of a target area or a set of target objects or other objects detected in a target area or FoV, which may include, e.g., sensing by using higher frequency or distributed radar or for longer period of time or with more advanced/more accurate algorithms of a target, may be initiated anyway in certain situations. Examples of such situations include, e.g., in case of an emergency call or a lawful intercept that initiated a request to start the radar based sensing of one or more targets and/or a certain area, or in case the target area/volume covers a house or facility (e.g., factory) for which the owner/inhabitants have (implicitly or explicitly) granted permission (e.g., provided user consent) when subscribing to the sensing service or subscribing to the operator's network communication services or for example through their healthcare provider/service or for example because the sensing service is operated by a non-public network (which may include privately owned infrastructure equipment and core network components that may include a sensing services, sensing receivers or sensing transmitters) whereby the sensing service/equipment operates in and/or covers the intended facility, or in case the targets and/or sensing receivers and/or sensing transmitters and/or first devices 10 and/or second devices 20 are subscribed to the same service/application or are part of the same group (e.g. sharing group ID or sharing group credentials).

In an example embodiment, a UE (that may or may not be the first device 10 having the sensor 12 or the second device having the sensor 22) initiates an emergency call with a public safety answering point via the (cellular) network to which it is attached, and based on location information provided/acquired during the emergency call according to local regulations (e.g., Enhanced 911), a sensing transmitter in the vicinity of the originating location of the emergency call (e.g., a base station in the vicinity or a mobile phone in the vicinity or the mobile phone making the emergency call) may get instructed (e.g., through configuration messages) to perform a sensing session (e.g., to sense a designated target victim or target area/volume around a victim or emergency area/volume or a particular FoV given the location of that mobile phone), whereby the instructions may include authorization information, information about the target (e.g., target location/area/volume or some characteristics of the target victim, e.g., whether the target victim is moving or not, is lying on the ground, has cardiac arrest, etc.) or the context (e.g., how many people are gathered around the victim, distance between people and their devices relative to the victim, number of injured people, debris in the vicinity) or an identifier or address (e.g., IP address, URL) of a destination server, network function/device or public safety answering point or a credential (e.g., public key) to be used for encrypting the results, or requested sensing output/results such as target position or movement or vital signs. The information about the target may be a set of target identification information (as described elsewhere in the present disclosure). The set of target identification information may be provided by the UE to the core network (e.g., to the emergency call session control function (E-CSCF) as specified in 3GPP TS 23.167) and/or the PSAP, for example, by including this information in the emergency connection setup request (e.g., an emergency PDU session establishment (e.g., an emergency PDU session as defined in 3GPP TS 23.501 and TS 23.167, and extended accordingly) or over the emergency connection (e.g., an emergency PDU session), whereby the E-CSCF may forward the received information to the PSAP. This information may be determined by the UE performing an initial scan (e.g., a radar sweep) of the victim or another target or of the emergency area, if the UE is capable of performing wireless sensing. Similarly, the UE may be a first device 10 having a sensor 12 and be capable of sensing one or more objects in a FoV of sensor 12. Such UE may include measured or segmented data from sensor 12 or resulting information about detected objects or FoV information (and possibly other information related to sensor 12, such as viewpoint and/or sensing heading and/or sensing capabilities) in the emergency connection setup request or over the emergency connection. The UE may be configured to sense for a target victim (e.g., matching one or more default characteristics such as shape or size of a person lying on the ground or heavily breathing or bleeding), e.g., based on a preconfigured set of target identification information (e.g., sensing criteria). The information (such as a set of target identification information) provided by the UE and received by the core network and/or the PSAP may then be provided (together with one or more of the mentioned instructions) to the sensing service (or another network function, e.g., location retrieval function (LRF) or LMF responsible for initiating the sensing of a target based on the provided information) and/or directly to a set of sensing transmitters and/or receivers.

Additionally or alternatively, the UE may provide a set of wireless sensing measurements or sensing results to the core network (e.g., to the E-CSCF) and/or the PSAP, for example, by including this information in the emergency connection setup request (e.g., emergency PDU session establishment) or over the emergency connection (e.g. an emergency PDU session), upon which the core network or the PSAP may determine a set of target identification information, based on the provided set of wireless sensing measurements or sensing results, that may then be provided (together with one or more of the mentioned instructions) to the sensing service (or another network function, e.g., LRF or LMF responsible for initiating the sensing of a target based on the provided information) and/or directly to a set of sensing transmitters and/or receivers. Similarly, the UE may be a first device 10 having a sensor 12 and be capable of sensing one or more objects in a FoV of sensor 12. Such UE may include measured or segmented data from sensor 12 or resulting information about detected objects or FoV information(and possibly other information related to sensor 12, such as viewpoint and/or sensing heading and/or sensing capabilities) in the emergency connection setup request or over the emergency connection.

Additionally or alternatively, a set of target identification information may be retrieved (e.g., by the E-CSCF) based on a UE identity received from the UE making the emergency call from a core network function or database (e.g., UDM/UDR) that maps UE identities with associated set(s) of target identification information. To this end, the UE may indicate (e.g., in a message field during emergency connection setup) whether or not the target is carrying the UE or encompasses the UE that has initiated the emergency call, e.g., because the person itself is a victim. The retrieved set of target identification information may then be provided (together with one or more of the mentioned instructions) to the sensing service (or another network function, e.g., LRF or LMF responsible for initiating the sensing of a target based on the provided information) and/or directly to a set of sensing transmitters and/or receivers or other devices capable to perform sensing using one or more sensing modalities (such as the first device 10 or second device 20).

In case of an emergency call, the authorization (including a user consent) to perform sensing (e.g., initial scan or detailed/prolonged sensing) of a target and/or to share sensing results of a target with a PSAP may be implicitly provided, e.g., because the request to initiate sensing was done by a core network function specifically used in case of emergency calls (e.g., E-CSCF or LRF) or by the PSAP, or e.g., because the request to initiate sensing includes a flag indicating that this is for an emergency call. Similarly, one or more receivers (also if receiver is part of the same device as the transmitter) or other devices capable to perform sensing using one or more sensing modalities (such as the first device 10 or second device 20 gets activated to participate in the sensing session, upon which the transmitter and receiver or other devices capable to perform sensing using one or more sensing modalities (such as the first device 10 or second device 20 may perform sensing according to the other embodiments in this document). The sensing results (which may be filtered to contain results only pertaining the designated target, i.e., a target that matches a set of target identification criteria provided to the sensing service, sensing transmitter(s) or sensing receiver(s), e.g., by the E-CSCF or PSAP) may be forwarded by the core network (e.g., by the E-CSCF) to the PSAP. To this end, the sensing results may be provided via the AMF to the E-CSCF when the UE includes them during the PDU session establishment, or the E-CSCF may retrieve them via a LRF/GMLC as specified in 3GPP TS 23.167/23.273, extended for this purpose, e.g., by providing functions similar the sensing service or by involving the sensing service as described in other embodiments of the present disclosure or by collecting the sensing results directly from the sensing receiver(s) and/or sensing transmitter(s) or the other devices capable to perform sensing using one or more sensing modalities (such as the first device 10 or second device 20.

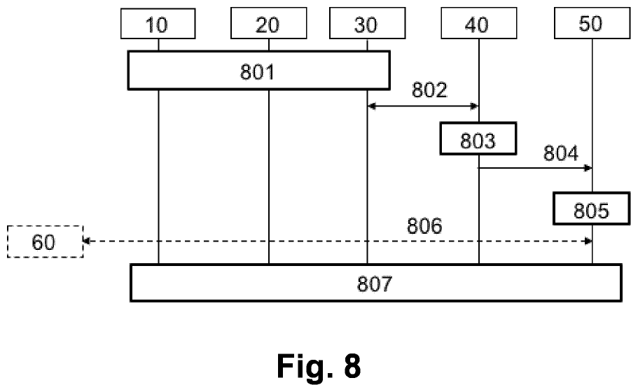

FIG. 8 schematically shows an example target authorization procedure according to various embodiments of the present invention.

In an embodiment that can be combined with any other embodiment, or that can be implemented independently, the first device 10 or the second device 20 may need to initiate an authorization procedure before initiating or continuing a sensing session (e.g., before initiating another scan or before initiating detailed and/or distributed sensing). Such authorization procedure may comprise verifying the authorization information and/or the credentials of the network operator or the application or the user or the device or the third party that issued a request for the sensing of the target and/or that provided the information on how to identify the intended target and/or the user that subscribed to the sensing service, in order to assess whether or not the respective entity is authorized to receive sensing measurements or sensing results or other sensing data, and/or is authorized to initiate a sensing request for a target, and/or is authorized to provide configuration information (e.g., authorized to provide a set of target identification information) for sensing of a target. The authorization may be provided by, and/or stored in, and/or retrieved from, the subscription database (e.g., the UDM) for the requesting user or device or the intended target. Alternatively, the authorization may be provided by, and/or obtained from, an application server or a core network function or through the NEF. Alternatively, the authorization may be provided by, and/or obtained from, a lawful intercept service or a PSAP. In case of lawful intercept or an emergency call (i.e., with a PSAP), the authorization (incl. user consent) to perform sensing (e.g., initial scan or detailed/prolonged sensing) of a target and/or share sensing results of a target with a PSAP or lawful intercept service may be implicitly provided, e.g., because the request to initiate sensing was done by a core network function specifically used in case of emergency calls (e.g., E-CSCF or LRF) or by the PSAP or, e.g., because the request to initiate sensing include a flag indicating that this is for an emergency call. If the authorization fails or cannot be verified, then an event and/or an error message may be generated, and/or the sensing of the target may be aborted. Since the rules for sensing in public spaces versus sensing in private spaces may be different, also the authorization and whether or not the authorization needs to be performed may differ depending on the location or area or volume in which a target is to be sensed or in which the sensing is performed. Also, in the case where only one object (i.e., matching target) was detected that may match a set of target identification information (either partially when matching a subset of the set of target identification information or fully when matching an entirety of the set of target identification information), such authorization procedure or authorization verification may need to be performed. In an example, a set of target identification information (and/or a set of sensing measurements and/or results within certain thresholds) may be linked to a mobile subscription identifier or a user identifier, e.g., a subscription permanent identifier (SUPI), or to an identifier from which (e.g., after authentication with an authentication server function (AUSF)) a mobile subscription identifier or user identifier can be derived (e.g., of a wireless communication device carried or encompassed by a target, or of a wireless communication device carried by or owned by the person that subscribed to a sensing service). The links between the sets of target identification information and mobile subscription identifiers or user identifiers may be stored, e.g., as part of a unified data repository (UDR) or UDM functions in a core network or in a separate database or AAA server from which this link information can be retrieved by a core network function (such as AUSF) upon or after authentication. The information to link the sets of target identification information to the mobile subscription identifiers or user identifiers may also be provided by or retrieved from an application beforehand, or upon or after authentication. To this end, the application may communicate with the respective core network function(s), such as UDM/UDR or AUSF, through the NEF. The information to link the sets of target identification information to the mobile subscription identifiers or user identifiers may further contain an association with one or more identifiers (preferably temporary or intermediate identifiers that may change or update (e.g., based on a set of rules or matching criteria) for privacy reasons) and may contain information on whether the user or device is subscribed to a sensing service and/or whether a device associated with the mobile subscription may be authorized and/or is capable of acting as a sensing transmitter or a sensing receiver or acting as the first device 10 or the second device 20. These (temporary or intermediate) identifiers may be provided to a target matching entity (e.g., a sensing service or a sensing transmitter or a sensing receiver (possibly indirectly via the sensing service) or a sensing application or a core network function) that is capable of performing a target matching procedure. If (e.g., through an initial radar scan) a potential target is found by the target matching entity, then the target matching entity (or a sensing transmitter or a sensing receiver or the first device 10 or the second device 20 or a sensing service to which the result of the target matching procedure (which may include a (temporary) target identifier) was transmitted) may initiate an authentication and/or authorization procedure using such a (temporary/intermediate) identifier as input for the authentication and/or authorization request and/or may use the set of target identification information (and/or the set of sensing measurements and/or results) as input for an authentication and/or authorization request, and/or may first retrieve a mobile subscription identifier or user identifier based on a set of target identification information and/or on a set of sensing measurements and/or results, and then use the retrieved identifier as input for the authentication and/or authorization request. The authentication and/or authorization request may be directed towards a core network function such as the AUSF and/or the UDM, which may verify whether the intended target is authorized for the sensing service and may also verify whether a user consent has been provided. To this end, the core network function (e.g., the AUSF and/or the UDM) may retrieve (e.g., from the UDR or database) a mobile subscription identifier or user identifier by using a (temporary/intermediate) identifier, and/or target identification information (and/or a set of sensing measurements/results). Since the mobile subscription identifier or user identifier may be associated to one or more UEs, the network may also send a notification to the one or more UEs (e.g., to inform the user that the sensing service is activated), and/or may request confirmation from the user of the one or more UEs to initiate and/or approve the sensing of the target, and/or may also request the location of the one or more UEs and use it to verify whether the one or more UEs are in the vicinity of the target (e.g., as an additional check that the target is correct or to request these one or more UEs to participate in the sensing of the target), and/or may perform primary authentication with the one or more UEs.

In the example authorization procedure as shown in FIG. 8, a sensing service 30 and/or the first device (e.g., sensing transmitter) 10 and/or the second device (e.g., sensing receiver) 20 perform(s) an initial scan 801 (i.e., an initial sensing operation 801) of a target location or area or volume. As shown, the sensing service 30 (or the first device 10 or the second device 20) may transmit the sensing measurements and/or results (e.g., the set of sensing information) from the initial scan 801 (i.e., transmit an output of the initial sensing operation 801) to a target matching entity 40 via a message exchange 802. The target matching entity 40 may then perform a target matching procedure 803 based on the sensing measurements and/or results from the initial scan 801 and on a set of target identification information. If a partial or full match to the set of target identification information is found for a target (i.e., if a matching target, matching either a subset of the set of target identification information in the case of the partial match or an entirety of the set of target identification information in the case of the full match, is determined (with a certain confidence or matching percentage)), then, as shown, the target matching entity 40 (or the sensing service 30 or the first device 10 or the second device 20 to which the result of the target matching was sent) may request an authorization for a target by transmitting a (temporary) identifier associated with the target or the set of target identification information to an authentication and/or authorization entity 50 (such as AUSF, UDM, AAA server, sensing application or a combination thereof) via a message exchange 804. The authentication and/or authorization entity 50 may perform an authentication and/or authorization procedure 805 in which the authentication and/or authorization entity 50 may further authenticate the target (e.g., by deriving the identity of a device or user that subscribed to the sensing service based on the provided (temporary) identifier, and, e.g., by performing primary authentication with the respective device), and/or may verify whether the target is authorized to be a target for sensing (e.g., based on subscription information directly or indirectly linked to the provided (temporary) identifier associated with the target or the set of target identification information), and/or may verify whether the user or target that subscribed or that is subject to the sensing service, has provided a user consent to be sensed/for sensing. The authentication and/or authorization entity 50 (possibly in cooperation with other core network and RAN entities) may also send a notification to a device 60 that is linked to the same subscription, the notification indicating that the target is subscribed to be a target for a sensing service, in a message exchange 806. In the same message exchange 806, the device 60 may send a message back to the authentication and/or authorization entity 50 in order to confirm that it is ok to proceed with the sensing of the target. Once the authentication and/or authorization procedure 805 performed by the authentication and/or authorization entity 50 has been completed, the entities (e.g., 10, 20, 30, and 40) involved in the sensing operation of the respective target will be informed by the authentication and/or authorization entity 50 through an authorization information procedure 807 that the target is authorized to be a target for sensing, and that, based on this, they may then continue the sensing of the target.

In an embodiment that can be combined with other embodiments or that can be implemented independently, in order to further improve the privacy of the sensing operation, a device carried or encompassed by the target, in particular a wireless communication device (e.g., a UE device) can be used to trigger or initiate a sensing operation of the target or target object carrying or encompassing that device. The wireless communication device may establish a connection to a network that may operate a sensing service, or to an application server or core network function that may communicate with the sensing service, or to a sensing transmitter, or to a sensing receiver, and may trigger or initiate a sensing operation by sending a signal (which may carry a message) indicating such a trigger directly or indirectly to the sensing service or to the sensing transmitter or to the sensing receiver. Such a message may contain potential sensing transmitter or sensing receiver capabilities of the device, may contain location or area or volume information about the device itself or about an intended target, may contain authorization information and/or credentials, and/or information about user consent, may contain identification information of a target or an identifier associated with a set of target identification information, and/or may contain a set of sensing measurements or results. Upon receiving such a trigger for initiating the sensing operation, the sensing service may obtain and/or verify an authorization of the device (e.g., by obtaining the identity of the device and by checking the information in the subscription database (e.g., the UDM) whether the user of the device is subscribed to the sensing service, and/or whether the device is authorized to participate in the sensing operation, and/or whether the user of the device has provided a consent to be a target for the sensing operation). If the user of the device or the device is indeed authorized, then the sensing service and/or the first device 10 and/or the second device 20 may initiate and/or perform the sensing operation as described in the present disclosure. Note that initiating a sensing operation may comprise receiving and/or retrieving a set of target identification information, or an identifier associated with the set of target identification information (e.g., if the set of target identification information and its associated (set of) identifier(s) has already been provided earlier or during a pre-configuration of the involved first device 10 and/or second device 20 and/or the sensing service 30).

Optionally, the sensing service may send a signal to the device carried or encompassed by the target, the signal indicating that the sensing operation is starting or is about to start. The device may display a notification to the user, or may request the user to provide confirmation (or automatically provide confirmation based on the device configuration) that he/she/it agrees to start the sensing operation, upon which a signal may be sent back to the sensing service, the signal indicating whether or not a confirmation has been obtained, after which, if the confirmation has been obtained, initiate or further perform the sensing operation. In an example, a wireless communication device carried or encompassed by the target (e.g., a mobile phone, IoT device, sensor device, wireless tag, or other UE) has a subscription with the network. The user of that wireless communication device may also be subscribed to a sensing service. A core network function (e.g., a UDR or a UDM or a separate database or AAA server) may store an association between a mobile subscription identifier or user identifier (such as a SUPI of the wireless communication device carried or encompassed by the target (object), or a SUPI of the wireless communication device carried by or owned of the person that subscribed to a sensing service) or a (temporary or intermediate) identifier from which a mobile subscription identifier or user identifier may be derived, and a set of target identification information (and/or a set of sensing measurements and/or results within certain thresholds). The information to link these identifiers to the sets of target identification information may also contain information on whether the user of the device or the device is subscribed to a sensing service, and/or on whether a device associated with the mobile subscription may be authorized and/or is capable of acting as a sensing transmitter or a sensing receiver and/or first device 10 or second device 20. Upon registration to the network and/or to the sensing service by the wireless communication device carried or encompassed by the target (object) or the user that subscribed to the sensing service, or upon connection of the wireless communication device carried or encompassed by the target or the user that subscribed to the sensing service to a sensing transmitter or a sensing receiver or the first device 10 or the second device 20, an identifier of the wireless communication device may be provided by the wireless communication device to a core network function responsible for authentication and/or authorization of the device (e.g., to the AUSF or to the UDM). After the authentication or as part of the authentication procedure, the core network function responsible for authentication and/or authorization of the device may check the information stored in the UDR or the UDM or a separate database or AAA server, about whether or not the user of the device or the device is subscribed to a sensing service, and/or whether or not a user consent has been provided, and/or whether or not a device associated with the mobile subscription may be authorized and/or is capable of acting as a sensing transmitter or a sensing receiver or the first device 10 or the second device 20, based on the given identifier, and/or may retrieve a mobile subscription identifier or user identifier based on the given identifier. The identifier used by a wireless communication device carried or encompassed by the target may be a subscription concealed identifier (SUCI) or a 5G globally unique temporary identifier (GUTI) that the wireless communication transmits to the core network as part of a connection setup and/or primary authentication procedure as specified in TS 33.501. However, it may provide a benefit if the wireless communication device carried or encompassed by the target may use another or additional identifier, preferably a temporary identifier, to indicate to the core network that the wireless communication device is subject to wireless sensing or sensing through other sensing modalities. This identifier may be pre-configured by the core network on the device (e.g., by a policy control function (PCF)), or configured by the network (e.g., by the AMF) when the device connects to the network, or may be provided as part of a sensing request (e.g., a mobile terminated or network initiated sensing request by the RSMF). The core network function responsible for authentication and/or authorization of the device (e.g., the AUSF or the UDM) may use the identifier to verify whether the device is authorized for using the sensing service, to retrieve user consent information, to retrieve a set of target identification information associated with the device, etc.

Alternatively or additionally, the authorization may be provided by or obtained from an application server or from a core network function or through the NEF, or may be provided by and/or obtained from a lawful intercept service or PSAP. The core network function responsible for authentication and/or authorization of the device may also retrieve a set of target identification information associated with the given identifier or the mobile subscription identifier or the user identifier retrieved based on the given identifier, or may retrieve or create an (intermediate or temporary) identifier associated with the set of target identification information. The set of target identification information or (intermediate or temporary) identifier associated therewith may be provided to the sensing service 30 or to the sensing transmitter or to the sensing receiver or the first device 10 or second device 20, if authentication and/or authorization is successful and/or if a set of target identification information can be successfully retrieved.

Additionally, credentials may be provided that the involved devices (e.g., the sensing transmitter(s) and/or the sensing receiver(s)) need to use for securely sending (e.g., with integrity and/or confidentially being protected) any sensing measurements and/or results or other sensing information about one or more targets/objects, and/or sensing configuration information, to the sensing service or to other devices or services and/or applications involved in a sensing session and/or operation.

Additionally or alternatively, it is verified whether or not identification information of a target (and/or a set of sensing measurements and/or results) provided during a registration and/or a connection setup matches such a retrieved set of target identification information.

Additionally or alternatively, the mobile subscription identifier or user identifier associated to one or more UEs may be used by the network to send a notification to the one or more UEs (e.g., to inform the user that the sensing service is activated) and/or request a confirmation from the user of the UE to initiate and/or approve the sensing of the target, and/or may also be used to request the location of the UE and use it to verify whether the UE is in the vicinity of the target (e.g., as an additional check that the target is correct or to trigger a sensing session and/or operation).

Additionally or alternatively, the wireless communication device carried or encompassed by a potential target may be instructed to show instructions for the target or target object to perform a particular movement (e.g., wave hands, wiggle, move a few steps in a certain direction) that may be detected by the sensing service, e.g., whilst performing an initial radar scan or at a particular time. If the movement can indeed be detected, it may be determined that the potential target is indeed the intended target or target object.

In an embodiment that can be combined with other embodiments or that can be implemented independently, a wireless communication device (possibly in cooperation with a set of sensors and/or a set of sensing transmitters and/or sensing receivers connected to the wireless communication device), such as the first device 10 or second device 20 may determine a set of target identification information by performing wireless medium measurements or sensor readings or performing an initial radar scan of a target, in order to identify a unique set of characteristics by which the target can be identified. For example, it may detect particular patterns in the wireless medium measurement, sensor readings or radar scan measurements/results, e.g., a unique movement pattern or biometric using signal/data processing/analysis, e.g. by analyzing the segmented data or mesh data as mentioned in other embodiments. To this end, the wireless communication device or a network function/server to which the wireless communication device is connected may run an AI model to learn how to identify the target (e.g., by identifying particular patterns) by feeding it with the respective wireless medium measurements, sensor readings and/or radar scan measurements/results. The model may also be fed with information (e.g., wireless medium measurements, sensor readings and/or radar scan measurements/results) related to a different object that should not be identified as a target. The AI model could be initially configured with a coarse-grained classification of objects and people based on some high-level characteristics (e.g., male person, medium height, heavy), and use such set of characteristics for a particular target object as input to determine a particular set of target objects with those characteristics in a particular area and/or select a particular AI model trained for objects with those characteristics. The user/subscriber of the sensing service could be asked (e.g., based on a request/message received from the network) to place his mobile phone once very close to the target object, so that an AI model can learn about the particular target object during this initial phase, and use the AI model afterwards for sensing of the target without requiring the mobile phone to be close to the target.

Additionally or alternatively, the wireless communication device carried/encompassed by a potential target may be instructed to show instructions for the target to perform a particular movement (e.g., wave hands, wiggle, move a few steps in a certain direction) that may be detected by the AI model, e.g., whilst performing an initial radar scan or at a particular time. The resulting set of target identification information or the AI model itself (or part thereof) may be transmitted to a core network function or application server and/or to a sensing service, sensing transmitter or sensing receiver or the first device 10 or second device 20, upon which it may be used for identifying a target using the mechanisms as described in other embodiments. The set of target identification may be stored together with an identifier of the wireless communication device or an identifier of the AI model. A sensing service, sensing transmitter or sensing receiver or first device 10 or second device 20 may use such identifier to identify a wireless communication device or an AI model, and transmit a request to verify whether a set of target identification information and/or a set of sensing measurement/results matches with a target.

In an embodiment that can be combined with other embodiments or that can be implemented independently, the sensing service, sensing transmitter or sensing receiver or first device 10 or second device 20 may receive information from a heat/movement sensor, camera or surveillance system (e.g., capable of generating heat maps or process video footage) or through an external application interface (e.g., Network Exposure Function) about a target for sensing and/or about other potential objects that should be excluded from being sensed or that should be excluded from the sensing measurements/results. The sensing service, sensing transmitter or sensing receiver or first device 10 or second device 20 may use the information to determine a target location, target area, target direction for transmitting the sensing signals towards and/or for the receiver to focus its antenna/receiving unit towards, e.g. by changing the FoV. The sensing service, sensing transmitter or sensing receiver or first device 10 or second device 20 may also use the information to correlate the sensing measurement/results with this information to determine whether or not the sensing measurement/results correspond to a target for sensing (e.g., by comparing a measured/calculated characteristic of the sensed object/target with a measured/calculated characteristic of an object/target based on this information). The sensing service, sensing transmitter or sensing receiver or first device 10 or second device 20 may also use the information to trigger the start of a (detailed/distributed) sensing session (only) when the presence of the intended target is detected in this information.

According to a further embodiment, the sensing service, sensing transmitter or sensing receiver or first device 10 or second device 20 determines based on an initial (low resolution) scan of the target or a detailed scan of the target (e.g., if allowed/enabled/authorized) that the sensing signals do not or cannot adequately identify a target object based on a set of target identification information. For example, this may be because the resolution/accuracy may be too low (e.g., due to a low frequency used), because the sensing signals may be blocked, because the distance may be too big, because the target may not sufficiently reflect the sensing signal or may absorb the sensing signal too much, or because the target is moving, or because the sensing transmitter or sensing receiver is moving). Based on this determination, the sensing service, sensing transmitter or sensing receiver or first device 10 or second device 20 may decide to reposition itself, delay sending the sensing signals (e.g., wait until the target, the receiver or transmitter have moved to a new position), adapt the sensing signal transmission characteristics/waveform, send information/instructions to the sensing transmitter or sensing receiver or first device 10 or second device 20 or sensing service or sensing application for example through the NEF (e.g., warning signal, request the receiver to move closer or further away to the position of the target or change its angle towards the target, reconfigure its antennas, adapt the sensing signal parameters, or a sensing measurement/result that, e.g., the transmitter may use to adapt the transmission of the sensing signals), select another receiver or first device 10 or second device 20 for sensing of the target, or send a signal to another transmitter or receiver or first device 10 or second device 20 to initiate the sensing of the target. If the first device 10 or second device 20 has a display (e.g., in the case of a mobile phone) or is connected to a display, the first device 10 or second device 20 may show a notification, whereby the notification may show a request and/or instructions to the user to move the first device 10 or second device 20 or the target to another position, or change its FoV or sensor heading.

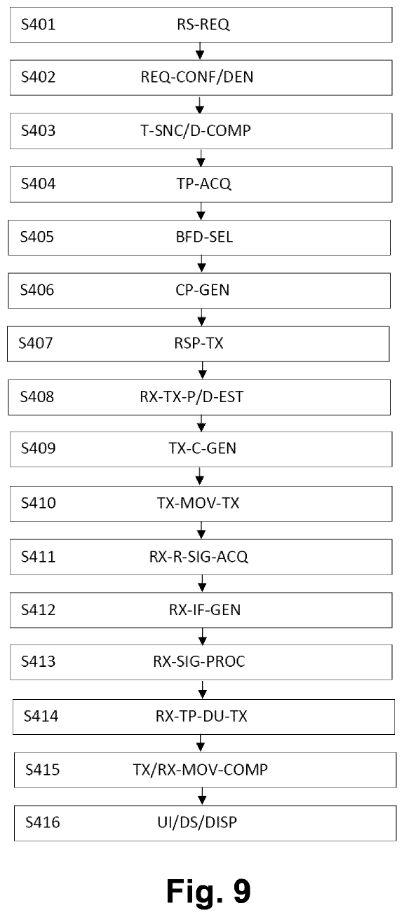

FIG. 9 schematically shows an embodiment of a flow diagram of a sensing operation (e.g., a radar-based sensing operation) including identification and authorization of a target for sensing.

In an optional initial session request (RS-REQ) step S401, a receiver device (e.g., terminal device), or a transmitter device (e.g., access device), or the first device 10, or the second device 20, or a sensing service, or sensing application (e.g., via NEF), or a mobile device carried/encompassed by a target, or a mobile device subscribed to a sensing service may transmit a sensing session request (e.g., using an RRC or NAS message) or a request for a service that may involve sensing (such as a metaverse or augmented reality service), possibly augmented with information about the position of the receiver device, transmitter device, first device 10, second device 20 or mobile device to the wireless network operating or providing access to the respective service. The request and/or the respective information may be transmitted as part of a PDU session request.

Optionally, information about a target location or area or volume of FoV, and/or a set of target identification information or an identifier associated with a set of target identification information, and/or (part-of) an AI model capable of identifying a target, and/or an identifier for authorizing the device to use a sensing service or be involved in a sensing operation, and/or a required scan time, may be supplied as well by the receiver device, the transmitter device, the first device 10, the second device 20, or the mobile device.

Optionally, the receiver device, transmitter device, first device 10, second device 20 or mobile device are authenticated by the network and are authorized to use a sensing service or be involved in a sensing operation (e.g., by verifying whether the subscription information associated with a unique identifier of the device includes information whether or not the device has subscribed to a sensing service or is authorized by a user (e.g., a target of a sensing service) to be involved in a sensing operation of a target).

In an optional responsive request confirmation (REQ-CONF)/denial (REQ-DEN) step S402, the sensing service, and/or the transmitter device, and/or the receiver device and/or the first device 10 and/or the second device 20, determine(s) whether it/they can respond to the request (for example make available sufficient bandwidth for the signals given its current communication demands) and transmit(s) to the requesting device or service a confirmation or denial response. The response (e.g., using an RRC or NAS message) may include a set of target identification information or an identifier associated with a set of target identification information and/or other sensing configuration information. The response may also include credentials to be used for securely sending (e.g., integrity/confidentially protected) any sensing measurements/results or other sensing information about one or more targets/objects, and/or sensing configuration information to the sensing service, or other devices or services or applications involved in a sensing session/operation. The response may further include a message to inform the user that the sensing service is activated and/or to request confirmation from the user of the UE to initiate/approve the sensing of the target and/or may also include a request for the location of the UE (if not provided in the request), e.g., to use it to verify whether the UE is in the vicinity of the target.

Optionally or alternatively, the sensing service or transmitter device or first device 10 or second device 20 can look up potential transmitter or receiver devices or a potential first device 10 or second device 20 close to the intended target (e.g., by requesting the last known position from a location database/service, or by requesting the potential devices to send their known position information, or acquiring the position from the potential devices through trilateration/triangulation/round trip time calculations based on signals received from the potential devices) and can voluntarily request (e.g., using an RRC or NAS message) a transmitter or receiver device or first device 10 or second device 20 to be used for sensing. The sensing service or transmitter device or first device 10 or second device 20 may transmit sensing configuration information based on a set of target identification information to the transmitter or receiver devices or first device 10 or second device 20 involved in the sensing of a target. Similar to the confirmation or denial response mentioned above, the request may include a set of target identification information or an identifier associated with a set of target identification information and/or other sensing configuration information, and may also include credentials to be used for securely sending (e.g., integrity/confidentially protected) any sensing measurements/results or other sensing information about one or more targets/objects, and/or sensing configuration information to the sensing service, or other devices or services or applications involved in a sensing session/operation. The request may further include a message to inform the user that the sensing service is activated and/or to request confirmation from the user of the UE to initiate/approve the sensing of the target, and/or may also include a request for the location of the UE (if not provided in the request), e.g., to use it to verify whether the UE is in the vicinity of the target.

Then, an optional time synchronization (T-SYNC) and delay compensation (D-COMP) step S403 is initiated, where a receiver clock is synchronized to a transmitter clock by sending a timing signal to the receiver device. Similarly, other devices involved in sensing, such as the first device 10 or second device 20 may synchronize their clock.

In an optional subsequent target position acquisition (TP-ACQ) step S404, a target location/area/volume information is determined by the transmitter device, receiver device, first device 10, second device 20 or sensing service, e.g., by performing an approximate radar object location scan in the direction or FoV indicated by the receiver device, first device 10 or second device 20 as target initial location estimate.

Alternatively or additionally, information about a target location/area/volume/FoV may be provided as part of sensing configuration or may be provided (indirectly) from a receiver device, transmitter device, first device 10, second device 20 or mobile device (as mentioned in step RS-REQ), which the transmitter device can use as target location information.

Alternatively or additionally, a set of target identification or an identifier associated with a set of target identification information may be provided to the receiver device, transmitter device, first device 10, second device 20 or sensing service.

Then, in a transmitter beamforming direction selection (BFD-SEL) step S405, the transmitter device selects an appropriate direction (for beamforming) for performing radar based sensing (distributed or non-distributed) based on the target location information/area/volume as transmitter target direction. Similarly, a first device 10, second device 20 can select an appropriate direction or FoV for performing sensing of the target based on the target location information/area/volume, or can select an appropriate viewpoint for its calculation of data for different viewpoints, sensor headings and/or FoVs (e.g., radar cross sections) used for matching (e.g. corresponding to a viewpoint, sensor heading and/or FoV of the other device (e.g. second device 20 in case of first device 10, or first device 10 in case of second device 20) involved in matching or corresponding to a position, angle and/or FoV of data stored or synthesized for a (pre-defined) set of viewpoints, sensor headings and/or FoVs.

In a following signal parameter generation, e.g., chirp parameter generation (CP-GEN), step S406, the transmitter device may select appropriate parameters of the signals and generates matching parameters for signal generation (e.g., by DFT-s-OFDM processing).

Then, in an optional subsequent (radar-based) sensing session parameter transmission (RSP-TX) step S407, the generation parameters and/or a selected start time and/or the location of the transmitter device, first device 10 or second device 20 and/or a target location information/area/volume/FoV are protected, e.g., encrypted using an encryption algorithm, and sent to the receiver device, first device 10, second device 20 where it is decrypted using a corresponding decryption algorithm.

In a following optional receiver-transmitter relative position and delay estimation (RX-TX-P/D-EST) step S408, the receiver device may use the transmitter location plus its own known receiver location or a round trip delay measurement to calculate a relative offset (or equivalent light transit time) between the transmitter device and the receiver device. Similarly, a first device 10 and second device 20 may use each other's location or a round trip delay measurement to calculate a relative offset (or equivalent light transit time) between the first device 10 and second device 20.

At the signal (e.g., chirp) start time, the transmitter device may initiate a transmitter generation (TX-C-GEN) step S409 and generates and emits a signal or a sequence of signals based on the generation parameters via an antenna beam formed in the direction of the transmitter target direction. Similarly, a first device 10 and second device 20 may initiate sensing of a target at the indicated start time.

In an optional transmitter movement series transmission (TX-MOV-TX) step S410, the transmitter device or first device 10 or second device 20 communicates its detected movements and/or vibrations during the sequence to the receiver device or other device (e.g. second device 20 in case of first device 10, or first device 10 in case of second device 20) or sensing service as transmitter movement data series. This information may be used to compensate for movements whilst performing matching (e.g. between viewpoint of first device 10 and viewpoint of second device 20).

In a receiver reflected signal acquisition (RX-R-SIG-ACQ) step S411, the receiver may collect reflected radio signals, whereby it may use beamformed reception directed at the target, to obtain a received signal.

The above steps S401 to S411 can also be applied to CSI-based distributed sensing systems.

In an optional receiver IF signal generation (RX-IF-GEN) step S412, the receiver device uses the obtained sensing signal start time, transmitter-receiver delay and sensing signal generation parameters to generate a synthetic internal analog sensing signal that matches with the emitted sensing signal and mixes this signal with the received signal to generate an IF signal.

Additionally or alternatively, the receiver may perform measurements (e.g., determine time of arrival of a received sensing signal, determine an angle of arrival of a sensing signal, determine an amplitude or frequency of a signal) or perform digital signal processing of the received sensing signals (e.g., to perform filtering of the signal, such as band-pass filtering or determine a signal deformation).

In a subsequent optional receiver signal processing (RX-SIG-PROC) step S413, the resulting IF digital signal data or the output resulting from measurements and/or digital signal processing performed on the received sensing signals is processed to yield sensing information (e.g., sensing measurements/results or application specific data, e.g., location, movement, vibration etc. of a detected object which may be a potential/intended target). Additionally or alternatively, the resulting IF digital signal data, or the output resulting from measurements and/or digital signal processing performed on the received sensing signals and/or the yielded sensing information is transmitted to a sensing service or a transmitter device for further processing.

In an optional target identification (T-ID) step, the receiver device, transmitter device or sensing service use the IF digital signal data, or the output resulting from measurements and/or digital signal processing performed on the received sensing signals, or the yielded sensing information from the previous step for detecting a set of objects and/or for determining a set of sensing information for one or more detected objects and/or for determining whether the set of sensing information for one or more detected objects meets or does not meet one or more configured criteria for identifying a target based on a set of target identification information. Similarly, a first device 10, second device 20 or sensing service can use measured data or segmented data from sensing of a target (in a FoV of the respective sensor of the device) for matching and/or identification of objects in the manner as described in other embodiments. A set of target identification may, for example, be pre-configured, or may be transmitted as part of a request for a sensing operation/session (e.g., from a core network function or an application (e.g., via the NEF), or from a device connected to the network), or may be transmitted (e.g., from the AUSF or UDM) to the respective receiver device, transmitter device, first device 10, second device 20 or sensing service upon authentication or authorization of a sensing service for a device (which may be carried or encompassed by a sensing target) connected to the network, or which may be retrieved from a core network function or database based on an identifier received as part of a request for a sensing operation/session or part of an authentication/authorization step, whereby the identifier is associated with a set of target identification information. Based on said determination, the receiver device, transmitter device, first device 10, second device 20 and/or sensing service may:
stop or continue the sensing operation;
initiate an additional sensing operation;
generate an event or transmit a signal indicating that a matching target was detected or was not detected; or
initiate/continue an authorization of a target for sensing (e.g., to verify whether a detected object is an authorized target for a sensing service).

Furthermore, in an optional receiver target position update transmission (RX-TP-UD-TX) step S414, the receiver device may send an updated and improved target location information to the transmitter device based on the results of step S413 to enable continuing accurate beamforming by the transmitter device towards the target.

Additionally, an optional transmitter and receiver movement compensation (TX/RX-MOV-COMP) step S415 may be integrated, where measured movements and/or vibrations of the transmitter device and the receiver device are subtracted from motions detected by the radar.

Finally, in a user interface, data storage and display (UI/DS/DISP) step S416, the resulting data (e.g., sensing information about a target object or information about whether a matching target was detected or not detected) may be stored and/or may be transmitted to a network service or application (e.g., via the NEF)and/or may be displayed by the receiver device, transmitter device, first device 10, second device 20 or other device (e.g., a mobile device carried/encompassed by a target) which may receive the resulting data from a core network service or application. The user interface and input information is collected (when necessary) using the user interface.

In the following additional embodiments, details of the application-specific processing applied to the digitized IF signal (e.g., in step S413 of FIG. 4) are described.

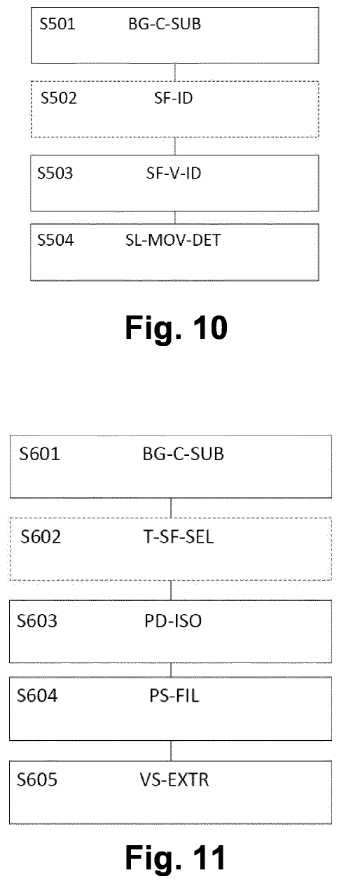

FIG. 10 schematically shows an embodiment of a flow diagram of a location and movement detection process.

This embodiment may be relevant for use cases such as object counting, object motion detection and measurement, infrastructure monitoring and the like. In such cases, the receiver device or transmitter device may request to set up a process for regular radar operations, e.g., repeated radar sensing every 15 (fifteen) minutes.

In an initial background clutter subtraction (BG-C-SUB) step S501, background subtraction of clutter (e.g., undesirable multipath signals) from the digital IF signal (i.e., IF frequency data) is performed. Background subtraction may be achieved by discriminating foreground information from background information based on variations of received data at different times. This can be achieved by applying recursive moving averaging (RMA) or a Gaussian mixture model (GMM) for learning mean values of path distributions. Then, in a surface identification (SF-ID) step S502, individual surfaces are identified from constant lines detected in the IF frequency data.

For objects with a measurable velocity, the velocity of each isolated surface is identified in a surface velocity identification (SF-V-ID) step S503 by the average phase change of the data extracted from that surface over several sequential sensing signals after phase extraction and phase unwrapping, e.g., by applying Doppler FFT. A sensing signal reflected at a moving surface incurs a Doppler frequency shift which is proportional to the velocity of the surface. This frequency shift introduces a phase shift in the detected sensing signal.

For objects with slow and long-term movement, the movement can be found in a slow movement detection (SL-MOV-DET) step S504 by determining their locations (range, direction) at regular times and calculating a change of that location over time.

FIG. 11 schematically shows an embodiment of a flow diagram of a heart rate and breathing rate detection process.

Again, in an initial background clutter subtraction (BG-C-SUB) step S601, background subtraction of clutter from the digital IF signal (i.e., IF frequency data) is performed.

Then, in a target surface selection (T-SF-SEL) step S602, the correct surface for a targeted user is selected from a constant line in the IF frequency data (at correct range).

In a subsequent phase data isolation (PD-ISO) step S603, the phase data from the selected surface is isolated and phase unwrapped (e.g., by applying a Doppler FFT).

Alternatively, the phase can be represented by complex components of sine and cosine of the signal (which avoids the need for phase unwrapping).

Then, in a phase filtering (PS-FIL) step S604, the phase signal is band pass filtered for a heart rate frequency range (e.g., 0.6˜4Hz) and/or a breathing rate (e.g., 0.1˜0.6Hz) to derive a heart rate data and/or a breathing rate data.

Finally, in a vital signal extraction (VS-EXTR) step S605, the resulting data is processed to extract the vital sign signal from the noise, for example using an algorithm such as a deep neural network trained on a dataset collected along with a “gold standard” such as electrocardiogram (ECG) and/or stretch breathing sensors, to compensate for noise and background movements to extract the desired signal (heart rate, breathing rate), the signal variability (e.g., heart rate variability) and confidence values for the accuracy of the data values.

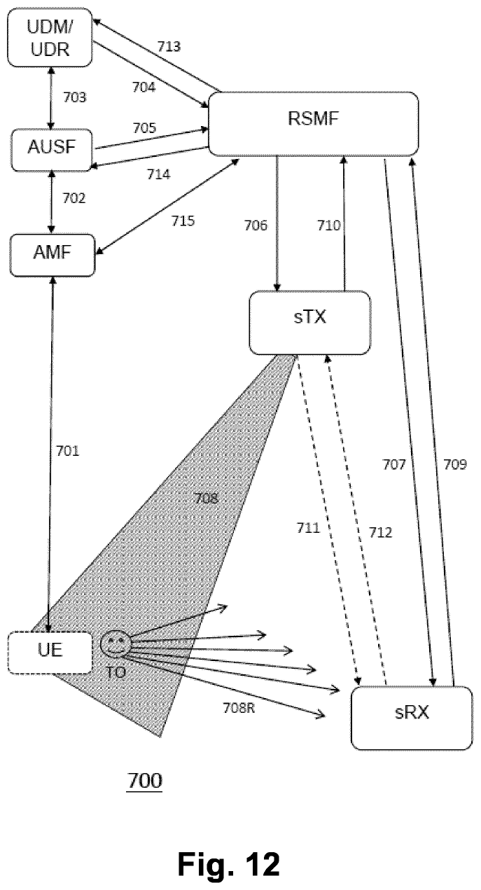

Another embodiment is represented in FIG. 12, which schematically shows an example sensing system 700, whereby the network (e.g., a RF sensing management function (RSMF) deployed by a wireless network, as depicted in FIG. 7) configures or controls the configuration parameters and/or the sensing requirements, and/or collects or combines the sensing results of a sensing transmitter (sTX) and/or a sensing receiver (sRX) and/or first device 10 and/or second device 20, e.g. to perform matching and/or to identify target objects. Such a RSMF could be deployed as a separate function or service in the core network, as part of an existing function in the core network (e.g., as part or extension of a location management function (LMF) e.g. as specified in 3GPP TS 23.273), as part of a wireless access device (such as a base station), or, e.g., as part of an application function or edge application or cloud server (that may indirectly provide the configuration information or sensing requirements and/or receive the sensing results via a network exposure function (NEF)), and may in general be seen as a sensing service and/or may support sensing capabilities as described for a sensing service in the present disclosure.

The RSMF may comprise a (network) communication unit capable of transmitting and receiving messages to/from the sensing transmitter (sTX) and/or the sensing receiver (sRX) and/or first device 10 and/or second device 20 and/or other core network functions and/or services (e.g., as specified in 3GPP TS 23.501, in particular UDM, UDR, AUSF, and AMF functions and/or services as depicted in FIG. 12), may comprise a non-volatile storage to store the sensing capabilities received from the sensing transmitter (sTX) and/or the sensing receiver (sRX), and may comprise a processing unit to run a sensing application or operation, to determine the parameters to be configured to the sensing transmitter (sTX) and/or the sensing receiver (sRX) (e.g., based on the received sensing capabilities from the sensing receiver (sRX) and/or from the sensing transmitter (sTX), and/or based on the sensing requirements (e.g., as received from or determined by an application or other services), and/or based on information about target objects (TOs) (for example a set of target identification information, as described in other embodiments of the present disclosure)), to collect sensing results from the sensing transmitter (sTX) and/or from the sensing receiver (sRX), and/or perform matching or object identification (e.g. using algorithms such as synthetic data algorithm(s) (SDA) 30, segmentation algorithm(s) (SA) 40, matching algorithms (MA) 50), and/or to further process the collected sensing results.

The RSMF may be deployed as part of the system 700 comprising a set of sensing transmitter devices (sTXs) (e.g., base stations, access points or UEs (e.g., mobile phones)) and a set of sensing receiver devices (sRXs) (e.g., base stations, access points or UEs (e.g., mobile phones)), whereby the sensing transmitter and receiver devices (sTXs, sRXs) may be colocated and hence be part of one and the same device (and hence may be controlled and operated as a single entity), and a set of first devices 10 and a set of second devices 20, and whereby the RSMF may be (securely) connected directly or indirectly via a set of wireless and/or wireline connections to these sensing transmitter, receiver devices (sTXs, sRXs), first devices 10 and/or second devices 20, and whereby the RSMF and the involved sensing transmitter, receiver devices (sTXs, sRXs), first devices 10 and/or second devices 20 may communicate with each other through a messaging protocol (e.g., a messaging protocol based on or extending the NAS protocol as defined in 3GPP TS 24.501, or RRC protocol as defined in 3GPP TS 38.331, or long-term evolution (LTE) positioning protocol (LPP) as defined in 3GPP TS 37.355, or new radio (NR) positioning protocol (NRPP) as defined in TS 38.455).

The RSMF and/or the sensing transmitter device (sTX) and/or the sensing receiver device (sRX) and/or first device 10 and/or second device 20 may support a method or a service flow comprising the following steps which may be performed in any order:
When the sensing receiver device (sRX) (e.g., a UE) or first device 10 or second device 20 registers to the network, the sensing receiver device (sRX) may provide its wireless sensing capabilities (e.g., device information (such as a number of antennas or supported frequency ranges), wireless sensing signal processing capabilities, ability to be a sensing receiver or a sensing transmitter or both, wireless sensing signal transmission capabilities (e.g., frequencies, timing, phase, type of signals it can generate), etc.), and other sensing capabilities (such as video or other sensing modalities) directly to the RSMF using a signal or a message transmitted from the sensing receiver device (sRX) to the RSMF over 709, or indirectly to the RSMF using a signal or a message transmitted from the sensing receiver device (sRX) to the sensing transmitter device (sTX) over 712 and then from the sensing transmitter device (sTX) to the RSMF over 710. This may also include capability information about supported sensing data types, algorithms (e.g. for segmenting the data), etc. The sensing receiver device (sRX) may also include its own position information, if known.

Alternatively or additionally, the position of the sensing receiver device (sRX) may be obtained from a LMF or location server, or from a wireless access device (e.g., a base station) which the sensing receiver device (sRX) is connected to or colocated with.

Similarly, when a sensing transmitter device (sTX) (e.g., a wireless access device such as a base station (e.g., a mobile base station relay device)) or first device 10 or second device 20 is added to the network, it may provide its wireless sensing capabilities to the RSMF using a signal or a message over 710.

It is to be noted that, in an alternative embodiment, the (wireless) access devices could also be OAM (operations, administration and maintenance) managed, whereby the RSMF may be deployed as part of the OAM or may be connected to the RSMF for exchange of signals or messages (such as sensing capabilities of a wireless access device, configuration messages for sensing, or sensing measurements or sensing results).

The wireless access device or core network function (e.g., the AMF), to which the sensing receiver device (sRX) or sensing transmitter device (sTX) or first device 10 or second device 20 gets registered, may forward or redirect the signal(s) or message(s) or the capability information, as received from the sensing receiver device (sRX) or from the sensing transmitter device (sTX) or from the first device 10 or from the second device 20, to the RSMF (e.g., based on the device's identity or the session identity or the RSMF identity that may be provided in the registration message). The sensing receiver device (sRX) or the sensing transmitter device (sTX) or the first device 10 or the second device 20 may also send their capabilities after an initial registration, e.g., using an RRC UECapabilityInformation message as specified in 3GPP TS 38.331, or through an LPP ProvideCapabilities message as specified in 3GPP TS 37.355, or as part of a sensing session setup request message (e.g., a separate/new NAS message by extending the messages as defined in 3GPP TS 24.501, a separate or new RRC message by extending the messages as defined in 3GPP TS 38.331, or a separate or new LPP or NRPP message by extending the messages as defined in respective 3GPP TS 37.355 and TS 38.455). Note that the capabilities of each of the devices involved in sensing may be different. For example, the RF signal processing capabilities of a UE may be different from those of a base station, e.g., a UE may be capable of determining a position or movement of a target object (TO), but may not be capable of determining a shape of the target object (TO), or, e.g., a UE may be capable of receiving and performing measurements on the received sensing signals, but be not capable of generating and transmitting wireless sensing signals. Also the supported sensing modalities or data types may be different. Hence the configuration of each of these sensing transmitter and sensing receiver devices (sTX, sRX) and first devices 10 and second devices 20 may be different or may change depending on the capabilities or the role (e.g., act as a sensing transmitter or a sensing receiver) they take. If a device can act as both a sensing transmitter (sTX) and sensing receiver (sRX), the sensing transmitter and receiver roles may be configured and/or activated independently, and may change dynamically (e.g., may act intermittently as a sensing transmitter and a sensing receiver, or may act as both a sensing transmitter and a sensing receiver simultaneously depending on a given schedule or based on messages received, e.g., by the RSMF or another network function, or by a local application).
Based on the sensing needs of a (5G) core network service (e.g., provided by or via GMLC or LMF or AMF) or external application (e.g., provided via NEF) or a UE (e.g., provided during registration with the core network), and/or based on the received capabilities, the RSMF may determine a set of wireless access devices (e.g., base stations) and/or UEs and/or other devices to be used for sensing, and may configure one or more of these devices as a transmitter of the wireless sensing signals or configure them to participate in the sensing of a target (e.g. using sensor 12 or sensor 22), using signals or messages directly transmitted from the RSMF to the sensing transmitter device (sTX) over 706. To this end, a core network service may provide the relevant information (e.g., sensing needs/requirements) for sensing by issuing a request for sensing by using a network initiated location request (NI-LR) (e.g., as defined in TS 23.273) to the RSMF, which may be extended to include information about a target to be sensed and/or about sensing requirements (e.g., which sensing results, e.g., velocity, need to be calculated, and/or accuracy requirements) and/or about sensing configuration information (e.g., target location/area/volume information that may be based on the location of the UE that initiated the request, or an identifier of the UE that initiated the request if the location of the UE is not known and still needs to be determined) and/or about capability information of one or more sensing receivers or sensing transmitters or first devices 10 or second devices 20. This may also include information about a model (e.g., semantic model) of an object and/or a set of data for different viewpoints, sensor headings and/or FoV (e.g., radar cross sections) of an object and/or a set of mesh data of an object stored in an object database, information about the FoV (and possibly other information related to the sensors used, such as viewpoint and/or sensing heading and/or sensing capabilities) of devices involved in the sensing of a target or viewpoints/angles of stored data for different viewpoints, sensor headings and/or FoV (e.g. radar cross sections) of a target, information about sensing modalities or data types supported by devices involved in sensing of a target, information about which segmentation algorithms are supported or need to be used. The RSMF is able to receive and interpret such information upon which the RSMF may then initiate the selection and configuration of the sensing transmitter devices. Similarly, the UE may issue a mobile originated location request (MO-LR) or another client (e.g., an application function) may issue a mobile terminated location request (MT-LR) to the RMSF, carrying the above-mentioned information. If the location of the UE that initiated the request (or the identity of the UE included in the request to the RSMF, e.g., triggered by a core network function to initiate sensing via the RSMF) is used as a target location, and the location of that UE is not yet known, the RSMF may first request the LMF to determine the location of that UE, after which it may use the resulting location as the target location, possibly in addition to some other information, such as (pre-configured or estimated) distance between the UE and the target, or (pre-configured or estimated) information about the emergency/disaster area. Additionally, one or more of the set of wireless access devices (e.g., base stations) and/or UEs and/or other devices to be used for sensing may be configured as a second device 20 for matching purposes, or as a receiver of the wireless sensing signals, using signals or messages directly transmitted from the RSMF to the sensing receiver device (sRX) over 707 or indirectly transmitted from the RSMF, i.e., transmitted from the RSMF to the sensing transmitter device (sTX) over 706 and then from the sensing transmitter device (sTX) to the sensing receiver device (sRX) over 711. The sensing transmitter and receiver devices (sTX, sRX) may also be colocated.

The device configuration information may include information about the wireless sensing signal to be used (e.g., timing, frequency, phase offset, identification of a wireless sensing signals), an identification of an algorithm or filter to be used for processing, wireless sensing application or session identifier, destination for sending the signal processing results, information about the FoV of devices involved in the sensing of a target or viewpoints/angles of stored data for different viewpoints, sensor headings and/or FoV (e.g. radar cross sections) of a target, information about sensing modalities or data types supported by devices involved in sensing of a target, information about which segmentation algorithms are supported or need to be used, etc. (e.g., as described in the present disclosure). Some of these parameters may also be determined by the devices themselves, e.g., the sensing transmitter device (sTX) may decide the timing of the sensing signal (i.e., which resources are used for the sensing signal). Such parameters may be directly exchanged with the sensing receiver device(s) (e.g., through a DCI or sidelink control information (SCI) signal or message as specified in 3GPP TS 38.212 (e.g., with a particular (new) format identifiable to denote reception or transmission of sensing signals and/or sensing signal parameters such as frequency), or through a semi-persistent schedule (SPS) denoting a repeating set of resources used for sensing signals) or indirectly through the core network.
Based on the sensing needs of a (5G) core network service (e.g., as part of an authentication and/or authorization procedure of a target for a sensing service) or external application, the RSMF may obtain information about a set of target objects. This information may include (rough) location information (or, e.g., the last known location) or area information (e.g., an address of factory, hospital or house, or a denoted (geographical) area or volume) in which the target object is expected to reside or where it often resides, or may include information on how to identify a certain target object (e.g., physical characteristics, material, shape, etc.) (i.e., a set of target identification information as described in other embodiments of the present disclosure), or may include identities of devices that the person may own or carry, etc. (e.g., as described in other embodiments of the present disclosure). The RSMF may use this information about the set of target objects to select and configure a set of sensing transmitter and/or receiver devices (sTXs, sRXs) and/or first devices 10 and/or second devices 20 to participate in the sensing of the indicated target or target area/volume (this may include information about the wireless sensing signal to be used, as described above in the previous bullet) or for a particular FoV, and/or may forward and/or configure some of this information to the set of sensing transmitter and/or sensing receiver devices (sTXs, sRXs) and/or first devices 10 and/or second devices 20. For example, the RSMF may provide the set of target identification information or an identifier associated with the set of target identification information to the set of sensing transmitter and/or receiver devices (sTXs, sRXs) and/or first devices 10 and/or second devices 20.

Additionally or alternatively, a UE device carried or encompassed by a target object (TO) may establish a connection to a network (e.g., to the AMF) via 701, and may trigger or initiate a sensing operation by sending a signal (which may carry a message) indicating such a trigger or initiation directly (e.g., through a tunneled connection over 701 and 715), or indirectly (e.g., via the AMF over 715 or via the AUSF over 705, whereby the UE may use a different set of messages to the AMF or AUSF than that being used between the AMF or AUSF and the RSMF), to the RSMF. Upon receiving such a trigger or initiation for initiating sensing, the AMF or the AUSF or the RSMF may initiate or request an authorization of the sensing service for the UE. For example, the AUSF may obtain a SUPI of the UE based on an identity provided by the UE to the AMF over 701 and then transmitted from the AMF to the AUSF via a message over 702, or based on an identity provided by the UE to the AMF over 701, transmitted from the AMF to the RSMF via a message over 715 and then transmitted from the RSMF to the AUSF via a message over 714, and based on the obtained SUPI, the AUSF may check or verify the information in the subscription database (e.g., the UDM) by transmitting a message to the UDM over 703, to determine whether or not the user of the UE device is subscribed to the sensing service and/or whether the UE device is authorized to participate in the sensing operation and/or whether the user of the UE device has provided consent to be a target for the sensing operation. If the user of the UE device is indeed authorized, then the UDM or the AUSF or the AMF may inform the RSMF about this through a message respectively transmitted over 704, 705 or 715. This message may contain a set of target identification information or an identifier associated with a set of target identification information (e.g., provided by the UDM/UDR that may store this information as part of the subscription information for the sensing service). Afterwards, the RSMF, the sensing transmitter device (sTX) and/or the sensing receiver device (sRX) and/or first device 10 and/or second device 20 may initiate or perform sensing as described in the present disclosure. Note that initiating a sensing operation may comprise receiving or retrieving a set of target identification information, or an identifier associated with the set of target identification information (e.g., if a set of target identification information and its associated set of identifiers has already been provided earlier or during a pre-configuration of the involved sensing transmitter and receiver devices (sTX, sRX) and/or RSMF).

Optionally, the RSMF may send a signal or a message (e.g., via a tunneled connection over 715 and 701) to the UE device carried or encompassed by the target object (TO), the signal or the message indicating that the sensing operation is starting or is about to start. The UE device may display a notification to the user or may request the user to provide confirmation (or automatically provide confirmation based on the UE device configuration) that he/she/it agrees to start the sensing operation, upon which a signal may be sent back to the sensing service (e.g., via a tunneled connection over 715 and 701) indicating whether or not a confirmation has been obtained. And if the confirmation is obtained, initiate or further perform sensing. The AUSF may optionally provide credential information to the RSMF over 705, and/or the RSMF may determine a set of credential information and may provide it to the AUSF over 714. The AUSF or the RSMF may provide, after successful authentication and/or authorization, this credential information to the involved devices (e.g., the sensing transmitter device (sTX), the sensing receiver device (sRX), first devices 10, second device 20), which may use the credential information for securely sending (e.g., integrity and/or confidentially protected) any sensing measurements and/or results (i.e., a set of sensing information) or other sensing information about one or more target objects, and/or sensing configuration information, to the RSMF, or to other devices or services or applications involved in the sensing session or the sensing operation.

The UE device carried or encompassed by a target object (TO) may provide information about its location and/or a set of target identification information or an identifier associated with a set of target identification information and/or other sensing capability/configuration information, upon of after it has registered to the network to the RSMF (e.g. via the AMF or the LMF to which the RSMF may be connected to obtain the position of the UE), or may be requested by the RSMF or LMF to provide its location or participate in a location determination procedure to enable the RSMF to obtain the position of the UE device and/or may be requested to provide a set of target identification information or an identifier associated with a set of target identification information and/or other sensing capability/configuration information.

The position information may be used as (initial) target location and/or may be used to configure the sensing receiver(s) and/or sensing transmitter(s) and/or first device 10 and/or second device 20 for sensing of the TO, i.e., the RSMF may use the location information of the UE device together with location information of a set of sensing receiver device(s) and/or sensing transmitter device(s) and/or first devices 10 and/or second devices 20 it may have stored or may obtain, in order to select and configure a set of sensing transmitter and/or sensing receiver devices (sTXs, sRXs) and/or first devices 10 and/or second devices 20 that are in the vicinity of the UE device (and hence in the vicinity of the TO) to enable these devices (sTXs, sRXs) to participate in a sensing operation of the TO. Similarly, the set of target identification information or an identifier associated with a set of target identification information and/or other sensing capability/configuration information may be used by the RSMF to select and configure a set of sensing transmitter and/or sensing receiver devices (sTXs, sRXs) and/or first devices 10 and/or second devices 20 that are capable of participating, or are best equipped to participate, in sensing of the TO based on the target identification information (e.g., by determining a required/desired accuracy based on which the RSMF may select sensing transmitter and/or sensing receiver devices (sTXs, sRXs) and/or first devices 10 and/or second devices 20 that may be capable of achieving the required/desired accuracy, e.g., because they support sensing using high frequency bands).

It is to be noted that the RSMF may provide location information about the UE device and/or location information about sensing transmitter device(s) (sTX(s)) and/or sensing receiver device(s) (sRX(s)) and/or first device(s) 10 and/or second device(s) 20, to the UE device and/or to one or more of the (selected) sensing transmitter device(s) (sTX(s)) and/or (selected) sensing receiver devices(s) (sRX(s)) and/or first device(s) 10 and/or second device(s) 20. Furthermore, the sensing transmitter device (sTX) or the sensing receiver device (sRX) or the first device 10 or the second device 20 may each provide location information about itself or about other sensing transmitter devices (sTXs) or about other sensing receiver devices (sRXs) or about other first devices 10 or second devices 20, to (further) other sensing transmitter and sensing receiver devices (sTXs, sRXs) and first devices 10 and second devices 20. This information may be used during the processing of the sensing measurements and/or sensing results for determining the location of the target object (TO) (as described in other embodiments of the present disclosure).

Alternatively, if target location or area or volume information or FoV information is not available, the RSMF may trigger a (broadcast) search function in which the sending transmitter devices (sTXs) or first device 10 or second device 20 are requested to sense the environment to determine the rough location information of the set of target objects (TOs).

Alternatively or additionally, one or more of the devices involved in the sensing (e.g., a base station that may include both sensing transmitter and sensing receiver capabilities) may determine a rough position or location of the target object(s) (TO/TOs) (e.g., based on a non-distributed radar based sensing) and provide this information about the rough position or location of the target object(s) (TO/TOs) to the RSMF.

Alternatively or additionally, a rough location (or the last known location) of the target object (TO) or more generally a target location or area or volume or FoV may be provided by an external application (e.g., through the NEF) or may, e.g., be obtained from the LMF, as specified in 3GPP TS 23.273, or from the network data analytics function (NWDAF), as specified in 3GPP TS 23.288, e.g., based on the identity of a device or UE device expected or known to be attached to or carried by the target object (TO)). The RSMF or the sensing transmitter device (sTX) or the sensing receiver device (sRX) or first device 10 or second device 20 may provide the rough position or location information about the target object(s) (TO/TOs), or more generally a target location or area or volume of FoV, to the involved sensing receiver device(s) (sRX/sRXs) and the involved sensing transmitter device(s) (sTX/sTXs) and the involved first devices 10 and the involved second devices 20.

Alternatively or additionally, the sensing function or service (RSMF) may obtain information about devices (e.g., information about their identities and estimated location) that are in the vicinity of the target object (TO) (e.g., a set of nearby base stations or UEs in the vicinity that are able and may be authorized (or are authorized) by the network and/or by the user of the device and/or by the target person or the target object owner, to participate in (distributed) sensing of the intended target. The authorization information (which may also include user consent information) may be stored as part of the user's subscription (e.g., in the UDM function of the core network) and/or as part of the RSMF, and/or may be received from a service or application function or an external application (e.g., through the NEF). The RSMF may use the information about sensing transmitter and/or receiver devices (sTX, sRX) and/or first devices 10 and/or second devices 20 in the vicinity of the target object (TO) in its selection and configuration of the sensing transmitter, and/or sensing receiver devices (sTX, sRX) and/or first devices 10 and/or second devices 20 to be used. The devices involved in sensing may be invited and/or configured to be involved in a sensing session by sending a message that may include a session identifier and/or a sensing signal identifier and/or a set of target identification information or an identifier associated with the set of target identification information.

Alternatively or additionally, an initial radar scan or sensing operation, which is performed by one of the sensing devices that may support both transmitter and receiver roles or that supports sensor 12 as in the first device 10 or sensor 22 as in the second device 20, may show that the obtained accuracy of the sensing measurements may not be sufficient to meet the desired accuracy (e.g., as indicated or received or configured in the RSMF, e.g., by an external application). The sensing devices involved may determine this themselves and inform the RSMF about it, or the RSMF may determine this based on the sensing results it may receive from the respective sensing devices.

Alternatively or additionally, the RSMF may determine, based on the capabilities of the sensing transmitter and/or receiver devices (sTX, sRX) and/or first devices 10 and/or second devices 20 and/or the available bands or spectrum in a certain area, and/or through previous measurements (e.g., obtained by or from a network analytics function such as NWDAF), that the accuracy by the involved sensing transmitter and/or receiver devices (sTX, sRX) and/or first devices 10 and/or second devices 20 and/or the accuracy that can be obtained in a given sensing area may not be sufficient for the application's requirements. The RSMF may use this information (possibly together with the received capabilities and location information of the sensing transmitter and/or receiver devices (sTX, sRX) and/or first devices 10 and/or second devices 20 in an area) as a trigger to select other or additional sensing transmitter and/or sensing receiver devices and/or first devices 10 and/or second devices 20 in the vicinity of the target object (TO), and/or to improve the sensing measurements and sensing accuracy (e.g., by changing to a higher frequency and/or to larger bandwidths, by increasing the number of signals and/or the number of signal measurements, or by selecting different algorithms).
The RSMF may activate one or more of the selected sensing transmitter devices (sTXs) and/or the sensing receiver devices (sRXs) and/or first devices 10 and/or second devices 20 to activate the sensing, e.g., by initiating a sensing session directly over 706 and/or 707, respectively, or indirectly via the sensing transmitter device (sTX) over 706 and then 711. The activation of the sensing transmitter device (sTX) and/or the sensing receiver device (sRX) and/or first devices 10 and/or second devices 20 may be triggered automatically by receiving the above-mentioned sensing configuration (e.g., given a start time or a set of time intervals when the sensing signals are transmitted), or may be triggered through a separate message (e.g., an additional LPP message containing for example a sensing session identifier) or through a separate signal (e.g., an identifiable sensing signal being detected matching one or more of the given signal characteristics or signal identifiers provided during configuration).
Based on the received configuration information and/or rough location of the target object (TO) or more generally a target location or area or volume or FoV, one or more of the sensing transmitter devices (sTXs) and/or first devices 10 and/or second devices 20 will direct a wireless sensing signal 708 or will initiate sensing using sensor 12 or sensor 22 in the direction of the target location or area or volume or FoV. The time at which such a wireless sensing signal 708 is transmitted is based on or the time to initiate sensing using sensor 12 or sensor 22, e.g., timing information (e.g., a sensing start time or a set of time intervals for sensing or a (pre-configured) set of time or frequency resources) as configured and, e.g., shared with the sensing receiver devices (sRXs) and/or other sensing transmitter devices (sTXs) and/or first devices 10 and/or second devices 20. In case of wireless sensing (e.g. radar based or distributed sensing) the sensing receiver device(s) (sRX/sRXs) will receive the reflected wireless sensing signal 708R and be capable of recognizing and processing the received reflected wireless sensing signal 708R based on the wireless sensing configuration information that was provided (e.g., as described in the present disclosure). In an example, based on the received reflected wireless sensing signal 708R, the timing information of when a signal was sent (e.g., as configured or part of timestamp information in the signal), its own known location and the location of the sensing transmitter device (sTX) (e.g., the base station), a position or location of a (potential) target object (TO) can be estimated, e.g., by using triangulation. In case of sensing using sensor 10 of first device 10 or sensor 12 of second device 12, the first device 10 or second device 20 may send its measurements or segmented data to the RSMF or to the other device (e.g. second device 20 in case of the first device 10), and the first device 10 or second device 20 or the RSMF may calculate mesh data and/or match the data with the viewpoint, sensor heading and/or FoV of the first device 10 or second device 20 or data that was stored for different (pre-defined) viewpoints, sensor headings and/or FoV (e.g. radar cross sections) or that matches a synthetic model of a target.

Additionally or alternatively, each sensing receiver or sensing transmitter device (sRX, sTX) or first device 10 or second device 20 will send its wireless sensing signal measurement and/or processing results to the configured destination (e.g., to the RSMF), which collects the results and can perform further processing on these results. This may include matching or object identification (e.g. using algorithms such as synthetic data algorithm(s) (SDA) 30, segmentation algorithm(s) (SA) 40, matching algorithms (MA) 50) as described in other embodiments of this disclosure. The RSMF may use all received/collected measurements and/or (partial) sensing results to determine a set of sensing results. This may be based on the sensing requirements received in the location/sensing request (e.g., as received from the application). The sensing results (e.g., the position of the target) may be provided to the entity (e.g., GMLC/AMF/NEF/UE) that issued or forwarded the “extended” location request to the RSMF. Alternatively or additionally, the sensing results may be stored in a shared storage, e.g., an unified data repository (UDR), from which other entities can fetch the sensing results based on an identifier provided by the RSMF to the respective entity.

The processing on a sensing receiver device (sRX), or on a sensing transmitter device (sTX) or first device 10 or second device 20, or a part of this further processing on the configured destination (e.g., the RSMF), may include a step for detecting a set of objects, and/or a step for determining a set of sensing information (i.e., measurements and/or results) for one or more detected objects, e.g., using an initial scan or sensing operation of a target area or volume performed by the sensing service (i.e., the RSMF) and/or the sensing transmitter device (sTX) and/or the sensing receiver device (sRX) as also described in other embodiments, and/or a step for determining whether the set of sensing information (i.e., the measurements and/or results obtained as an output of the sensing operation) for the one or more detected objects meets or does not meet one or more configured criteria (e.g., threshold values) for identifying a target based on a set of target identification information. Based on said latter determination, the sensing receiver device (sRX) and/or the sensing transmitter device (sTX) and/or first device 10 and/or second device 20 and/or the configured destination (e.g., the RSMF) may:
stop or continue the sensing operation, for example by sending a signal or a message directly to the sensing transmitter device (sTX) or first device 10 or second device 20 over 706 and/or directly to the sensing receiver device (sRX) or first device 10 or second device 20 over 707, or indirectly to the sensing receiver device (sRX) or first device 10 or second device 20, e.g., via the sensing transmitter device (sTX) over 706 and then from the sensing transmitter device (sTX) to the sensing receiver device (sRX) over 711;
initiate an additional sensing operation, for example by sending a signal or a message directly to the sensing transmitter device (sTX) or first device 10 or second device 20 over 706 and/or directly to the sensing receiver device (sRX) or first device 10 or second device 20 over 707, or indirectly to the sensing receiver device (sRX) or first device 10 or second device 20, e.g., via the sensing transmitter device (sTX) over 706 and then from the sensing transmitter device (sTX) to the sensing receiver device (sRX) over 711;
generate an event or transmit a signal, the event or the signal indicating that a matching target was detected or was not detected (wherein the matching target matches (with a certain confidence or matching percentage) either a subset of the set of target identification information in the case of a partial match or an entirety of the set of target identification information in the case of a full match), for example by sending a signal or a message directly to the RSMF from the sensing transmitter device (sTX) or first device 10 or second device 20 over 710 and/or from the sensing receiver device (sRX) or first device 10 or second device 20 over 709, or indirectly to the RSMF from the sensing receiver device (sRX) or first device 10 or second device 20, e.g., from the sensing receiver device (sRX) to the sensing transmitter device (sTX) over 712 and then from the sensing transmitter device (sTX) to the RSMF over 710, or by sending a signal or a message from the RSMF to the UDM/UDR over 713 or to the AUSF over 714 (e.g., as part of an authentication and/or authorization procedure) or to an application function or AAA server (e.g., via the NEF, not shown) or to a non-volatile storage unit; or
initiate or continue an authorization of a target or target object (TO) for sensing (e.g., to verify whether a detected object is an authorized target for a sensing service), for example by sending a signal or a message from the RSMF to the UDM/UDR over 713 or to the AUSF over 714, or to an application function or AAA server (e.g., via the NEF, not shown).

Thus, the RSMF can retrieve the wireless sensing capabilities of the sensing receiver devices (sRXs) and/or the sensing transmitter devices (sTXs) and/or first devices 10 and/or second devices 20, can configure one or more sensing transmitter devices (sTXs) and/or sensing receiver devices (sRXs) and/or first devices 10 and/or second device 20s to take part in wireless sensing of the target object (TO), can configure a wireless sensing capable receiver device (sRX) and/or a wireless sensing capable transmitter device (sTX) and/or first device 10 and/or second device 20 with information about to which network entity or destination server to send the wireless sensing results, can configure a wireless sensing capable transmitter device (sTX) and/or a wireless sensing capable receiver device and/or first device 10 and/or second device 20 with information about when and how to transmit and/or receive and/or process a wireless sensing signal, and can collect and further process wireless sensing measurements and/or results (i.e., a set of sensing information) from the sensing transmitter devices (sTXs) and/or from the sensing receiver devices (sRXs) and/or first devices 10 and/or second devices 20.

### Object Identification (for Metaverse or Mixed Reality Services)

A metaverse or MR service may be a service operated by a 3rd party who may gain access to specific network functions of the wireless network via service application programming interfaces (APIs) (e.g., similar to a network exposure strategy). A metaverse or MR service provider may be a 3rd party who operates the metaverse or MR service, while a user may be an individual who participates either actively or passively in the metaverse or MR service. A user ID may be an identifier that is unique to a given user. It may be a unique identifier of the user's UE, an ID supplied by the metaverse or MR service provider, a local ID assigned by a (serving) base station (e.g., gNB) or a local network, or other. It might be fixed or temporary. A viewing user may be a user who is currently viewing another user. Sensors of the user's UE are also assumed to be viewing the other user. A viewed user may be a user who is viewed by the viewing user and whose identity is initially unknown to the viewing user and/or their UE. The viewed user location is to be understood as the location of the viewed user. In case the viewed user has a UE, this may be functionally identical to the UE's location as provided e.g. by the LMF 320 or GNSS location data provided by the UE to the wireless network. In case the viewed user does not have a UE, this may be determined from radar data collected by the sensor 22 or other sensor of e.g. a device carried by a viewing user, denoted as the second device 20 in FIG. 3 or 4.

In a metaverse or mixed reality (MR) scenario (as initially described), multiple users may use their user devices (e.g., UEs) to interact with both real objects and virtual assets. Virtual assets are rendered by the UEs. Such virtual assets may be related to particular users, e.g., they may be a virtual outfit, a virtual pet, etc. When one user enters the view of the other user, virtual assets associated with the viewed user need to be correctly rendered by the viewing user's UE.

This requires the viewing user's UE to identify the viewed user, i.e., such that correct virtual assets may be retrieved from the metaverse provider and rendered by the UE. However, the viewing user's UE may initially have no (access to) information on the viewed user, other than the information it can attain from local sensors (e.g., video pose data of the viewed user as attained by e.g. a camera of the viewing user's UE). This may get more com-plicated if the viewing user and the viewed user are participating in separate metaverses (such that the viewing user's metaverse service may also initially have no information on the viewed user) or if the viewed user has no UE at the time at which they are viewed (and thus can't provide any identification information).

To address this issue, the wireless network to which the UEs are connected may utilise its sensing capabilities (e.g., gNBs in a sensing mode collecting radar data of a user's pose) to provide a “viewed user identification service”. Here, data on the viewed user from UE sensors (e.g., camera) is used to generate synthetic data which may then be matched according to the above embodiments to data collected on the same viewed user by wireless network sensors. Once a match has been confirmed, the wireless network may provide an identifier, e.g., a unique user ID, of the viewed user to the viewing user's UE, which can then be used to request digital assets from the metaverse service provider for rendering. Alternatively, the wireless network might request said digital assets directly e.g. from an identity service or subscription service and/or user/object database operated by the network itself or from an 3d party application function (e.g. via Network Exposure Function (NEF)) and provide the viewing user's UE with said digital assets. Similarly, other objects (not just users) may be detected. This alternative approach protects the privacy of the user since a unique ID does not need to be disclosed. In an example, digital assets that are actually provided might depend on a privacy policy linked to the matching serving and the rights of the viewing user's UE.

This final step requires the wireless network to have prior access to a list of identifiers, e.g., unique user IDs, associated with data collected by wireless network sensors.

In cases where the viewed object (e.g., user) has a UE, this association may be accomplished by providing the UE with a unique ID, or by determining the UE's location (e.g., by the LMF 320 of the 5GS), or by determining the location of viewed objects via wireless network sensors, or by assigning a UE's unique ID or a related ID (e.g., an ID derived from the UE's unique ID) or a location-based or time-based pseudonym to objects who are co-located with that UE. Any further data collected by wireless networksensors may then by associated with that ID.

In cases where the viewed object has no UE, temporary IDs may be assigned by the network to all users sensed by the wireless network sensors. If required, further steps may then be taken to identify these objects, for example, if the viewed object is known to some viewing users but not to others, a viewing user who knows the viewed object may be able to provide an identifier for the viewed object, which can then replace the temporary ID and be sent to other viewing users. Or, if an authentication function is available (e.g., network sensors are used to gain biometric data), the network may be able to authenticate the viewed object directly and assign a unique ID to the viewed object.

As indicated in FIG. 3, the wireless system (5GS) may consist of the core network (5GC) 300, the access network (5G-AN) 200 and the mobile stations or terminal devices 100 (e.g., UEs). The LMF 320 in the core network 300 may provide the geographic position of some or all mobile stations 100.

Sensing functions performed e.g. by the second device (B) 20 may be achieved via or supported by one or more of the base stations (e.g., gNBs) of the access network 200. Such sensing functions could also be based on raw base station measurement data for identification purposes and may be carried out by a network function of the core network 300, or by an external application.

Execution of some or all algorithms described in the above embodiments may be carried out by hardware of a base station 220 or a mobile station (e.g., UE) 100 or a network function of the core network 300 or by an external application or by some or all of the above entities in combination.

The first device (A) 10 of FIGS. 3 and 4 may be a UE used for MR or AR reality applications. E.g., AR glasses, or a smartphone. In the present use case, the first device 10 is considered to be the UE of the viewing user, which may have established a communications link with the wireless network, so that the location of the first device 10 may be provided to the system (e.g., by the LMF 320 or by the first device 10 itself). The sensor 12 of the first device 10 may be a line-of-sight sensor, e.g., a camera or a lidar sensor. The measured data D_{MA} may be a brief section of data recorded by the sensor 12 of the first device 10 (e.g., a few hundred frames of video footage), featuring (e.g., showing, presenting) the viewed object with a moving pose.

The second device (B) 20 of FIGS. 3 and 4 may be one or more devices which are part of the wireless network, wherein the wireless network has access to the sensor(s) 22 of the second device(s) 20.

In some embodiments, the second device 20 may be a gNB or base station as part of the access network 200. The sensor 22 of the second device 20 may be a radar sensor, which may include at least one of dedicated radar sensors placed on the gNB, communications components used in dedicated sensing mode (e.g., ISAC), and a passive sensing function derived from normal communications signals.

In some embodiments, the sensor 22 of the second device 20 may be entirely virtualized and provided as part of a network function on the core network 300, where raw measurement data may be provided by many sensors which can be accessed by the network. In such cases, a single second device 20 may not be present. The sensor 22 of the second device 20 may have a set of properties including at least one of a data type, a field of view (FoV) of the sensor, a heading of the sensor, and a 3D position of the sensor 22 or the second device 20. The sensor 22 may be capable of collecting the measured data D_{MB} of the second device 20 (i.e., pose data of the viewed object), but also determining the location of the viewed object (i.e., a range and angle measurement).

In an alternative embodiment that may be combined with other embodiments or implemented independently, instead of matching measured or segmented data from sensor 12 of the first device 10 to data (e.g., measured or virtualized) from sensor 22 of the second device 20, one or more radar cross sections may be generated based on the measured or segmented data from sensor 12 of the first device 10, whereby the one or more radar cross sections may be generated for different viewing angles that may correspond to a predefined set of angles (e.g., an angle in relation to a reference line towards the magnetic north) and/or FoVs and/or positions. These generated radar cross section may be matched (e.g., by a “matching service” or a “viewed object identification service” running in a core network) with a set of cross sections (for different viewpoints, sensor headings and/or FoVs) generated from a model (e.g., digital twin) of an object and/or a set of data for different viewpoints, sensor headings and/or FoVs (e.g. radar cross sections) and/or a set of mesh data of an object stored in an object database, whereby the data for the set of viewpoints, sensor headings and/or FoVs may be generated or stored according to a predefined set of positions (e.g., known location of a base station) or angles (e.g., an angle in relation to a reference line towards the magnetic north) and/or FoVs (e.g., different focal lengths). Such a model of an object or a set of stored data for different viewpoints, sensor headings and/or FoVs of an object may be associated with an identity (e.g., a UE identity such as Subscription Permanent Identifier (SUPI)). If a match is found between the data from sensor 12 of the first device 10 and a model or a set of viewpoints of an object, the resulting identities may be provided to an entity that uses these entities for additional action (e.g., another core network service such as AUSF or UDM using the identities for authentication and/or authorization purposes, or application function using the identities to e.g. obtain Metaverse assets).

In another alternative embodiment that may be combined with other embodiments or implemented independently, the measured or segmented data from sensor 12 of the first device 10 is used (e.g., by a network service (such as a sensing service or “viewed object identification service”) or second device 20 to which this data is transmitted) to determine a distance and/or angle between the first device 10 and an object in the field of view of sensor 12. Together with location information of the first device 10 (e.g., GNSS location data provided to the network (e.g., to a location management function from which other services such as a sensing or matching service may be able to obtain the location information) or the second device 20 by the first device itself or a location obtained by triangulation/trilateration of (sensing or position reference) signal measurements by the first device and/or one or more base stations or other devices) the location of objects in the field of view of sensor 12 may be determined. To this end, the network service or second device may receive location information of the first device 10 and the viewpoint, FoV and/or heading of sensor 12, and may obtain location information about one or more objects detected in the area through other means (e.g., based on sensing by the second device 20, or by UEs carried/encompassed by such objects for which the location is received or can be determined), and may use this obtained location information together with the received location information of the first device 10 and its FoV and/or heading to calculate the distance/angle between the location of the first device 10 and the one or more objects. Based on these calculations, the network service or second device can determine if these objects would be in the given FoV and/or heading of the first device 10 (i.e., based on the FoV information and/or heading information and possibly other information related to sensor 12 of the first device 10, such as viewpoint and/or sensing capabilities, as received from the first device 10). Furthermore, the network service or second device may use size information and/or material information and/or other target identification information that it may obtain or retrieve (e.g., from operating a sensing service or from an external application), to determine if one object may obscure another object and/or whether or not the object may only be partially observable given the viewpoint, heading and/or FoV of the first device 10, e.g. by performing raytracing). The determined location of the objects may then be matched with locations of objects and/or UEs in the area, e.g. in vicinity of the first device 10 for example UEs registered to the same gNB or within a (preconfigured) maximum distance, and based on location match the respective objects and/or UEs may be identified and the related identities may be provided to an entity that uses these entities for additional action (e.g. send information (such as location and/or angle/distance from the first device or reference point, identity information, whether or not a target object carries/encompasses a UE, metadata to describe the object, size of the object, whether or not it may be obscured by another object or only partially observable) about these objects to the first device 10, which may use this to retrieve data about these objects to a metaverse service (e.g. for overlaying/rendering of data about these objects on the rendering device), or which may use this set up a connection to one or more of these targets (if these targets carry or encompass UEs), or which may use this to initiate/continue sensing of these objects). The locations of objects and/or UEs in the area may be obtained in similar way as the location information of the first device (e.g., based on GNSS location data, through by triangulation/trilateration, etc.).

For this use case (metaverse or MR), deployed algorithms of the above embodiments of FIGS. 1 to 7 may be configured as follows:
The X-to-Mesh algorithm 32 may consist of e.g. a pre-trained neural network which maps a 3D mesh onto human poses in the measured data D_{MB} and outputs a set of time-varying mesh data.
The Mesh-to-Y algorithm 34 may be configured to generate the synthetic data D_{S} which emulates a radar cross section of the viewed user. More specifically, viewpoints may be synthesized which correspond to a predicted view of the viewed user by the sensor 22 of the second device 20, guided by the corresponding sensor parameters (properties) and the location of the viewed user.

Additionally or alternatively, the viewpoints (e.g., radar cross sections) may be synthesized based on measurements of objects by sensor 22 of the second device 20 or from a model of an object and/or set of viewpoints of an object and/or a set of mesh points of an object that may be stored and retrieved from an object database (e.g., user database which associates UEs with a set of models, mesh data or viewpoints representing the UE device or a user of the UE device or object carrying/encompassing such device) to corresponds with a predicted view of the user by sensor 12 of the first device 10.

Optionally, additional UE devices (e.g., UEs) associated with any viewed objects may be provided. This may be relevant in case a viewed user has a UE and is participating in the metaverse or MR service. The additional device(s) may be functionally identical to the first device 10. The location of the additional device(s) may be determined by the LMF 320 or by an ISAC service (e.g., based on sensing data from one or more base stations). This location is assumed to be practically identical to the location of the viewed user.

Furthermore, an additional database may be provided, which stores the segmented measured data D_{MBS} of the second device 20 for all viewed users and their associated user IDs.

Moreover, an additional algorithm (e.g., ID assignment algorithm) may be provided, which assigns user IDs to the segmented measured data D_{MBS} in the user database. For viewed objects with UEs, this may utilize the location of the additional device and the user location as determined by the sensing sensor 22 of the second device 20 to assign a given segmented measured data D_{MBS} to a user ID. For viewed objects without UEs, a temporary user ID may be assigned.

The user database may be updated when multiple users interact with the respective metaverse or MR services, e.g., in a single physical area.

The sensor 22 of the second device 20 (continuously) collects measured data D_{MB} and the segmentation algorithm 40 runs on the measured data D_{MB} to cluster the measured time-varying reflections and output the segmented measured data D_{MBS} where each segment is therefore indicative of an individual object's body motion. This data may be stored in the user database.

For each identified object in the segmented measured data D_{MBs}, the sensor 22 of the second device 20 is used to attain a range and angle measurement of that object and therefore also output the object location of each object. This is also stored in the user database.

The ID assignment algorithm may then assign a user ID to all segmented measured data D_{MBS} in the user database. This may be followed by the steps of providing the locations of all first and additional devices in the area by the LMF 320, comparing user locations to device locations by the ID assignment algorithm, requesting to provide a user ID for device locations that are similar within an acceptable level of error, assigning this user ID to the segmented measured data D_{MBS} and the user location and storing it in the user database. For user locations which have no corresponding device locations (i.e., that user has no UE), a temporary user ID may be generated and assigned to the associated segmented measured data D_{MBS} and stored in the user database.

Objects (e.g., users) may be identified as follows:
When a (new) object enters the field of view of another user, the viewed object is initially unknown to the first device 10 of the viewing user. The sensor 12 of the first device 10 records measured data D_{MA} of the viewed object and transmits it to the synthetic data algorithms 30 that might be provided, e.g., locally at the first device 10 or in an edge server or in the second device 20 or in the core network 300, etc.

The following procedures may be deployed by the synthetic data algorithms 30:
The X-to-Mesh algorithm 32 generates time-varying mesh data of the viewed object based on the measured data D_{MA} .
The Mesh-to-Y Algorithm 34 uses the mesh data to generate synthetic data D_{S} of the same data type of the sensor 22 of the second device 20, which emulates a measurement of the viewed object from the perspective of sensor 22 of the second device 20. In case the sensor 22 of the second device 20 is of a radar data type, synthetic data D_{S} which emulates a measurement of the viewed object's radar cross section is generated. The procedure of this algorithm 34 method may comprise generating synthetic viewpoint at a position, angle and FoV with respect to the mesh data in a virtual scene, such that it mirrors the position, heading and FoV of the sensor 22 of the second device 20 with respect to the object position of the viewed object in the real world.

As mentioned earlier, the synthetic set of data for a viewpoint, sensor heading and/or FoV (e.g., synthetically generated radar cross section) may be generated from the data of sensor 12 of the first device 10 for different viewing angles, positions and/or FoVs that may correspond to a predefined set of angles, positions and/or FoVs. The synthetic sets of data for a viewpoint, sensor heading and/or FoV may be such that one or more of these sets of data may match with a synthetic set of data for a viewpoint, sensor heading and/or FoV generated from a model of an object and/or a set of data for a viewpoint, sensor heading and/or FoV of an object and/or a set of mesh data of an object stored in an object database, whereby the data for the set of viewpoints, sensor headings and/or FoVs may be generated or stored according to a predefined set of positions (e.g., location of one or more gNBs), angles (e.g., one or more angles in relation to a reference line towards the magnetic north) or FoVs (e.g. from narrow focus to wide angle view).

Given the synthetic viewpoint and the mesh data of the viewed object, the radar cross-section of each vertex of the mesh data can be calculated for a virtual radar sensor at the position of the virtual viewpoint, whereby the virtual radar sensor may have a (predetermined) sensor heading and/or a FoV. This may be done by computing the radial velocity of each vertex of the mesh data with respect to a sensor at the synthetic viewpoint. The mesh data vertices which are occluded by other objects (e.g., body parts) with respect to the synthetic viewpoint or which are outside the FoV (given a (pre-defined) sensor heading and/or FoV for the virtual radar sensor) are filtered out, such that they do not contribute to the final radar synthetic data D_{S} . An initial coarse synthetic radial velocity profile may then be generated from the radial velocities of the remaining vertices. A pre-trained encoder-decoder model may then be run on the initial radial velocity profile to generate the final radar synthetic data D_{S} . The encoder-decoder model may be pre-trained on corresponding pairs of real-world and synthetic radar data.

The matching algorithm 50 of FIG. 4 may run through the most up-to-date instances of segmented measured data D_{MBS} and may compare the real doppler radar measurements in each segment to the generated synthetic data D_{S} to identify a match. The real doppler radar measurements may be measured real-time or may be stored in a database, e.g., a database containing user related information used for user identification/authentication. A positive matching outcome may be outputted when the virtual and real doppler radar datasets have a similarity that exceeds a predetermined numerical threshold. A matching confidence may be calculated e.g. based on the average size of the differences between the datasets.

In the case of a positive matching outcome, the user ID associated with the matching segment may be returned to the first device 10 which can now identify the user via the user ID and use the user ID to request additional data (such as instructions for rendering digital assets) from the metaverse or MR service provider.

Alternatively, the second device 20 (or another entity in the wireless network may retrieve additional data from the metaverse or MR service provider on behalf of the first device 10 and may provide the additional data to the first device 10.

As an optional measure, IDs may be assigned to users without devices. This may be achieved by viewing a user or by a pre-registered identification. In the first case, in case where a temporary user ID has been assigned to an unknown user, the corresponding user location of this unknown user may be transmitted to nearby devices with a request for a real user ID. Either through direct user input or by an automated service provided by the metaverse or MR Service provider (e.g., a facial recognition algorithm), the real user ID of the unknown user may be provided to the ID assignment algorithm which may then update the user database with the real user ID. In the latter case of a pre-registered identification, the wireless network may have in some cases access to a database of existing data which may serve as biometric identifiers of particular users, e.g., mmWave radar cross-section data, gait data, of the given unknown user or a set of (other) matching criteria, with an associated real user ID. In such cases, the segmented measured data D_{MBS} of the second device 20 may be compared to the data in this database to match the unknown user to the biometric data, and therefore assign a real user ID.

In another embodiment that can be combined with any other embodiment or implemented independently, the first device 10 may be capable of determining a FoV and/or a heading (e.g., based on user input or through a gyroscope or other orientation sensor or through using ranging/sidelink positioning (which may include calculating or receiving information about distances/angles to nearby objects carrying/encompassing UEs) in which one or more objects are known/determined/expected/assumed to be in. The first device 10 may transmit information about the FoV and/or a heading to a second device 20 or a “viewed object identification service” or other sensing service. Based on location information of the first device 10 (e.g., GNSS location data provided to the network or the second device 20 by the first device itself or a location obtained by triangulation/trilateration of (sensing or position reference) signal measurements by the first device and/or one or more base stations or other devices) and location information about one or more objects detected in the area (e.g. within a (pre-configured) maximum distance from the first device 10) through other means (e.g., based on sensing by the second device 20, or by UEs carried/encompassed by such objects for which the location is received or can be determined) the distance/angle between the location of the first device 10 and a set of objects can be calculated, and based on these calculations it can be determined (e.g., by the “viewed object identification service”) if these objects would be in the given FoV and/or heading (i.e., based on the FoV information and/or heading information (and possibly other information related to a sensor 12 that the device may optionally have, such as viewpoint and/or sensing capabilities)as received from the first device 10). Furthermore, it may use size information and/or material information and/or other target identification information that it may obtain or retrieve (e.g., from operating a sensing service or from an external application), to determine if one object may obscure another object and/or whether or not the object may only be partially observable given the viewpoint, heading and/or FoV of the first device (e.g., by performing raytracing). Based on the outcome of these calculations, the respective objects and/or UEs in the given FoV may be identified and the related identities may be provided to an entity that uses these entities for additional action (e.g., send information (such as location and/or angle/distance from the first device or reference point, identity information, whether or not a target object carries/encompasses a UE, metadata to describe the object, size of the object, whether or not it may be obscured by another object or only partially observable) about these objects to the first device 10, which may use this to retrieve data about these objects to a metaverse service (e.g. for overlaying/rendering of data about these objects on the rendering device), or which may use this set up a connection to one or more of these targets (if these targets carry or encompass UEs), or which may use this to initiate/continue sensing of these objects). The locations of objects and/or UEs in the area may be obtained in similar way as the location information of the first device (e.g., based on GNSS location data, through by triangulation/trilateration, etc.).

In other words, a first device may be adapted to communicate in a wireless network and may be adapted to determine information about its location and a FoV and/or a heading and may transmit information about its location and a FoV and/or a heading to a service or second device in the wireless network, the service or second device adapted to receive this information from the first device and further adapted to obtain location information and/or target identification information about one or more objects detected nearby and/or within a maximum distance from the first device, and to calculate based on the received information from the first device and the obtained location information and/or target identification information about one or more objects, whether or not an object is in the FoV and/or heading of the first device. The first device may be adapted to receive information about a set of objects in the given FoV and/or heading (i.e. as transmitted by the first device to the service or second device in the wireless network), and may be further adapted to obtain additional information about these object or set up a connection to these objects based on the received information.

This can be useful for deployments where the first device may have limited or no sensing capabilities to sense nearby objects or may be deployed in a system/configuration where sensing capabilities to sense nearby objects are not used.

### Service Continuity

In the following, a use case related to service continuity is described, where a given UE or other terminal device (or an object (e.g., person) associated with a given UE or other terminal device) is crossing or moving between cells of two different base stations (e.g., gNBs) of a cellular network, service continuity for a sensing function between the cells may be ensured by enabling easy recognition that the object leaving a first cell is identical to (matches with) the object now entering the second cell.

This may also be used for general tracking of particular objects or UEs through cells, e.g. for tracking particular drones or cars of interest as they traverse an area.

In this use case, the first device (A) 10 and the second device (B) 20 of FIG. 3 may both be base stations (e.g., gNBs). The sensor 12 of the first device 10 and the sensor 22 of the second device 20 may be a radar sensor, which may include at least one of dedicated radar sensors placed on the base station, communications components used in dedicated sensing mode (e.g., ISAC), and a passive sensing option derived from normal communications signals.

Furthermore, an additional device may be provided, which may be any terminal device (e.g., UE) such as a smartphone, wearable device, vehicle, drone, etc. The additional device may have an allocated unique identifier (device ID) which might be a UE-related ID or a unique identifier assigned by the wireless system, e.g., the access network 200. At any given moment, the additional device has an associated location (device Location) and a recognisable radar cross-section (device cross-section). In case the additional device is a hand-held or wearable device (such as a smartphone) its cross section may be the radar cross section of the device itself and/or the user carrying the device.

The measured data DAM collected at the first device 10 and the measured data D_{MB} collected at the second device 20 may both be measurements of the device cross section of the additional device and/or its user.

In this use case, the input data and output data of the synthetic data algorithm 30 may be of the same data type, e.g., doppler radar measurements. Here, the synthetic data algorithm may be configured to perform a view synthesis operation using the measured data D_{MA} of the first device 10 to generate synthetic data D_{S} which represents the device cross section of the additional device and/or its user from the perspective of the second device 20.

Furthermore, an additional database (device database) may be provided for storing device IDs and device locations of additional devices that pass through the sensing range of the first device 10.

Moreover, an additional algorithm (handover algorithm) may be provided, which may be configured to trigger the collection of the measured data D_{MA} of the first device 10 and the generation of the synthetic data D_{S} .

In the following, an exemplary procedure for this use case is described.

An additional device is detected in the cell of the first device 10 but is about to leave the cell, the handover algorithm triggers the sensor 12 of the first device 10 to complete a doppler radar measurement of the additional device, measuring the device cross section.

Then, the synthetic data algorithm 30 generates the synthetic data D_{S} by first using the measured data D_{MA} to generate a point cloud or other 3D data representing the additional device. Techniques to accomplish this may rely on pre-trained deep learning networks to construct point cloud data. Then, the generated point cloud data is used to generate a synthetic device cross section from the perspective (viewpoint) of the sensor 22 of the second device 20. This may be accomplished by using the 3D data to reconstruct a radar cross section of an object from a specific viewpoint, sensor heading and/or FoV. This constructed cross-section is output as the synthetic data D_{S} and may be transmitted from the first device 10 to the second device 20 or from an entity (e.g., in the radio access network or core network) operating the synthetic data algorithm before the additional device leaves the cell of the first device 10, together with the associated device ID.

Upon or before receipt of the synthetic data D_{S} or independently thereof, the second device 20 collects the measured data D_{MB} via its sensor 22 that images the device cross section of the additional device. This measured data D_{MB} and the synthetic data D_{S} may be passed to the matching algorithm 50 which compares the measured data D_{MB} to the generated synthetic data D_{S} to output a positive or negative matching outcome. A positive matching outcome may be outputted when the virtual and real doppler radar datasets have a similarity that exceeds a numerical threshold. Additionally, a matching confidence may be calculated based on the average size of the differences between the datasets. In the case of a positive matching outcome, the second device 20 may (immediately) associate the additional device with its device ID and may inherit any settings or other data related to the additional device from the first device 10.

A similar use case for inter-cell tracking may be enabled. In this case, non-communicating objects (such as vehicles, people without devices, any drones not connected to the network, etc.) may be traced as they travel between cells of a cellular network.

Such a non-communicating object may be sensed while in an initial cell and a device ID may be generated for it and stored in a database. Synthetic data D_{S} of the non-communicating object may be generated for surrounding base stations (e.g., gNBs), such that they can efficiently identify it as soon as it enters their cell. This can then be repeated when the non-communicating object leaves that cell for the next cell, and so on. In this manner, the non-communicating object can be traced as it travels through the cells of the cellular network without having to communicate with the cellular network at all.

It is noted that the procedures of the above use cases may as well be modified to apply the matching process of the third and fourth embodiments described in connection with FIGS. 4 and 5, where both measured data D_{MA}, D_{MB} of the first and second device 10, 20 are converted to synthetic data sets which are then compared by the matching algorithm 50.

The following figures and embodiments provide additional details on how these mechanisms can be used to enable service continuity.

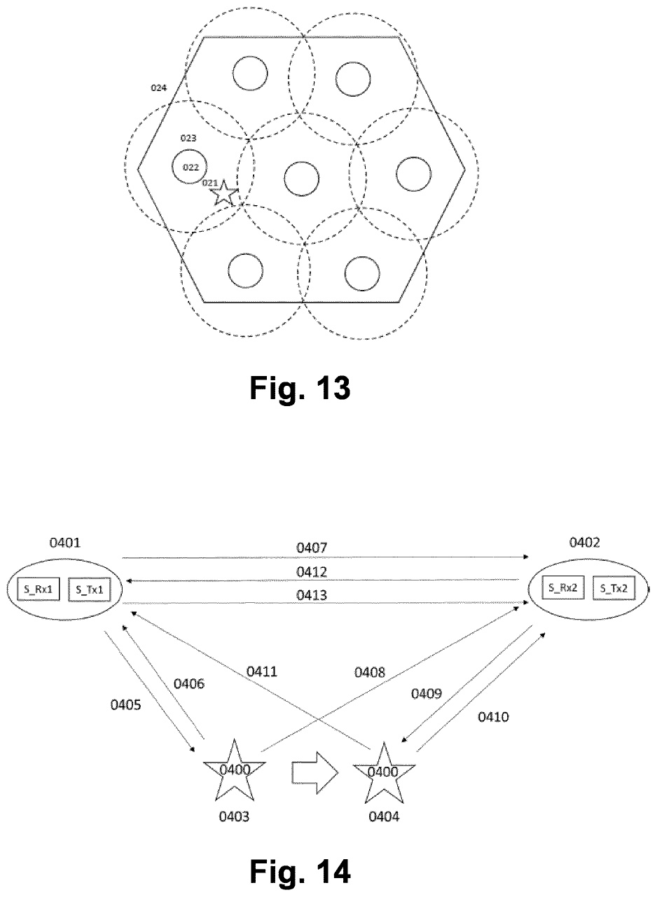

FIG. 13 schematically shows an architecture of a wireless network with overlapping sensing structure in which the invention can be implemented.

As explained above, wireless sensing may require that a single wireless device is capable of sensing a target when the target is within the sensing range of the single wireless device, and may require means to allow multiple wireless access devices to work together to sense a target in a Region of Interest (ROI), such as a city or a building. This is illustrated by means of FIG. 5 which shows an ROI in the form of a hexagon 024. An ROI can be defined as a location or area or volume in which a target is to be sensed/detected (i.e., a target location or area or volume or FoV) or in which the sensing is performed (i.e., a sensing location or area or volume or FoV) can be defined as a region of interest (ROI). The target 021 can move anywhere in the ROI. Multiple wireless sensing devices with overlapping sensing areas are used for sensing/tracking/monitoring the target, each of those wireless sensing devices with a sensing area smaller than the ROI. For instance, wireless sensing device 022 has a sensing area 023. Similarly, a device 10 with sensor 12 or device 20 with sensor 22 may have a certain FoV that is smaller than the ROI.

FIG. 14 schematically indicates a sensing mobility procedure. This sensing mobility procedure can be required in use cases where the sensing infrastructure is distributed, e.g., implemented by multiple sensing devices, e.g., 0401 and 0402 in FIG. 14, each device with a given sensing range or area. Sensing device 0401 and 0402 may correspond to the first device 10 having a sensor 12 and second device 20 having a sensor 22 as described in earlier embodiments, each with a different FoV.

The first sensing device 0401 may include a first sensing receiver S_Rx1 and a first sensing transmitter S_Tx1 or a different sensing modality such as sensor 12 in case of the first device 10 as described in earlier embodiment. The second sensing device 0402 may include a second sensing receiver S_Rx2 and a second sensing transmitter S_Tx2 or a different sensing modality such as sensor 12 in case of the first device 10 as described in earlier embodiment. The sensing infrastructure covers an overall area (ROI), usually larger than the sensing area of a single sensing device as shown in FIG. 13. The sensing devices 0401 and 0402 need to coordinate to sense targets that move through the overall sensing area. For instance, such a sensing infrastructure may be based on base stations in charge of keeping track of and sense cars, UAVs, people, etc.

In FIG. 14, the first sensing device 0401 and the second sensing device 0402 cooperate to keep track of a target 0400 moving from a first target location 0403 towards a second target location 0404. In this mobility procedure, the first and second sensing devices 0401 and 0402 have a limited sensing range or FoV and it is desired to keep track of the moving target 0400, e.g., a car, a UAV, a person, etc. The first and second sensing devices 0401 and 0402 may use multiple sensing technologies as described above. For instance, the first sensing device 0401 may send a sensing signal 0405 towards the target 0400 at the first target location 0403 and receive a message/signal 0406 that may be, e.g., (i) a message containing a set of CSI measurements collected by the target 0400 at the first location 0403 and/or (ii) a reflected component of the (radar) sensing signal 0405. In either case, the message/signal 0406 allows the first sensing device 0401 to determine certain aspects (such as position, speed, acceleration, beam alignment, heart rate, etc.) of the target 0400 at the first location 0403. Similarly, if the first sensing device 0401 uses other sensing modalities. The first sensing device 0401 may determine that the target 0400 is moving away from its sensing area by monitoring certain aspects (e.g., signal strength, frequency shift, or measurements carried out by the target and included in the received signal 0406). If this event happens, the first sensing device 0401 informs the second sensing device 0402 of the approaching target 0400. Indeed, the first sensing device can look up in a list of neighboring sensing devices which one(s) is (are) most likely to become the sensing devices closest to the target (device) 0400 and initiate a handover on this basis.

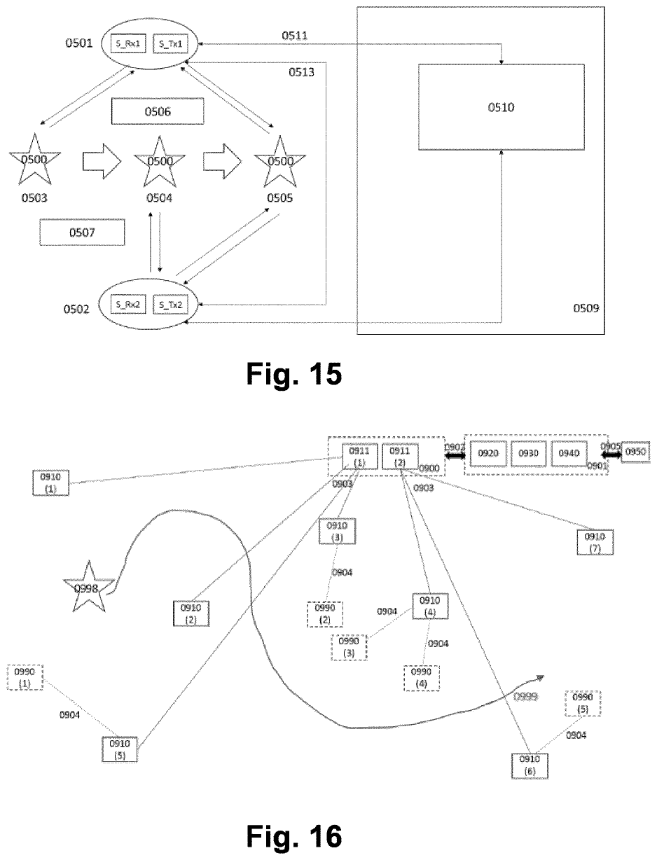

The first sensing device 0401 may know which sensing device to inform based on, e.g., the second procedure described below in the context of FIG. 15, or a predetermined map of the sensing devices, or based on other embodiments in this application. Then, the first sensing device 0401 informs the second sensing device 0402 by sending a message 0407 to the second sensing device 0402, e.g., a base station, e.g., through a communication interface, e.g., the Xn interface, with the identity of the target 0400 and/or its current location (e.g., the first location 0403) and/or other parameter related to the target (e.g. a monitored state of the target) and/or measured or segmented data from sensor 12 or a calculated set of data for a viewpoint, sensor heading and/or FoV (e.g., radar cross section) or resulting information about detected objects or FoV information (and possibly other information related to sensor 12, such as viewpoint and/or sensing heading and/or sensing capabilities). Note that the second sensing device 0402 may also be a UE and in this case the messages may be, e.g., RRC messages exchanged over the Uu interface. Note that the first and the second sensing devices may also both be UEs and in this case the messages may be exchanged over the PC5 interface. The first sensing device 0401 can know which sensing device to inform, e.g., if the sensing devices know the location or the sensing area or FoV of surrounding sensing devices. Note, that the first sensing device 0401 may also inform other sensing devices, e.g., proactively or based on a policy. The second sensing device 0402, upon reception of message 0407 may initiate sensing of the target. For example, it may proceed to send (a) sensing signal(s) 0409. The second sensing device 0402 may also monitor whether it detects the sensing signal 0408 coming from the first sensing device 0401 reflected at the target 0400 at location 0403. The second sensing device 0402 may discern whether this signal 0408 comes from the target 0400 if the first sensing device 0401 uses a specific sensing signal, e.g., including an identifier identifying the sensing signal or using any signal that may be identifiable at least within the area, e.g., using a very specific radar signals, e.g., a very specific chirp timing/frequency. This identity of the sensing signal (and/or signal characteristics of the sensing signal and/or other information relevant for sensing, such as sensing measurements received thus far, sensing results, predicted/estimated trajectory/speed/direction of the intended target, target application ID/URL, identity of core network functions (e.g. sensing service) involved, identity or location of the first sensing device, information about surrounding sensor/receiver devices that may be involved in the measurements (e.g. their location), synchronization information, a set of target identification information (e.g. matching criteria for a target), or a sensing session identifier) from the first sensing device 0401 may be communicated to the second sensing device 0402 in message 0407. The second sensing device 0402 may also use measured or segmented data from sensor 12 or a calculated set of data for a viewpoint, sensor heading and/or FoV (e.g., radar cross section) or resulting information about detected objects or FoV information (and possibly other information related to sensor 12, such as viewpoint and/or sensing heading and/or sensing capabilities) received from the first sensing device 0401 to match its sensing output of sensor 22 with the received information, possibly compensated for the different FoV, as described in other embodiments of this disclosure. Note that the location of a target and of the first sensing device may be specified as an absolute position (e.g. geographical coordinates) or relative position (e.g. distance/angle from the receiver or other reference device or reference coordinate) or as an area/volume (e.g. an area/volume in which the target is expected to reside or in which it appears to be with minor fluctuations, e.g. due to measurement errors or signal variations), possibly formatted as a set of Universal Geographical Area Description (GAD) shapes (as specified in 3GPP TS 23.032). Upon reception of the signal 0408, the second sensing device 0402 may initiate sensing of the target. For example, it may start transmitting its own sensing signal 0409 that may also be identifiable, e.g., by embedding an identifier or any other means. The second sensing device 0402 may then receive a signal 0410, e.g., a reflected component of the sensing signal 0409 or any other information, that allows the second sensing device 0402 to sense/monitor/keep track of the target 0400. The second sensing device 0402 may use the information (i.e., parameters) that it has received (from the first sensing device 0401) about the target (e.g. the latest value of a monitored state of target 0400, or a set of target identification information) to identify target 0400 in its sensing data and/or verify if a detected object matches the target 0400 (e.g., by verifying if the sensing results correspond to the received information about the target within a (pre-)configured margin of error). The second sensing device 0402 may also use measured or segmented data from sensor 12 or a calculated set of data for a viewpoint, sensor heading and/or FoV (e.g., radar cross section) or resulting information about detected objects or FoV information (and possibly other information related to sensor 12, such as viewpoint and/or sensing heading and/or sensing capabilities) received from the first sensing device 0401 to match its sensing output of sensor 22 with the received information, possibly compensated for the different FoV, as described in other embodiments of this disclosure. Since the sensing measurements of target 0400 by the second sensing device 0402 may be initiated after a certain delay, the first sensing device 0401 may include a timestamp in the message or in the information inside the message about target 0400 (e.g., an absolute or relative time at which the value of a monitored state was determined before it was transmitted to the second sensing device 0402). The second sensing device 0402 may calculate the delay between such timestamp (or the time at which it received the message if no timestamp is included) and the time it initiated sensing of target 0400 or time it calculates (or has calculated) the first sensing results about target 0400. This delay may be used to compensate for the transitions/differences that may have occurred during that time in the sensing of target 0400. For example, if the target was moving at a certain speed in a certain direction, the location of the target 0400 determined by the second sensing device 0402 can be expected to be shifted. The second sensing device 0402 may estimate/predict (e.g., through extrapolation) a new position of the target or a value of a monitored state of the target by using the time delay, and may use the expected difference in position or state in the identification, matching or verification of target 0400 using the information received about the target 0400 from the first sensing device 0401. Alternatively or additionally, the time delay may be used to estimate/predict a new position of a target 0400 and use this new position for beamforming to the target 0400 or for sensing the target 0400 (e.g. change the FoV or other parameters of e.g. sensor 12 or sensor 22). At this point, the second sensing device 0402 may communicate to the first sensing device 0401 by means of message 0412 that it has sensed the target 0400, e.g., at the second target location 0404. The message may include the identity of the sensing signal 0409 used by the second sensing device 0402 as well as information regarding the sensing quality. Sensing quality may refer to, e.g., location accuracy, speed accuracy, target frequency (e.g., breathing, heart rate, in the case of a person), signal strength of the received signal, etc. The first sensing device 0401 may measure at this point a sensing signal 0411 coming from the second sensing device (e.g., a component of the sensing signal 0409 reflected at the target 0400 at the second location 0404 or a set of measurements by the target 0400 on signal 0409 that are sent to 0401). The first sensing device 0401 may release the tracking of the target 0400 and inform the second sensing device 0402 by means of a message 0413 that it is stopping the tracking. Alternatively, the first sensing device 0401 may stop tracking after sending message 0407. In particular, the first sensing device 0401 may stop tracking once it has sensed/received signal/message 0411. Alternatively, the first sensing device 0401 may have included already in message 0407 the condition for releasing the sensing, e.g., when the second sensing device 0402 achieves a given sensing quality on the target, or a time when the first sensing device 0401 will stop sensing of the target. When the second sensing device 0402 achieves this target sensing quality or other condition is fulfilled (e.g., a timer expiring), or when the second sensing device 0402 has initiated transmission of sensing signals or when the second sensing device 0402 has successfully received signal 0410, signal 0408 or message 0407, the second sensing device 0402 may inform the first sensing device 0401 about this in message 0412. In this case, the first sensing device 0401 may not be required to send message 0413.

In another variant, the first sensing device 0401 may stop tracking the target (device) 0400 a predetermined time after the initiation of the handover, thus not requiring extra signaling from the second sensing device 0402. Optionally, this predetermined time may be based on an estimate of the speed of the target 0400 or a signal quality change rate. It is also possible to keep the monitoring as long as the first sensing device 0401 is able to detect the target (device) 0400, reducing thus the probability of losing the tracking. However, because of the low quality of the sensing at the end of the handover (when the target 0400 is getting far from the first sensing device 0401), it is possible to discard or at least weigh down the measurements to keep the estimate accurate.

In accordance with another embodiment, a cooperative sensing procedure is described in FIG. 15. In this procedure, at least two sensing devices 0501 and 0502, e.g., two base stations or two UEs or a base station and a UE, are involved in the wireless sensing of a target 0500, e.g., a moving target, e.g., a car, a vehicle mounted relay, a UAV, or a person, that moves from a first location 0503 to a second location 0504 and then to a third location 0505. Sensing device 0501 and 0502 may correspond to the first device 10 having a sensor 12 and second device 20 having a sensor 22 as described in earlier embodiments, each with a different FoV. A cooperative sensing procedure may be important because a single sensing device may not have line of sight (LoS) with the target 0500 always, e.g., obstacles such as buildings may obstruct the LoS. For instance, in FIG. 15, a first obstacle 0507 blocks the LoS between the second sensing device 0502 and the target 0500 at the first location 0503. For instance, in FIG. 15, a second obstacle 0506 blocks the LoS between the first sensing device 0501 and the target 0500 at the second location 0504. To address this situation, the sensing system involves several procedures:
A first procedure that can be combined with other embodiments refers to a procedure that allows a sensing device to create and maintain its map of its sensing area or sensing volume. This procedure may be triggered by the sensing device itself, the sensing function (SF) 0510 in the core network 0509, or an external AF through the NEF. The sensing area is defined as the area around the sensing device that can be sensed by the sensing device. The sensing volume is defined as the volume around the sensing device that can be sensed by the sensing device. The sensing area or volume is determined by the sensing range (how far the sensing device can sense assuming free space) of the sensing device and the obstacles (e.g., fixed obstacles) in its environment that may limit the sensing of the sensing device. The creation of this map can be done, e.g., by configuring the sensing device or SF with a map based on the known environment (e.g., buildings in a city) and location of the sensing device (e.g., gNB). This map can be retrieved, e.g., from an external application, through the NEF. This map can be created by actively sensing the environment, e.g., by beaming a sensing signal around the sensing device, and storing, e.g., in a data base co-located with the sensing device or in the SF 0510 in the core network 0509, the locations of obstacles around the sensing device and determining the sensing area or sensing volume of the sensing device. This procedure can be repeated in a periodic manner to adapt the map according to seasonal changes (e.g., vegetation). The map should also be weather dependent (e.g., rain).
A second procedure that can be combined with other embodiments refers to a procedure for the configuration of cooperative sensing devices in a sensing device or the configuration of relationships between sensing devices in the SF 0510. In particular,
   The SF 0510 may retrieve the map obtained by a sensing device and store it in a data base. The SF 0510 may determine white spots triggering the deployment of additional sensing devices. The SF 0510 may determine the sensing neighbors for each sensing device.
   The first sensing device 0501 may be informed by the SF 0510 about the second sensing device 0502 that it can cooperate with in order to ensure wider/good sensing coverage. In particular, the SF 0510 may inform the first sensing device 0501 which sensing devices, e.g., the second sensing device 0502, can perform sensing at the limits of the sensing area or sensing volume of the first sensing device 0501. For instance, it can inform the first sensing device 0501 that the second sensing device 0502 can sense the target at the second location 0504.
   To avoid interferences during sensing, the sensing devices may (1) have been configured, e.g., by the core network 0509, e.g., the SF 0510, with suitable timing/frequency resources (e.g., sensing signals using different timing or frequencies or codes) over respective first and second interfaces 0511 and 0512 or (2) communicate to each other over a respective third interface 0513 the resources that they are currently using for sensing to avoid using the same resources, a situation that may lead to a decrease in the sensing accuracy during operation. In certain cases, the sensing devices may require a tight cooperative sensing procedure, e.g., by broadcasting the same sensing signal in a coordinated manner, e.g., with a small phase shift to create a directional beam. In this case, the core network 0509, e.g., the SF 0510, or a central unit of a gNB may coordinate the suitable parameters.
A third procedure refers to a cooperative sensing procedure in which at least two sensing devices cooperate to sense a target by simultaneously sensing the target and (i) informing each other about the sensed features (e.g., location) of the target or (ii) combining the received signals to obtain a more accurate sensed signal or (iii) combining the output from different sensors (e.g., sensor 12 and sensor 22) which may use different sensing modalities.
A fourth procedure that can be combined with other embodiments in this invention refers to a procedure in which a central entity, e.g., the SF 0510 in FIG. 15 or an application function, gathers the sensed information of one or multiple targets as collected by the sensing devices. The central entity is in charge of linking the sensed information to a given target independently of the sensing devices used to sense the target. In applications in which the target is not linked to a device UE, the central entity may allocate an identifier to the target (e.g., the central entity may allocate a new (e.g., randomly chosen) identifier when a new and/or distinct object has been detected, or may allocate an identifier that is associated with a set of target identification information (e.g., matching criteria for a target), or may allocate an identifier based on a target identifier provided by an application or may allocate an identifier based on a subscription identifier associated with the sensing service and/or the sensing of the target, or may allocate an identifier based on an identification of the sensing session). This identifier may have also been allocated, e.g., initially, by a sensing device. This identifier may be a temporal identifier. This identifier may also be updated in a regular basis or when a given sensing device starts sensing the target, e.g., after a sensing handover procedure. This identifier may be linked to a subscriber identifier, e.g., the Subscription Permanent Identifier, once the managing (i.e. central) entity has identified the target In case the target is linked to a device UE (e.g., the target carries or encompasses a UE), the identity (or pseudonym linked to that identity) of the respective device UE (e.g., the Subscription Permanent Identifier (SUPI) related to that device UE) may be used as identifier of the target. For instance, a sensing identifier might be created that is linked to the SUPI of the UE and the binding is stored in a data base in the telecommunication system, e.g., in the UDM, AUSF, etc.
A fifth procedure that can be combined with other embodiments refers to a procedure in which a central entity, e.g., the SF 0501 of FIG. 15 or an application function, gathers the sensed information of one or multiple targets as collected by the sensing devices. The central entity is in charge of combining the sensed information from one or multiple targets. In particular, this means that sensing devices may send all sensed information of targets, e.g., location, speed, vital signs, etc. to the SF or another managing (i.e. central) entity. The managing entity is then in charge of keeping track of a target when it moves across the sensing boundaries of different sensing devices.

For instance, in FIG. 15, the first sensing device 0501 senses the target 0500 at the first location 0503. When the target 0500 moves towards the second location 0504 that is not in the sensing area of the first sensing device 0501 due to the second obstacle 0506, the first sensing device 0501 informs the second sensing device 0502 by means of a message over the third interface 0513 (e.g., an Xn interface when the first and second sensing devices 0501 and 0502 are base stations or an Uu interface when the first and second sensing devices 0501 and 0502 are a base station and a UE or a PC5 interface when the first and second sensing devices 0501 and 0502 are two UEs) ensuring that the second sensing device 0502 is ready to start sensing the target 0500. The first sensing device 0501 may know which sensing device to inform by looking up a neighbor table that has been configured in the first sensing device 0501 in the context of the second procedure. Additionally, or alternatively, a network function, e.g., the SF, 0510, in the core network 0509 or an application function may inform/request the second sensing device 0502 about the need to start sensing the target 0500 when the target is about to move out of the sensing coverage area/volume or FoV of the first sensing device 0501.

It is worth noting that a (conditional) sensing handover procedure as described in the above embodiment and in FIG. 14 may not be feasible due to the presence of the first and second obstacles 0507 and 0506 that avoid smooth transition (in other words, the first sensing device 0501 may not observe a slow decrease in, e.g., the signal strength of the sensing signal from the target 0500, but this decrease may be abrupt); thus, the first sensing device 0501 needs to make aware the second sensing device 0502 well in advance of the upcoming target 0500 to ensure a proper sensing coverage. Similarly, even if the target (UE) 0500 can measure the reference sensing signals of other sensing devices, it may be that at the first location 0503 the first sensing device 0501 is the preferred option and it is only when the target 0500 moves to the second location 0504 that the measurements of the sensing signals by the target (UE) 0500 indicate the need of a sensing handover or triggers the initiation of cooperative sensing.

As described for FIG. 14, sensing handover may be triggered by the network, e.g., when a first sensing device (e.g., base station) detects that it cannot sense well a target (e.g., it moves out of its coverage area or it moves towards the coverage area of a second sensing device), the first sensing device informs a second sensing device. These conditions may be based on a local policy or based on a configuration by a central controller (e.g., a gNB-CU, or a sensing network function). Conditional sensing handover may be triggered by the target (which incorporates or carries a terminal device (e.g., UE)) based on conditions configured in the target (e.g., UE) which may have been configured by the network beforehand, as described for FIG. 14.

When the target 0500 moves towards the second location 0504 that is at the limit of the sensing area/volume/FoV of the first device or the first sensing device 0501 has detected an obstacle 0506 (e.g., due to a radar sweep of the area) or observes a sudden drop in receiving reflected sensing signals from target 0500, the first sensing device 0501 may inform the second sensing device 0502 by means of a second message over the third interface 0513, e.g., the Xn, Uu, or PC5 interface. Additionally/alternatively, the NF 0510 may also inform the second sensing device. This ensures that the second sensing device 0502 starts sensing as soon as possible. In case of conditional handover (e.g. whereby a terminal device carried/incorporated by the target 500 performs its own signal strength/quality measurements to determine if these reach below or above a certain threshold), the terminal device carried/incorporated by the target 500 may inform the second sensing device 0502 to start sensing of target 0500 as soon as it notices a drop in receiving sensing signals or other (reference) signals (e.g., PSS, SSS) from the first sensing device and/or may inform the second sensing device 0502 to start sensing of target 0500 as soon as it can measure sensing signals or other (reference) signals (e.g., PSS, SSS) from the second sensing device. Additionally or alternatively, the terminal device carried/incorporated may be configured by the network (e.g., SF or by the first sensing device) about obstacles and/or areas with limited or no coverage and/or with information that maps a set of location/area/volume information (e.g., as denoted by a set of coordinates or GAD shapes as defined in 3GPP TS 23.032 or zone IDs as defined in 3GPP TS 38.331) to one or more sensing devices (identified e.g. by its cell ID or sensing signal identifier) which it can request to initiate sensing of target 0500. The terminal device carried/incorporated by the target 500 may use this information as (additional) condition to trigger handover, i.e., if it detects that it is currently located (e.g., through built-in GNSS receiver to determine its location) in a particular location/area/volume, it can request handover to a sensing device indicated in the configured information. At the third location 0505, both the first and second sensing devices 0501, 0502 can simultaneously sense the target 0500 since the third location 0505 is in the sensing area of both sensing devices. To this end, the first sensing device 0501 may have continued sensing of target 0500 based on the target's trajectory and/or the determination of the size of obstacle 0506, or based on a pre-configured time after it has not been able to sense target 0500 anymore (e.g., a retry timer). The first sensing device 0501 may receive information from the second sensing device 0502 (or NF 0510) about the current location and/or trajectory of target 0500 and/or measured or segmented data from sensor 22 or a calculated set of data for a viewpoint, sensor heading and/or FoV (e.g., radar cross section) or resulting information about detected objects or FoV information (and possibly other information related to sensor 22, such as viewpoint and/or sensing heading and/or sensing capabilities) that the first sensing device 0501 may use to determine whether to continue or restart sensing of target 0500 (e.g. if a match according to different viewpoints can be made as described in other embodiments). In case of conditional handover, the terminal device carried/encompassed by the target may inform the first sensing device 0501 to initiate/continue sensing of target 0500 as soon as it can receive the sensing signals (or other signals) from the first sensing device 0501 again. Sensing measurements can be sent to the SF 0510 over the first and second interfaces 0511 and 0512 and the SF 0510 can combine the measurements to increase the sensing accuracy.

Communication systems such as 5G rely on mobility procedures such as hand-over and conditional handover procedures (TS 38.300) to provide service to UE when they move through the service area of a wireless communication network, in other words, to get a UE connected to the wireless communication network through multiple gNBs. A communication system can benefit of sensing capabilities to improve such mobility procedures.

For instance, in an embodiment regarding a handover procedure for a mobile device in a cellular network (as described in Section 9.2.3.2.1 in TS 38.300), the handover decision of the source gNB in step 2 may not only depend on measurement control and re-ports exchanged in step 1, but also on accurate sensed information of the UE similar to the embodiments described in the context of FIG. 14. In particular, message 3 “Handover request” in Section 9.2.3.2.1 in TS 38.300 may correspond to and be enhanced by means of message 0407 of FIG. 14 and message 4 “Handover request acknowledgment” in Section 9.2.3.2.1 in TS 38.300 may correspond to and be enhanced by means of message 0412 of FIG. 14.

In an additional particular embodiment, sensed information related to the accurate location (position, speed, . . . ) of the UE can improve mobility procedures in deployments such as depicted in FIG. 14 where a target 0500 (e.g., a UE) moves from the first location 0503 to the second location 0504. Additional information that may be sensed and exchanged with this purpose may include:
the shape or size of the target (device) may(e.g., a truck with a UE installed), or
information that the UE is carried on the body of a person, if this is detectable, or
information on which side of the body such UE is worn (e.g., which side is obstructed by the person) or
Its orientation.

While the reported measurements at the first location 0503 of FIG. 15 may usually not trigger a communication handover as per TS 38.300, the additional sensed information can help the first sensing device 0501 implementing the source gNB functionality to trigger the communication handover procedure towards the second sensing device 0502 implementing the target gNB functionality.

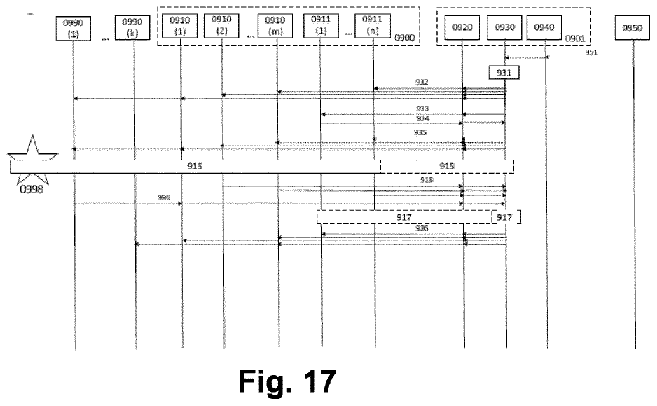

An additional embodiment for (centralized) sensing of a moving target, that can be combined with the other embodiments of this invention or can be implemented independently, is depicted in FIG. 16 in combination with FIG. 17. In this embodiment, a target 0998 is moving around in an area according to a trajectory 0999. The area is covered by a set of RAN entities (e.g., base stations, small cells, integrated access and backhaul (IAB) nodes, gNB-DU) 0910 (1 to m) that are capable of acting as a sensing device (i.e., as sensing transmitter and/or sensing receiver and/or first device 10 and/or second device 20). The RAN entities 0910 may operate under control of one or more RAN controllers (e.g., gNB-CU, RAN network control entity) 0911 (1 to n), whereby a RAN controller 0911 may be combined in a single device with a RAN entity 0910, and whereby the RAN entities 0910 or the RAN controllers 0911 are possibly operated/managed by multiple network operators. The RAN entities 0910 together with the RAN controllers 0911 constitute a RAN 0901. The RAN entities 0910 may communicate with the RAN controllers 0911 using a first interface 0903 (e.g., an F1 interface) and may also communicate with each other (not shown in FIG. 16) using e.g. an Xn interface. The RAN 0901 may communicate with a core network (CN) 0900 using a second interface 0902, in particular it may communicate with an AMF 0920 over e.g. a next generation (NG) interface (using the NG application protocol (NGAP)) and/or communicate directly with a Sensing Function (SF) 0930 that may be a service offered by the CN 0901 (e.g., using a tunneled control plane protocol or user plane protocol over the second interface 0902 or a different interface). The SF 0930 may also be deployed (not shown in FIG. 16) as a service in one of the RAN entities 0910 or the RAN controllers 0911 (e.g., as part of its Edge computing environment). The CN 0900 may further consist of a Network Exposure Function (NEF) 0940 to communicate with an Application Function (AF) 0950 using a third interface 0905 (e.g., a N33 interface). In addition to the RAN entities 0910 capable of wireless sensing, also a number of UEs 0990 (1 to k) with k>=0 may be capable of acting as a sensing device (i.e., sensing transmitter and/or sensing receiver), and may be present in the area as well. These UEs 0990 may be connected to one or more RAN entities 0910 using a fourth interface 0904 (e.g., a Uu interface), and may also communicate (not shown in FIG. 16) with each other e.g. using a PC5 interface. Note that the selection to which RAN entity 0910 a UE 0990 connects can be independent from the sensing operation. For example, a sensing signal transmitted by a first RAN entity 0910 (1) acting as a sensing transmitter may be received by a first UE 0990 (1) acting as a sensing receiver, whereby the first UE 0990 (1) may not be connected to the first RAN entity 0910 (1), but e.g. in case of FIG. 16 to a fifth RAN entity 0910 (5). The sensing measurement data of the first UE 0990 (1) acting as a sensing receiver may be received by the fifth RAN entity 0910 (5) to which it is connected, which may then forward the measurements to the respective sensing transmitter or to another destination (e.g., a central sensing service, or central repository e.g. in a CN or operated by a RAN controller), based on configuration/policy provided to the respective RAN entity by an SF (or other CN entity or RAN controller), or based on a destination provided by the UE.

An exemplary high-level procedure of how the target 0998 can be sensed whilst moving along its trajectory 0999 is shown in FIG. 17. Not all steps in FIG. 17 may always be required.

In a first step 931 the SF 0930 may determine a target sensing area/volume, e.g., as required for a given application and/or related to the area/volume that can be sensed by one or more sensing devices. This may be determined by, e.g., optionally receiving information 951 about the target sensing area/volume or a set of possible target locations or trajectory information provided by an AF 0950 via the NEF 0940 (i.e., using the third interface 0905). The AF 0950 may also provide other information, such as characteristics of target (e.g., size, shape, identity, speed) and/or expected sensing data (e.g., which sensing results/measurements it would like to receive about the target 0998 (e.g., location, size, sudden movements, regular displacement patterns) and/or the accuracy of the sensing results/measurements). Alternatively or additionally, the target sensing area/volume may be determined by estimating the location or receiving location information of the target 0998, e.g., from one or more RAN entities 0910 or UEs 0990, or e.g. from the target 0998 itself if the target 0998 encompasses a UE or a UE is carried by the target 0998 that may provide its location (e.g., through tracking area information provided during registration or for which the location may be obtained through a Location Management Function (LMF) using radio access technology (RAT)-dependent (e.g., time difference of arrival (TDOA)) or RAT-independent (e.g., global navigation satellite system (GNSS)) positioning and/or position information exchange. Alternatively or additionally, a target sensing area may be provided as part of the subscription information to a sensing service (e.g., stored in the UDM or Unified Data Repository (UDR)), which may be obtained by or provided to the SF 0930 when an application function or UE (e.g. upon registration) triggers activation of a sensing service. Based on a target location and/or target sensing area and/or trajectory information, the SF 0930 may determine a set of sensing devices for sensing of a target (i.e., sensing transmitters and/or sensing receivers and/or first devices 10 and/or second devices 20) that are currently present/located in the target sensing area or that together cover a target sensing area or that are in vicinity of the target 0998. This may include determining if sensors 12 of one or more first devices 10 or sensors 22 of one or more second devices 20 would be able to sense the target given their capabilities (such as FoV). This may be a subset of all known or registered sensing devices, e.g. the SF 0930 may not select some sensing device because they may be switched off or sleeping, or some may be too overloaded (e.g., with communication tasks) that they should not be selected as sensing transmitter or receiver or as first device 10 or second device 20, or some may have insufficient capabilities for the given sensing task (e.g., if the sensing task requires only mmWave devices to be involved or requires a minimum bandwidth or set of resources to achieve high accuracy). The SF 0930 may also determine a set of sensing devices in neighboring areas (e.g., if the target 0998 is near the edge of a target sensing area or coverage area of a previously selected set of sensing devices) that may need to get involved in sensing of a target.

The SF 0930 may instruct/configure the determined set of sensing devices to initiate or prepare for sensing of a target. This may be done by a set of messages 932 that may be sent/tunneled/forwarded via the AMF 0920 to a set of RAN entities 0910 and/or RAN controllers 0911 and/or UEs 0990 that are part of the determined set of sensing devices, whereby the messages destined for a UE 0990 may be forwarded or repackaged by a RAN entity 0910 to which the UE 0990 is connected. The messages 932 may include sensing signal timing/frequency configuration, target characteristics, such as last known/estimated location, size, shape, velocity, thresholds (e.g., which minimal signal quality required before sensing measurements are performed or transmitted for further processing, minimum/maximum distance from target), identity of a target, and/or the environment (e.g., other sensing devices involved).

The execution of the sensing procedure may also require collecting the user consent preferences. This may involve:
Sending a request to the UE asking the user for UC confirmation, and/or
Retrieving the UC preferences from the UDM/UDR, e.g., through the AUSF; and/or
Sharing the UC preferences with the serving network

And only performing the sensing operation if user consent is granted.

Alternatively or additionally, the SF 0930 may request the RAN 0900 (or other network function (e.g., LMF), not shown in FIG. 17) to determine a set of sensing devices for sensing of a target (i.e., sensing transmitters and/or sensing receivers and/or first devices 10 and/or second devices 20) that are currently present/located in the target sensing area or that together cover a target sensing area or that are in vicinity of the target 0998, or are in a neighboring area, and/or that meet certain criteria (e.g., required capabilities for sensing, such as mmWave, sufficient bandwidth and/or resources available for sensing), or for which the target is in its FoV of its sensor. To this end, the SF 0930 may send a message 933 to the RAN 0900 (e.g., to one or more of the RAN controllers 0911) (or other network function), which may include information about the target sensing area or target location information or trajectory information, and/or criteria/requirements/capabilities for sensing. The RAN 0900 (or other network function) may return e.g. in a message 934 the determined set of sensing devices to the SF 0930 for further configuration, or may itself instruct/configure the determined set of sensing devices to initiate or prepare for sensing of a target (e.g., by using information provided by the SF 0930 similar to the information provided in message 932 or pre-configured on the device).

In a next step 915 the determined sensing devices may initiate sensing of the target 0998. This may be based on previous instruction/configuration of the SF 0930 (or the RAN 0900), or the SF 0930 (or the RAN 0900) may send an explicit message 935 to the determined sensing devices to initiate the sensing. Step 915 involves transmitting sensing signals and receiving the sensing signals reflected by the target 0998 and/or sensing messages sent by a UE 0990 attached to/encompassed in the target 0998 and/or using sensor 12 of a first device 10 and/or using sensor 22 of a second device 20 to sense the target 0998, and/or performing the necessary measurements on the (reflected) sensing signals and/or processing the sensing messages containing the measurements made by the UE 0990. The sensing measurements and/or sensing results derived from these measurements may be transmitted by the sensing devices using messages 916/996 to the SF 0930 (or to a RAN entity 0910 or a RAN controller 0911 collecting sensing measurements and/or performing some sensing calculations, or to a central repository from which a sensing service can retrieve these measurements/results) for further processing. The sensing measurements/results may include for each sensing device (e.g. sensing receiver) the signal strength and/or quality of the reflected sensing signals (e.g., per sensing signal identifier or beam identifier) or a measure of accuracy of a sensing result for the respective target 0998 (e.g., location accuracy, accuracy of matching target characteristics) or a measure of signal noise/disturbances or timing of sensing signals, or measured or segmented data from sensor 12 or sensor 22, or a calculated set of data for a viewpoint, sensor heading and/or FoV (e.g. radar cross section) or FoV information (and possibly other information related to sensor 12 or sensor 22, such as viewpoint and/or sensing heading and/or sensing capabilities), or more specific results (such as a frequency (e.g., related to the heart rate of the target), or speed (e.g., related to the speed of a UAV/car target) or location (e.g., related to the location of a car target) or a set of detected objects or count (e.g., related to the number of persons in an area) or other application-related relevant results) and/or the SF 0930 (or the RAN 0900) may derive these quality and/or accuracy and/or noise and/or timing measures based on the received sensing measurements and/or results. Note that also sensing devices that may not receive sensing signals (or with very low quality) may send a sensing measurement report (e.g., indicating/showing no results, or showing signal strength zero for an expected sensing signal). Note that before the information is sent from the RAN 0900 or target 0990, the RAN entities may aggregate or process the measurements in a combined result report.

In a next step 917 the SF 0930 (or the RAN 0900 or by cooperation between the RAN 0900 and a network function (NF)) determines based on the received sensing measurements/results or segmented data from sensor 12 or sensor 22, or a calculated set of data for a viewpoint, sensor heading and/or FoV (e.g. radar cross section) which sensing devices were close to the target and/or performed good measurements of the target and/or which reflected sensing signals were received with good quality (e.g., their timing, characteristics or identifier, based on which the SF 0930 may determine (possibly by requesting/receiving information from the RAN 0900 and/or the RAN controllers 0911 or the respective sensing devices) which sensing transmitter sent those sensing signals). Based on this information, the SF 0930 (or the RAN 0900) may select/change a determined set of sensing devices to be involved in sensing of the target 0998, and instruct/configure them accordingly (using messages 936 similar to messages 932). This helps in reducing the resources used for sensing of the target 0998, by not involving sensing devices that are not able to sense the target 0998 (e.g. because it is outside the FoV of sensor 12 or sensor 22) or not able to reach the target 0998 by transmitting sensing signals and/or that are not able to receive the sensing signals (e.g., too far away from the target 0998). The SF 0930 (or the RAN 0900) may select only the best suited/closest sensing devices as a subset of the initially determined set of sensing devices. Furthermore, if the target 0998 is moving, the SF 0930 (or the RAN 0900) may determine or predict (based on the location/trajectory of the target), which additional sensing devices may need to be involved in sensing of the target 0998 based on the direction, speed and/or current location of the target 0998, and/or the received measurements showing a decline or increase of signal strength/quality for a particular sensing device, and/or the location of nearby or neighboring sensing devices (e.g., base stations with overlapping coverage). The SF 0930 (or the RAN 0900) may use this information to instruct/configure these additional devices (e.g., using the messages 936) to prepare them for sensing of the target 0998, in order to assure service continuity. Additionally or alternatively, the SF 0930 (or the RAN 0900) may instruct/configure a sensing device to transmit information about the target 0998 (e.g., “hand-over” information such as target identity, location, sensing signal characteristics/timing) to one of these identified additional devices. This can be seen as two ways of facilitating “hand-over” of sensing between one set of sensing device to another set of sensing devices, i.e., directly by the SF 0930 (or the RAN 0900) or indirectly by letting a sensing device communicate the “hand-over” information to another sensing device.

In a particular example, the SF 0930 or the RAN 0900 (or another network function (e.g., the LMF)) initially selects only a single sensing transmitter and a single sensing receiver (which may be co-located in the same sensing device) or other sensing device (e.g. a first device 10 or second device 20) that is closest or expected to be closest to the target 0998 or that has the required/best sensing capabilities for an initial sensing of the target 0998 or for performing a radar sweep of the area, to identify and/or determine a (more precise) location of the target 0998 and possible other characteristics of the target 0998. The respective single sensing device may send its sensing measurements/results to the SF 0930 (or to a RAN entity 0910 and/or a RAN controller 0911 collecting sensing measurements and/or performing some sensing calculations, or to a central repository from which a sensing service can retrieve these measurements/results). Based on these sensing measurements and/or results, the SF 0930 (or the RAN 0900) may select one or more sensing devices for sensing of the target 0998 that are best suited/located closest to the target 0998. The SF 0930 may send sensing requests towards sensing device capable of providing sensing data of the target 0998 and/or capable of transmitting sensing signals that will be received by one or more sensing receivers (after reflection by the target 0998), and may stop sending sensing requests to a sensing device that is not capable anymore of providing sensing data of the target 0998 and/or capable anymore of transmitting sensing signals that will be received by one or more sensing receivers (after reflection by the target 0998), or send a message towards such sensing device to stop sensing of the target 0998 (e.g., stop transmitting or receiving sensing signals).

In a related embodiment, instead of the SF 0930 or the RAN 0900 performing above determination of a set of sensing devices for sensing the target 0998 and/or instructing/configuring the determined sensing devices (possibly including preparing neighboring sensing devices for service continuity/handover of the sensing of the target 0998), the AF 0950 communicating via the NEF 0940 may perform those actions. To this end, the AF 0950 may be provided (via the NEF 0940) with information about sensing devices and/or capabilities in a certain area, e.g., a requested target sensing area. Also, the AF 0950 may receive the sensing measurements/results (i.e., as indicated above for the SF 0930) to enable it to determine which sensing devices to include in sensing of the target 0998 or prepare for sensing of the target 0998. Additionally or alternatively, the AF 0950 may request a core network function (e.g., the SF 0930) or the RAN 0900 to provide a list of sensing devices based on an estimated location, speed or trajectory of the target 0998, whereby the sensing devices may be identified with a temporary identifier (e.g., issued by the NEF 0940 or another core network function) and/or a relative position to the target 0998 and/or a restricted set of information about the capabilities of the sensing device (e.g., provide information that it is capable of sensing using mmWave, but not which particular frequencies). The AF 0950 may use these temporary identifiers in its selection and/or its configuration messages for sensing. The NEF 0940 or the other core network function can translate the temporary identifier back to the original identifier in order to select or configure the respective sensing device accordingly.

To summarize, a sensing and communication system for sensing targets (objects or people) in an environment has been described, wherein first real sensing data of a target collected by a first device is used to generate synthetic data which emulates second real sensing data which would be produced by a second device of the same target. The synthetic data is then used to determine whether the second real sensing data collected by the second device matches the first real sensing data collected by the first device, such that it can be confirmed whether both devices are sensing or have sensed the same target, or to identify objects in the field of view of a device (e.g., AR glasses).

While the invention has been illustrated and described in detail in the drawings and foregoing description, such illustration and description are to be considered illustrative or exemplary and not restrictive. The invention is not limited to the disclosed embodiments. It can be applied to various types of UEs or terminal devices, such as mobile phone, vital signs monitoring/telemetry devices, smartwatches, detectors, vehicles (for vehicle-to-vehicle (V2V) communication or more general vehicle-to-everything (V2X) communication), V2X devices, Internet of Things (IoT) hubs, IoT devices, including low-power medical sensors for health monitoring, medical (emergency) diagnosis and treatment devices, for hospital use or first-responder use, virtual reality (VR) headsets, etc.

Moreover, the above embodiments may be implemented in a quasi-distributed deployment where the base station is a central unit (e.g., gNB-CU) and there are two distributed units (e.g., gNB-DUs), one acting as the transmitter device and the other acting as the receiver device, while the central unit may be the entity synchronizing the distributed units.

The base station may be any network access device (such as a base station, Node B (eNB, eNodeB, gNB, gNodeB, ng-eNB, etc.), access point or the like) that provides a geographical service area.

Furthermore, at least some of the above embodiments may be implemented in other communication technologies, e.g., wireless communication technologies such as WiFi, ultra-wideband (UWB), 6G, etc.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims.

Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The mere fact that certain measures are recited in mutually different dependent claims does not indicate that a combination of these measures cannot be used to ad-vantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

The described operations like those indicated in FIGS. 4 to 17 can be implemented as program code means of a computer program and/or as dedicated hardware of the related network device or function, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. An apparatus comprising:
a processor circuit and a memory circuit, wherein the memory is arranged to store instructions for the processor circuit,
wherein the processor circuit is arranged to obtain a first measured data of a target object;
wherein the processor circuit is arranged to receive second measured data related to the target object from a second sensor;
wherein the processor circuit is arranged to obtain synthetic data of the second measured data based on at least one sensing parameter of a first sensor and/or at least one sensing parameter related to the second measured data,
wherein the processor circuit is arranged to obtain synthetic data of the first measured data based on the at least one sensing parameter of a the first sensor and/or at least one sensing parameter related to the second measured data,
wherein the processor circuit is arranged to determine if there is a match between the first measured data and the second measured data based on the synthetic data of the first measured data and the synthetic data of the second measured data.

2. The apparatus of claim 1,
wherein the at least one sensing parameter related to the second measured data is at least one sensing parameter of the second sensor,
wherein the processor circuit is arranged to obtain the at least one sensing parameter of the second sensor (22) from another device.

3. The apparatus of claim 1, wherein the processor circuit is arranged determine if there is a match between the obtained synthetic data of the first measured data and the synthetic data (Det of the second measured data.

4. The apparatus of claim 1, any wherein the processor circuit is arranged to determine if there is a match by using at least one of:
a first algorithm for segmenting the first and the second measured data into first object-related data and second object-related data,
a second algorithm for generating the synthetic data of the first measured data and the synthetic data of the second measured data from the first object-related data or second object-related data or one of previous inputs,
a third algorithm for converting the first object-related data or second object-related data or one of the previous inputs into first intermediate form or second intermediate form,
a fourth algorithm for converting the first intermediate form or second intermediate form or one of the previous inputs into the synthetic data of the first measured data and the synthetic data of the second measured data
a fifth algorithm for aligning the first intermediate form and second intermediate form.

5. The apparatus of claim 1, wherein the processor circuit is arranged to determine an identity of the target object based on the synthetic data and the first measured data.

6. The apparatus of claim 1, wherein the processor circuit is arranged to retrieve the first measured data and/or second measured data from a database.

7. The apparatus of claim 1,
wherein the processor circuit is arranged to retrieve additional data related to the target object from a metaverse or mixed reality service provider,
wherein the processor circuit is arranged to provide the additional data to the second sensor.

8. The apparatus of claim 1, wherein the processor circuit is arranged to perform asset tracking of the target object.

9. The apparatus of claim 1, wherein the processor circuit is arranged to request the target object to accept a network-aided identification.

10. The apparatus of claim 1, wherein the processor circuit is arranged to authorize the target object if a match has been determined.

11. The apparatus of claim 1, wherein the processor circuit is arranged to provide support for service continuity if the target object moves out of the coverage area of the second sensor.

12. (canceled)

13. (canceled)

14. (canceled)

15. A method the method comprising:
obtaining first measured data of a target object;
receiving second measured data related to the target object from a second sensor;
obtaining synthetic data from the second measured data based on at least one sensing parameter of a first sensor and/or at least one sensing parameter related to the second measured data
obtaining synthetic data of the first measured data based on the at least one sensing parameter of a the first sensor and/or at least one sensing parameter related to the second measured data; and
determining if there is a match between the first measured data and the second measured data based on the synthetic data of the first measured data and the synthetic data of the second measured data.

16. A non-transitory computer-readable medium storing a computer program, wherein the computer program when executed on a processor performs the method as claimed in claim 15.

17. The apparatus of claim 1, wherein the processor circuit is arranged to determine if there is a match between the first measured data and the synthetic data of the second measured data.

18. The apparatus of claim 1, wherein the processor circuit is arranged to determine if there is a match between the second measured data and the obtained synthetic data of the first measured data.

19. The method of claim 15,
wherein the at least one sensing parameter related to the second measured data is at least one sensing parameter of the second sensor,
wherein the processor circuit is arranged to obtain the at least one sensing parameter of the second sensor from another device.

20. The method of claim 1, further comprising determining if there is a match between the synthetic data of the first measured data and the synthetic data of the second measured data.

21. The method of claim 1, further comprising determining if there is a match between the first measured data and the synthetic data of the second measured data.

22. The method of claim 1, further comprising determining if there is a match between the second measured data and the obtained synthetic data of the first measured data.

23. The method of claim 1, further comprising determining if there is a match by using at least one of:
a first algorithm for segmenting the first and the second measured data into first object-related data and second object-related data,
a second algorithm for generating the synthetic data of the first measured data and the synthetic data of the second measured data from the first object-related data or second object-related data or one of previous inputs,
a third algorithm for converting the first object-related data or second object-related data or one of the previous inputs into first intermediate form or second intermediate form,
a fourth algorithm for converting the first intermediate form or second intermediate form or one of the previous inputs into the synthetic data of the first measured data and the synthetic data of the second measured data,
a fifth algorithm for aligning the first intermediate form and second intermediate form.

24. The method of claim 1, further comprising determining an identity of the target object based on the synthetic data and the first measured data.

25. The method of claim 1, further comprising retrieving the first measured data and/or second measured data from a database.

26. The method of claim 1, further comprising:
retrieving additional data related to the target object from a metaverse or mixed reality service provider; and
providing the additional data to the second sensor.

27. The method of claim 1, wherein further comprising performing asset tracking of the target object.

28. The method of claim 1, further comprising requesting the target object to accept a network-aided identification.

29. The apparatus of claim 1, w further comprising authorizing the target object if a match has been determined.

30. The apparatus of claim 1, further comprising providing support for service continuity if the target object moves out of the coverage area of the second sensor.
